(19) United States
(12) Patent Application Publication
(10) Pub. No.: US 2026/0330133 A1
(43) Pub. Date: Oct. 22, 2026

(54) AI-BASED WEBSITE ORCHESTRATION

(71) Applicant: TENWEB, INC., Newark, DE (US)

(72) Inventors: ARTAVAZD MINASYAN, Yerevan (AM); TIGRAN NAZARYAN, Yerevan (AM); SERGEY MARKOSYAN, Yerevan (AM); SERGEY POGHOSYAN, Yerevan (AM); GOHAR AVAGYAN, Yerevan (AM); ALEXANDER DAINIAK, Yerevan (AM); ANNA GHANDEVOSYAN, Yerevan (AM); MHER VEZIRYAN, Yerevan (AM); MHER KHACHATRYAN, Yerevan (AM)

(73) Assignee: TENWEB, INC., Newark, DE (US)

(21) Appl. No.: 19/649,200

(22) Filed: Apr. 16, 2026

Related U.S. Application Data
(60) Provisional application No. 63/790,038, filed on Apr. 17, 2025.

(51) Int. Cl. G06F 40/197; G06F 40/151

(52) U.S. Cl. CPC G06F 40/197; G06F 40/151

(57) ABSTRACT

Techniques are described for an AI-based copilot system for website creation, editing, and management that performs multi-agent orchestration, structured Ground Data, and configurable Global Design Parameters to streamline the entire website lifecycle. The system performs automated website layout generation, style enforcement, and content updates based on user commands or external triggers, in one or more embodiments. By utilizing specialized AI Agents, the copilot system may address complex tasks such as multi-page rebranding, bulk content modifications, or continuous content automation with minimal user intervention. Its extensible architecture supports the integration of new Widgets/sections, design modules, or external services, while the emphasis on structured Ground Data and various website layers provides consistency across the pages.

### BENEFIT CLAIM

This application claims the benefit under 35 U.S.C. §119(e) of provisional application 63/790,038, filed Apr. 17, 2025, the entire contents of which are hereby incorporated by reference for all purposes as if fully set forth herein.

### FIELD OF THE TECHNOLOGY

The present invention relates to the field of web development technology, in particular to an Artificial Intelligence (AI) based website orchestration.

### BACKGROUND

The approaches described in this Section are approaches that could be pursued, but not necessarily approaches that have been previously conceived or pursued. Therefore, unless otherwise indicated, it should not be assumed that any of the approaches described in this Section qualify as prior art merely by virtue of their inclusion in this Section.

Building and maintaining cohesive webpages requires complex coordination of layout, design consistency, and usability. With popular do-it-yourself (DIY) web development platforms, users need to manually create and edit webpages, Sections, and Widgets, which may be time-consuming and prone to errors.

Website administrators may retain a web designer and communicate their vision and preferences to the designer, who then creates a website, and the design thereof based on the instructions. However, such approach is both time-consuming and expensive requiring many iterations to achieve the desired effect.

Alternatively, website administrators may attempt to create the website themselves. However, many website administrators lack coding skills or design experience required to build a professional, cohesive website. Even platforms that promise “no-code” solutions often involve a steep learning curve, with complex builder interfaces and endless style and layout options. This process may take many hours to master and often requires specialized knowledge.

In both scenarios, when using DIY platforms and hiring web designers, the resulting webpages should be coherent in design, style, content and convey the message of website administrators effectively through textual and visual content. Maintaining the consistency, such as cross-page brand consistency, synchronization of content across multiple website areas (such as, a blog, product pages, and a homepage) makes the complexity even more challenging.

Website administrators that frequently add new products, blog posts, service pages, or landing pages end up spending hours on repeating tasks, such as filling in templates manually, adjusting layout details, etc. Changing a website's “look and feel” usually requires combing through every page, adjusting CSS, images, and layout structures manually, which may be an error-prone and extremely time-consuming process.

Building a website that seamlessly pulls data from CRMs, e-commerce platforms, or analytics tools usually demands programming knowledge, custom APIs, and continuous maintenance.

The technical difficulty is further exacerbated when a website includes not only ordinary pages but also structured content domains, such as products, posts, listings, team members, reviews, catalogs, or other schema-defined content collections that are stored separately from the presentation structures that render them.

Furthermore, long-running website operations, such as site-wide redesign, synchronized content refresh, or programmatic page generation, also benefit from routing, pre-planning, intermediate review, interruption handling, and controlled recovery rather than a single unconstrained generation step which may yield arbitrary result and degrade the consistency of look and feel for these same typed elements. [9D] Accordingly, improvements are needed in AI-based website systems to provide orchestration, validation, synchronization, structured-content management, and lifecycle control in a coherent architecture.
Additional technical difficulty arises in website platforms or Content Management System (CMS) environments where module, plugin, or extension lifecycle changes may require discovery of current installation state, dependency-aware ordering, compatibility evaluation, staged activation or deactivation, verification after mutation, rollback capability, and reconciliation with live website state.

As entities increasingly rely on a strong digital presence, the demand for efficient, consistent, AI-driven website creation and management tools continues to rise.

### BRIEF DESCRIPTION OF THE DRAWINGS

In the drawings of certain embodiments in which like reference numerals refer to corresponding parts throughout the figures:

FIG. 1 is a block diagram that depicts the system architecture, in an implementation;

FIG. 2A is a flow diagram that depicts the process of website creation, in an implementation;

FIG. 2B is a flow diagram that depicts the process of orchestration of changes to a website, in an implementation;

FIG. 3 is a block diagram of a Sitemap as shown to the user, in an implementation;

FIG. 4A is a block diagram that depicts the data flow interaction between the various layers of the website and the resulting website artifacts, in one or more embodiments;

FIG. 4B and FIG. 4C are an example of Ground Data structure (in JSON format), in an implementation;

FIG. 5A is a flow diagram that depicts the process for modifying the schema of a Structured Content Entity type, in one or more embodiments;

FIG. 5B and FIG. 5C are an example of Prebuilt Section Template (in JSON format), in an implementation;

FIG. 6 is a flow diagram that depicts website editing process by modifying a specific Widget through AI Agents, with an AI Agent responsible for Widget settings modification being triggered, in an implementation;

FIG. 7 is a flow diagram that depicts website editing process by modifying a specific Section through AI Agents, in an implementation;

FIG. 8 is a flow diagram that depicts the process of interaction between the copilot system and the database and Ground Data during website editing process, in an implementation;

FIG. 9 is a flow diagram that depicts the process of website rebranding with both content and design modifications, in an implementation;

FIG. 10 is a flow diagram that depicts the process of Sitemap-level website editing scheme, in an implementation;

FIG. 11 is a flow diagram that depicts the process of programmatic landing page creation, in an implementation;

FIG. 12 is a flow diagram that depicts the process of automated programmatic blog posts creation with goals, in an implementation;

FIG. 13 is a block diagram of a basic software system, in one or more embodiments;

FIG. 14 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### General Overview

Techniques are described for orchestrating website creation, editing, synchronization, validation, publishing, and lifecycle management across multiple scopes of website state, including pages, Sections, Widgets, settings, schema-defined content structures, and live website platform or Content Management System (CMS) environments. The techniques may be performed on or by deployed websites or website-platform environments having installed modules, plugins, extensions, configuration surfaces, and external integrations, rather than only over abstract source artifacts. Additionally or alternatively to generation of webpages, techniques include orchestration of multi-stage website creation and modification processes that use intermediate representations, validation controls, synchronization with live state, and controlled artifact packaging or publishing. In one or more embodiments, the orchestration is performed on a real website platform or CMS environment having installed modules, settings, APIs, publication surfaces, and live operational state. Accordingly, the techniques further include compatibility evaluation, dependency-aware sequencing, post-mutation verification, and rollback controls.

Techniques herein describe an AI-based website copilot that streamlines the creation, editing, and management of websites. The copilot system addresses the complexity of developing and managing websites by using artificial intelligence (AI) models to automate and optimize website development processes, ensuring brand consistency and intuitive user experiences across the pages. The copilot system and its techniques described herein provide a more efficient and user-friendly execution to create, edit, and manage websites by using AI Models to generate websites, webpages and their components in a way that is consistent with the user's preferences and the overall design of the website. Additionally, the copilot system is adaptive and flexible to the changing needs of website administrators. The copilot may generate websites based on user input, such as a natural language description of the content, the structure of the website, and the content of the webpages. Additionally, the copilot may assist users in editing and managing websites, by providing suggestions, automations, and other tools to help users create and maintain their websites. The copilot may be used to create and manage websites for a variety of purposes, such as e-commerce, blogging, marketing, and more. The copilot may be accessed through a web interface or other user interface or may be integrated with other tools and services to provide a complete website creation and management solution.

### Glossary of Terms

AI Model refers herein to a computer program utilizing one or more machine learning (ML) models, which are generated by training ML algorithms on one or more training datasets that may process single-mode or multimodal inputs (e.g., text, images, audio) and generate one or more types of outputs (e.g., text, images, code) based on learned patterns. In one or more embodiments, AI Models include text-to-text, text-to-image, and image-to-image generative models. In the context of the present techniques, each reference to an AI Model may denote a different AI Model. The choice of AI Model depends on which specific action (as subtask or AI Agent) is executed by the copilot system. When referring to AI Models, the series of “guardrails” are included in an implementation. Guardrails are components of a computer program which, when executed, ensure the output of AI Model meets correctness (in format, value, etc.), and safety constraints (e.g., filtering out inappropriate text) thus being within ethical, legal and technical boundaries and preventing errors in the system. AI Model may refer to both the baseline or foundation model, as well as any specialized or fine-tuned versions. When referring to an AI Model used for a certain action/task, its prompts (system prompt, user prompt etc.) may be predefined and/or included. Thus, the same AI Model used with different prompts is considered as different AI Models.

AI Agent refers to herein, within the context of multi-task pipeline, a computer program that uses AI Models to perform a specific task or a set of tasks and to achieve its goal. Additionally, one or more AI Agents may split tasks into subtasks, spawn subtasks and assign the subtasks to other AI Agents or AI Models and pass corresponding data between them. In an embodiment, AI Agents decide which data to pass to other AI Agents or models, and when to call third-party APIs or tools which are functions applying given modification to provided inputs. One or more of these actions may happen without the user's further instructions following the initial prompt. Each AI Agent may have its own short-term and long-term memory systems, where the data and messages related to current or previous user input or internal data passing between agents may be stored and retrieved from. When referring to an AI Agent used for a certain action/task, its prompts (system prompt, user prompt etc.) may be predefined and/or included. Thus, the same AI Agent used with different prompts is considered as different AI Agents.

Within the system, some AI Models or AI Agents responsible for particular tasks may be replaced by rule-based algorithms. The system may be configured that in certain situations (certain input to AI Agent or AI Model or other conditions or their combinations), in addition or alternative to using the AI Model or Agent, a specific rule-based algorithms (per action/task and condition) may be used. Rule-based algorithms provide granular control over the behavior of the system and mitigate the chances of AI Models and AI Agents may yield inaccurate results. “Validation” term refers herein to one or more computer-implemented checks that determine whether an intermediate representation, generated output, modified output, packaged artifact, deployed website state, or requested action satisfies one or more technical and business constraints of the system. Validation is not limited to syntax checking, code-format checking, or schema-conformance checking of source-like artifacts. In one or more embodiments, validation additionally includes structural validation, semantic validation, style validation, accessibility validation, integration validation, rendered-output validation, binding validation, dependency validation, module or extension compatibility validation, configuration validation, import or publication validation, verification of rendered pages or views, verification of Structured Content Entity-backed views, verification of data bindings, verification of availability or enablement of platform capabilities, and validation of consistency between internal representations and live website state.

Validation may be performed by rule-based algorithms, AI Models, AI Agents, or combinations thereof. Different validation stages may use different validation mechanisms depending on the output type, mutation scope, deployment scope, or technical constraint being checked. Validation may additionally be performed against Ground Data-derived constraints, expected content, dependency rules, or other relationships defined by Ground Data, the Ground Data schema, or the Ground Data dependency schema.

Such validation may be performed before mutation, during staged execution, after repair, after import or publication, after synchronization, or during reconciliation with live website state. In one or more embodiments, validation may further determine whether output is to be accepted, rejected, repaired, retried, rolled back, clarified, or propagated to later stages.

Subject Matter refers herein to user-provided information about the topic dealt with or the subject represented by the website or the user's activity presented on the website. Subject Matter may also include information about website content. Subject Matter may have a name, type, description and other parameters. A non-limiting example is a Subject Matter having a title “Julia's recipes”, with type being “culinary blog”, and description containing information about the website owner's activity or site content overview and/or preferences.

Website Sitemap or Sitemap refer herein to a simplified representation of a website's pages, as defined or requested by user(s). The Website Sitemap may include a list and hierarchy of web pages that are related to, but may not exactly reflect the final website structure. The Sitemap may include metadata and a hierarchy of pages and subpages. Website Sitemap may be augmented or changed by the system iteratively as the user or Copilot works on the website.

Webpage Outline refers herein to a high-level description of a webpage, including webpage title, a description and a list of Sections. In one or more embodiments, Webpage Outline may include metadata for one or more Sections, such as style preferences, layout information, content preferences, information about how a Section looks or is to be styled, and information about which components, Widgets, blocks, containers, or other elements the Section may contain.

Section refers herein to a visible part of a webpage that has a specific purpose, and may correspond to a subtree in the tree of the webpage HTML document, such as a “header”, “footer”, “hero”, “FAQ”, etc. A Section consists of one or more blocks. A Section may have title, description, metadata, such as style and layout preferences, type and internal structure (Widgets and containers) and content. Certain global Sections such as header and footer may be used across multiple pages and treated differently from other Sections. When rendered in the webpage each Section may or may not be delimited by a Section type tag such as <div>or <Section>.

Prebuilt Section or Page Template refers herein to a template for a Section or a web page that is partially or completely designed and may be used as a basis for further generation/modification of the Section or web page. One or more parameters of prebuilt templates may be fixed, while other parameters may be modified.

Layout refers herein to the arrangement of elements on a webpage or Section. Layout may include the position, size, and style of elements such as text, images, and buttons.

Style(s) refers herein to a set of parameters and their values describing the visual appearance of any web element, such as a webpage or a Section, including colors, fonts, and other design elements. Styles may be applied to individual Sections, Widgets or pages or may be global. Styles may be hierarchical (e.g., site-wide base styles, overrides at page or Widget levels).

Global Design Parameters refer herein to a set of design parameters that define the visual appearance of a website, including colors, fonts, spacings, alignments, etc. These parameters are applied to the whole website and are used as a base for generating styles for individual elements such as Sections and Widgets.

Design Paradigm refers herein to a set of design parameters that define the visual appearance of a website, including paddings, spacings, alignments, and available presets of elements (such as buttons). Changing Design Paradigm parameters may affect the appearance, including the sizes and positions of visual elements, but may not alter the hierarchical block structure of webpages.

Theme/skin refers herein to an additional set of design parameters that may be applied to a website to change its appearance. Changing the theme/skin may affect the appearance of the webpage. However, changing the theme or skin may not affect on positions and structure of elements on webpages, such as border-width or border-shadow of buttons, roundness of icons, etc. In one or more embodiments, design parameters, Design Paradigm, and theme/skin are managed as a website-wide design state that is distinct from textual, media, business, or other content state. Changes to such design state may be propagated across pages, Sections, Widgets, templates, and rendered views while preserving content that is not intended to be changed.

Widget or Block refer herein to a unit of visible content or visible functional elements that may be added to a webpage or Section. Widgets may include texts, images, videos, forms, buttons, sliders and other elements. A Widget has a type and a set of parameters with their values that define its appearance and behavior, including textual and media content of the Widget, appearance and style. A Widget may be of custom HTML type which includes arbitrary HTML in its content. A Widget is being converted by a Page Builder into artifacts that may be displayed on a webpage. The term “artifacts” refers herein to a representation, such as (source) code, markup, such as HTML, executable bundles and/or platform/Page Builder specific artifacts, that may be readily rendered as a website or any element thereof.

A Widget may be distinct from a component. A Widget may be a higher-level parameterized black box, and may internally contain nested Widgets or other internal structure that may or may not be fully exposed to or modifiable by the copilot system. In one or more embodiments, the system additionally uses components as reusable implementation units that may underlie, render, correspond to, or be composed into Widgets, Sections, pages, or other webpage structures.

Web Component refers herein to a reusable computer-implemented logic for rendering part of a webpage or application. A Web Component may encapsulate markup, logic, style, state, event handling or references to other Web Components. Unlike a Widget, a Web Component may expose its implementation, source code or source-like representation, such as HTML, declarative markup, style definitions, scripting code, typed or untyped program code or other code or markup, to the system or user, although in some embodiments the Web Component remains non-modifiable or only partially modifiable. A Web Component may render one or more Widgets, other Web Components, raw HTML, arbitrary markup or a combination thereof. Not the webpage content represented in source code is necessarily a Web Component, because some portions may be plain HTML, markup fragments, scripts, styles, text nodes or other markup/code not wrapped as a named Web Component.

Page Builder refers to a class/type or an instance of such class/type of software that generates webpages using Widgets/blocks, Web Components, artifacts or a combination thereof, by customizing and arranging them instead of writing the HTML markup directly based on user input. Page Builders may internally store Widgets, Web Components or the content of webpages as a markup or data representation of some type, which Page Builders convert into HTML, script, style or another format when rendering webpages. In one or more embodiments, a Page Builder is one example of a Webpage Composition Pipeline, while in other embodiments the Webpage Composition Pipeline includes Web Component-based rendering, build, export, or transformation systems that are not limited to drag-and-drop Page Builders.

Webpage Composition Pipeline refers herein to a sequence of transformations that converts higher-level representations of a website or webpage into one or more intermediate or final artifacts that may be rendered, built, compiled, bundled, exported or displayed. The Webpage Composition Pipeline may accept as input one or more of Sitemap data, Webpage Outlines, Section templates, Widgets, Web Components, global styles, Ground Data, Structured Content Entities, custom artifacts, and may produce as output artifacts. In one embodiment, the Webpage Composition Pipeline is analogous to a Web Component-based build or rendering pipeline.

Widget Presets refer herein to a set of predefined configurations of a Widget that may be applied to modify the appearance and behavior of the Widget. Widget Presets may include different styles, layouts, and content configurations.

Web Component modes, variants or parameter presets refer herein to a set of predefined combinations of properties, parameters, styles, behaviors, implementation options or other configuration values of a Web Component that may be selected or applied together. In one embodiment, different Web Component modes or variants correspond to different visual styles, purposes, responsive behavior, enabled features, internal layout substructures or code paths of a Web Component while preserving the general role of that Web Component.

Ground Data refers herein to a data set that is website-specific and defines core information of the website, its related entity and the Subject Matter and is the same for different parts of the website. Stated differently, the Ground Data is a textual representation of the uniqueness of the website, the portions of which, when modified, affect each and every part of the website that depends on that portion to maintain consistency across the website. In an embodiment, Ground Data for a website is generated by AI Agent(s), based on user input, existing content of the website and data from integrations with third-party services, that is shared between different parts of the system. This data is used to generate the content for the website. Ground Data may be stored in a structured or semi-structured format. Ground Data is website-specific and is stored in the system's database, which is different from the website's database. In one or more embodiments, Ground Data acts as an additional underlying or cross-cutting layer that captures website-specific information and dependencies used to coordinate the other layers of the system. Ground Data may source, constrain, connect, or trigger updates across design, structure/template/layout, data, content, and integration layers without requiring that such layers be mutated together in every operation. Additional details on techniques for Ground Data are described in the “GENERATING GROUND DATA” section.

Structured Content Entity refers herein to a schema-defined, field-governed content unit which is stored separately from the presentation structures or templates through which it may be rendered. A Structured Content Entity may belong to one of multiple entity types, where each entity type may have its own schema, item instances, metadata, taxonomies, validation rules, and relationships to website structures. Structured Content Entities may be generated, modified, synchronized, queried, rendered, or re-rendered independently of ordinary webpage layout generation.

Authored Artifacts refers herein to artifacts that are generated by AI Model(s) based on user input.

### System Overview

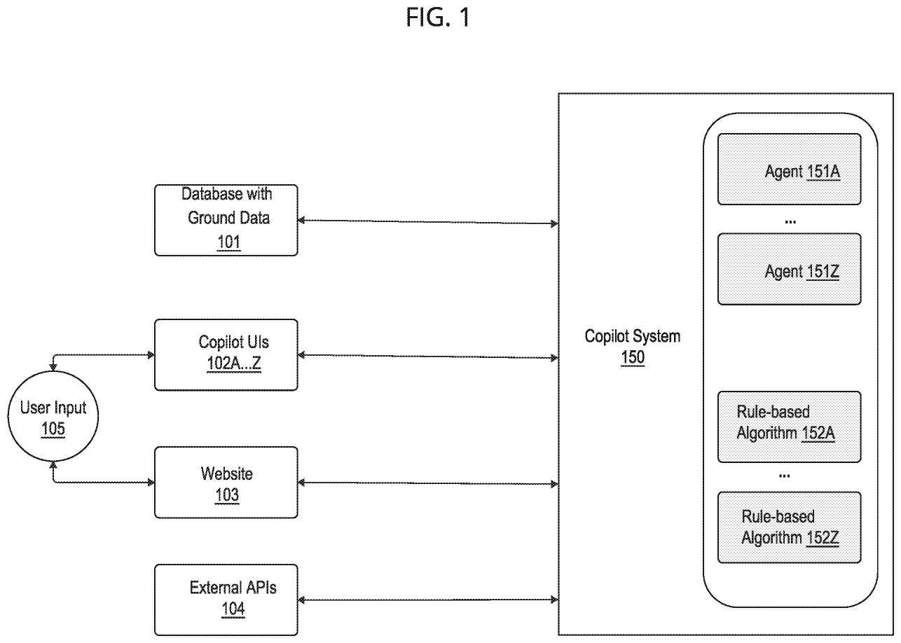

FIG. 1 depicts the AI website orchestration system, in an implementation. The system may include: copilot system 150 that runs AI Models (not depicted), AI Agents 151A-Z corresponding to the AI Models and different rule-based algorithms 152A-Z; database 101 that stores the Ground Data and other data; and external API interfaces 104—a set of integrations with external APIs.

Copilot system 150 (also referred to as “copilot” or “backend”) may execute one or more AI Models and one or more AI Agents to generate content, styles, and layouts for websites based on user input and preferences. Copilot 150 may generate websites, webpages, Sections, and Widgets, and may assist users in managing and updating them. Copilot 150 may be accessed through a web interface or other user interface. Copilot system 150 may proactively suggest changes or may passively respond to user prompts. In an embodiment, copilot system 150 may perform in three modes, depending on the site management context or user input: site creation, site editing, and site management.

In one or more embodiments, copilot 150 additionally coordinates synchronization, validation, packaging, publishing, version tracking, and management of Structured Content Entities. Accordingly, the system operates as a control architecture for the website lifecycle rather than as a simple one-shot content generator. In one or more embodiments, backend 150 is additionally integrated with website-platform or CMS management surfaces that expose installed module inventory, enablement state, configuration state, update state, publication state, or combinations thereof.

Copilot system 150 is coupled with the user's website 103 and is available for user input 105 through, at least, the user-facing interfaces of the system copilot UIs 102A-Z. Based on received user input 105 through copilot UIs 102A-Z or website 103, copilot system 150 may invoke its agents 151A-Z to execute corresponding AI Models and/or rule-based algorithms 152A-Z. Based on the output and response from agents 151A-Z and/or rule-based algorithms 152A-Z, copilot system 150 may modify data in database 101, invoke external APIs 104 and/or update copilot UIs 102A-Z. Although, database 101, external API interfaces 104, website and/or copilot UIs 102A-Z, one or more (or all) of these modules may be hosted/executed within copilot system 150.

### Functional Overview

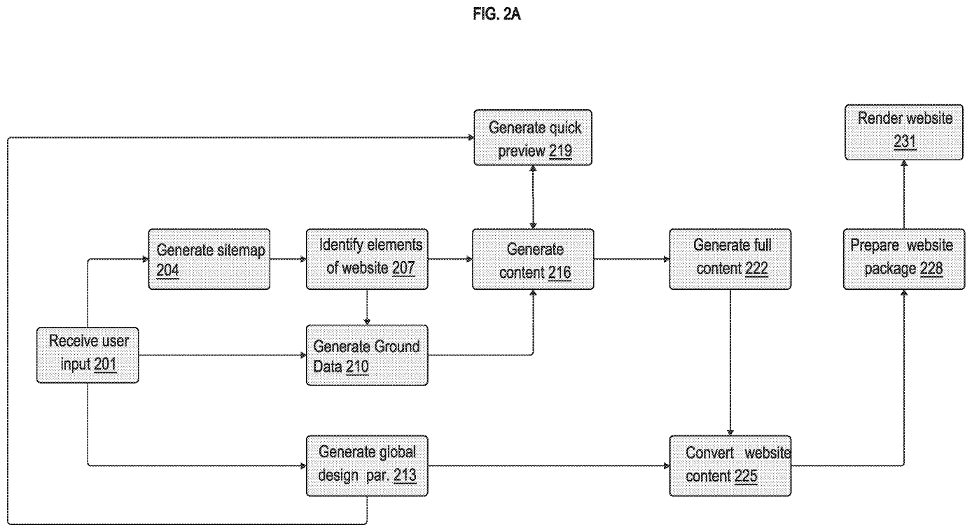

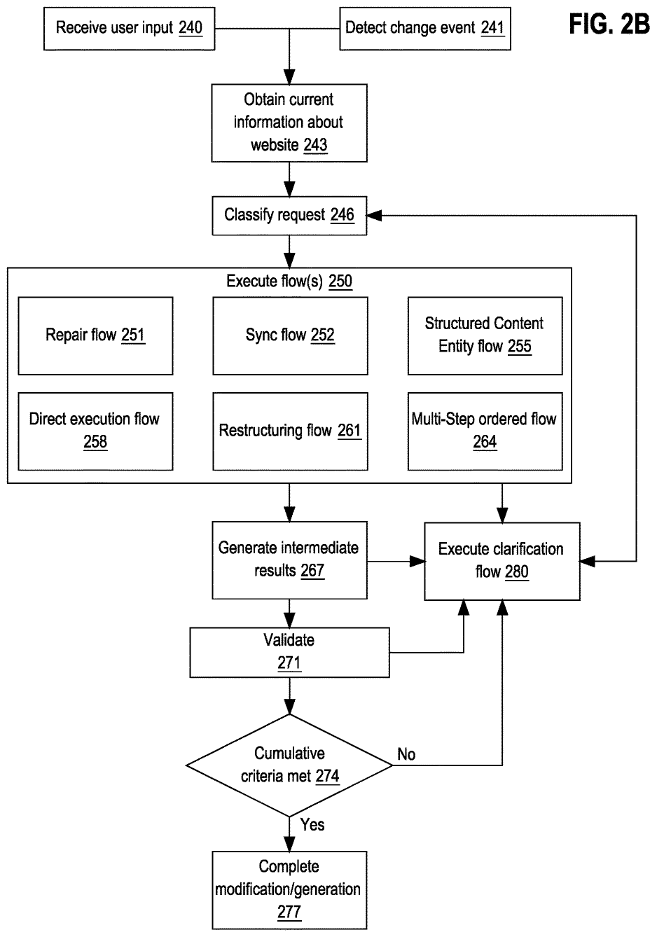

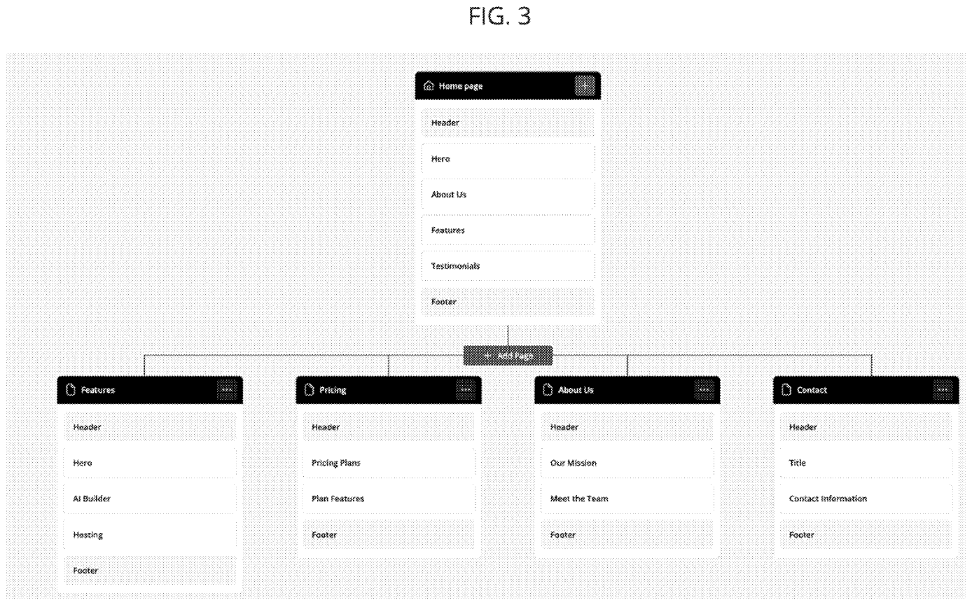

FIG. 2 is a flowchart that depicts the process of website creation, in an implementation. At step 201, the system receives a user input that may define the Subject Matter, intent, or parameters of the website to be created. The system then may proceed to step 204, step 210, step 213, and/or step 219. At step 204, the system generates a Sitemap that defines the initial hierarchy of the website. The system then proceeds to step 207. At step 207, the system defines Section types and templates. The system then may proceed to step 210 and/or step 216.

Based on step 201 and/or step 207, at step 210, the system generates Ground Data. The system then proceeds to step 216.

Based on step 201, at step 213, the system generates Global Design Parameters. The system then may proceed to step 225.

Based on step 207 and/or step 210, at step 216, the system generates content for website which may not be complete. The system may then proceed to step 219 to receive more user input and/or step 222 to generate complete Sections of the website with complete content.

Based on step 213 and/or step 216, at step 219, the system may generate the website and display the website for a user as a quick preview to gather further feedback. The system then proceeds back to step 216.

Based on step 216, at step 222, the system generates complete content for the website, including Widgets and Sections. The system then proceeds to step 225.

Based on step 213 and/or step 222, at step 225, the system converts the output to a necessary format via a converter using the full content with the application of the generated global designs. At step 228, the system prepares the final website package. At step 231, the system installs the package, thereby generating the artifacts for the website, which, when rendered, displays the website.

In one or more embodiments, apart from operating on the artifacts (e.g., HTML), the system operates on a managed website environment in which pages, templates, styles, Structured Content Entities, modules, settings, bindings, and published artifacts may each be discovered, created, modified, synchronized, validated, deployed, rolled back, or reconciled. In such an embodiment, a website platform or CMS has a live stateful environment whose current inventory of structures, modules, configurations, and website data informs the later orchestration steps or the later state(s).

In one or more embodiments, the system operates over multiple layers of website state that may be represented, processed, validated, synchronized, and mutated independently. Such layers may include, but are not limited to, a design/style (“style”) layer, a structure/template/layout (“layout”) layer, an organized data/structured content entity (“Structure Content Entity”) layer, a content layer, and an integration/platform (“integration”) layer. The design/style layer may govern visual appearance; the structure/template/layout layer may govern arrangement, reusable presentation blueprints, and scope-specific presentation variants; the data layer may govern stored structured representations, schemas, entity definitions, and other machine-readable state; the content layer may govern textual, media, business, or other substantive information to be expressed through the website; and the integration layer may govern connections to website-platform capabilities, modules, plugins, extensions, external APIs, third-party services, or other environment-dependent operational state.

In one or more embodiments, the system may determine that a requested change mutates one of such layers while preserving one or more other layers, or first mutate one layer and thereafter propagate selected effects into one or more dependent layers. Thus, a requested change may, by way of non-limiting example, modify design state while preserving content state, modify structure or template state while preserving most design state and content state, modify data state before re-rendering presentation, modify content state while preserving current design and layout, or modify integration state without immediately altering visible presentation.

In the following sections the processes of the system leveraging AI Models to generate entire websites from simple user inputs, maintain design and content consistency across pages, and integrate seamlessly with third-party services are described, in one or more implementations. Additionally, the system's multi-agent architecture is described, which orchestrates tasks and subtasks for site creation and editing, in such implementations.

FIG. 2B is a flowchart that depicts the process of orchestration of changes to a website, in an implementation. At step 240, a user input is received to change one or more elements of the website. Alternatively, at step 241, the system may detect a change event based on synchronization with another website, a change to the website through a page builder or another interface, and/or a change to the underlying data.

In one or more embodiments, the techniques include the discovery of current website state before mutation (alteration), staged application of modifications to the live environment, and verification of the resulting deployed state after import, publication, module change, or synchronization event. Continuing with FIG. 2, at step 243, the system obtains the current state of the website. The step may include collecting context of the user input, Ground Data, templates, and/or Structured Content Entities of the website. Additionally or alternatively, the system may also determine the prior one or more states. The current state and the one or more prior states may be used for accurate classification and routing of the request. In one or more embodiments, the system expresses intended actions in a constrained form before invoking tools, external APIs, or mutation logic, thereby reducing unsupported or inconsistent automated behavior.

At step 246, the system classifies requests before executing any flow so that simple requests, complex multi-step requests, clarification flows, repair flows, and broader restructuring flows may be handled differently.

At step 250, the incoming requests are routed into different execution regimes based on estimated complexity, ambiguity, scope, dependencies, or side-effect risk determined at step 246. A localized request may be handled through a direct execution flow at step 258, while a multi-page or cross-scope request may be routed into a planned multi-step ordered flow at step 264. Such routing may distinguish between, for example, a Widget-level modification, a page-wide redesign, a request to repair previously generated output, a request to synchronize with live website state, or a request to create or modify Structured Content Entities and their rendered views. One or more other flows may be executed based on the classification performed at step 246: synchronization flow at step 252, Structured Content Entity flow at step 255, and/or restructuring flow at step 261.

At step 267, the system generates intermediate results of the change. The system may perform staged execution over intermediate representations, such as Sitemap data, Webpage Outlines, templates, Ground Data, and Structured Content Entities, rather than treating website generation as a single prompt-to-output operation. In one or more embodiments, the system performs generation and modification across multiple scopes, including Widget-level, Section-level, page-level, site-wide, and Structured Content Entity-level operations. In one or more embodiments, the system stores intermediate state and side effects so that long-running operations may be paused, retried, resumed, repaired, or restored in a controlled manner.

At step 271, the generated or modified output is processed through validation and repair stages before acceptance, packaging, import, or publishing. In one or more embodiments, the system maintains synchronization between internal representations and live website state, and performs reconciliation where those states diverge. In one or more embodiments, the system distinguishes among authored artifacts, validation-corrected artifacts, packaged outputs, and deployed website state as different lifecycle stages of website output. In one or more embodiments, actions selected by one or more AI Agents are validated against supported targets, allowed parameters, or dependency conditions before tool use or external mutation occurs. Unsupported or malformed actions may be rejected, repaired, retried, or sent to clarification flow executed at step 280.

In one or more embodiments, the system decomposes a request into tasks or subtasks, executes one or more of them, evaluates intermediate results, and then decides whether to continue, revise, retry, or terminate the flow. Intermediate feedback at step 271 may include validation results, review outputs, synchronization outcomes, user feedback, or detected inconsistencies. In one or more embodiments, the system preserves execution-state information for in-progress operations, including partial results, temporary side effects, progress state, and recovery checkpoints. If an operation is interrupted, cancelled, or fails, the system may resume from a stored state, replay a subset of steps, or discard uncommitted side effects.

If at step 274, based on validation and/or intermediate results, the cumulative criteria are met, the system proceeds to apply changes to relevant layer(s), element(s), template(s), layout(s), data, content, and/or integration at step 277. The website artifacts are generated and packaged, deployed and renderable upon the website request.

However, if at step 274 or any step starting classification step 246, any error or inconsistency is detected, the system proceeds to execute clarification flow at step 280. The clarification flow provides for iterative execution based on continuous input (from user or otherwise) to further improve the accuracy of the inputs to AI Agents or rule-based algorithms and thereby improve AI Model and rule-based algorithm outputs.

### Website Creation—Gathering Necessary Information About the Subject Matter

In one embodiment, the process of creating a website with the copilot system starts with collecting the Subject Matter details for the resulting site authentically reflects the company's brand identity, goals, and audience.

The copilot-based techniques may assist users in creating complete websites by gathering necessary information about the Subject Matter, such as a description of the Subject Matter, its name, industry, target audience, and other relevant details. Such an approach allows for a top-down creation process, which replicates the typical way of interaction between a web designer and a website administrator. The copilot may also gather information about the structure of the website, such as the number of pages, the layout of the pages, and the content of the pages. In an embodiment, this information may be used to generate a high-level Sitemap of the website, which may be used as a guide for creating the website. Additionally, the collected information may relate to additional functionality, such as e-commerce, blog, contact form, etc. The input to the copilot may also include preferences, such as design preferences, style preferences, text style preferences, logo, brand kit and other preferences which are related to brand identity and website goals.

The copilot system may dynamically request for more necessary information about the Subject Matter, such as specific details about the site activity, products or services presented, target audience, and other relevant details, before generating any Sitemap or website. The exact type of information that the system requests may be based on user input and configuration of the system, implementing any rule-based or AI-based logic. In one embodiment, if the Subject Matter description relates to “services” offered to entities, the system may request a list of services or some examples of entities.

The copilot system provides an iterative site creation process with displaying more and more specific outputs during site creation. In an embodiment, this enables effective user feedback and interaction with the system allowing users to customize the output according to their needs not only after the website generating is completed, but also during the creation process. In one or more embodiments, this iterative process is implemented as staged execution over intermediate site representations, so that the system may collect or revise information, update the Sitemap, update styles, update Ground Data, preview partially generated output. In such an embodiment, once such one or more iterative steps are performed, then the system continues to package and/or publish the final website.

### Generating and Editing High-Level Sitemap

After receiving the initial input from the user, the system generates a high-level Sitemap of the website, which includes a list of pages and Sections that may be included on the website. The Sitemap may also include metadata about each webpage, Page Template or Section, such as the type, title, description, and other details. In one or more embodiments, the Sitemap is stored in the Database and is used to generate content for the website. The Sitemap may be used as a blueprint for creating the website and may be updated as the website is being built. The Sitemap may be displayed to the user in a visual format, such as a tree diagram or flowchart, to help the user understand the structure of the website and make changes on request.

In one or more embodiments, the Sitemap is not only a user-facing description, but also an intermediate control representation used by later stages of generation, editing, synchronization, and propagation of changes across the website.

Page Templates in the Sitemap are page/Section-level prebuilt structures or may be generated by the system. Page Template act like blueprints for pages or Sections that have similar structure and content. In one embodiment, a Page Template for products of a certain category includes Sections that are common for pages that contain lists of products, regardless of the category.

In one or more embodiments, such Page Templates are associated with one or more Structured Content Entity types so that the system may separately manage the stored content items and the presentation structures that render them during generation/modification.

The Sitemap may contain repeatable Sections that are used in multiple pages. In one embodiment, a Section of “footer” is used in multiple pages. In one or more embodiments, the system automatically recognizes and suggests some Sections as cross-page or global structures and allows users to specify which Sections to use as the cross-page or global structures.

In one or more embodiments, when a change request is determine to effect the structure that is shared across multiple pages, the system determines whether the request mutates a shared template or shared Section definition, or instead creates a scoped template, scoped Section definition, or variant that is bound to a selected page, page type, Section scope, user segment, or other limited scope. Such determination may depend on the text of the request, explicit scope identifiers, current bindings of the shared structure, expected side effects on other pages, or consistency constraints. If the system determines that the request is not to be propagated to the pages using the shared structure, the system may create a derived template or variant from the shared template, bind that derived template or variant to the selected scope, and preserve continued use of the shared template elsewhere. By way of non-limiting example, if a user requests that a menu in a header be changed for one page, the system may create a page-specific header template or header variant for that page while preserving the original shared header template for other pages.

The copilot interface of Sitemap allows users interacting with the Sitemap in order to add/modify/remove pages/templates, and their Sections. The system may include functionality to suggest pages, templates or Sections, as well as enhance or modify their titles, descriptions and other parameters. Pages may have types, such as “homepage”, “blog”, “product”, “service”, “contact”, etc. Such classification of pages is based on page title, description, Subject Matter, user preferences, etc. Having pages classified into types provides context for the generation of Sections, as well as for the generation of content for the pages. Pages [symbol] also have “custom” or “other” type.

Pages and templates consist of one or more Sections. Each Section has a type, title, description, and other parameters. Description of a Section may provide details about the style, layout, content, etc., of the Section. In one embodiment, a user describes a hero Section that has a slider with a video background, or a team Section that has a grid layout and rounded corners for elements corresponding to each team member. In another embodiment, user preferences may be related to content of the page or Section, such as a list of products, a list of blog posts, a list of team members, a list of services, or a set of Structured Content Entity items. Additionally or alternatively, the system may specify the writing style and tone, as well as overall design style and preferences per page or per Section or globally. The system may generate Sections in a single AI Model call or may use a sequence of AI Model calls to generate the first group of parameters of Sections, then add other parameters, e.g. first generate title and description, then classify types and add style preferences.

The system may include functionality to create or modify pages or Sections based not only on textual title and description, but also on sketch, drawing, a screenshot, or a video, URL or some markup such as HTML or JSON. This technique provides a more precise and detailed description of the page or Section. The system may include a functionality to extract information from the provided media or markup, and provides users functionality to specify the characteristics of the media or markup that are used for the page or Section, such as colors, fonts, layout, content, etc.

In another embodiment, the system allows users to provide audio instructions and serve as voice-based copilot, which may be used to generate the page or Section. The system may include a functionality to convert audio-instructions into textual description, which may be used to create or modify the page or the Section.

### Generating Global Styles

A copilot system may generate global styles for the website. In one embodiment, the global styles are used to generate content for the website. Global styles include colors, fonts, theme/skin, and other Global Design Parameters. In one embodiment, the system generates global styles based on user input, such as name and description of the Subject Matter, industry, brand kit, target audience, and other relevant details. In another embodiment, the system generates the global styles based on user preferences, such as design preferences, style preferences. A non-limiting example is a website description that may suggest the website to have a modern, clean, and minimalistic design, which may be reflected in the choice of global styles. Based on user-supplied industry keywords, the AI might propose color schemes commonly associated with that vertical. A set of values for global styles may be combined into a single theme or skin, which may be suggested to the user for approval or change, instead of setting each parameter separately.

In an embodiment, the system allows users to generate global styles based on screenshot, mockup or other media, as well as based on a sample website or a webpage. Users may specify which global parameters of provided web samples or media may be used for the website. For example, the user may require using a color palette, but not fonts.

In an embodiment, the system generates global styles based on a brand kit, which may include a logo, color palette, typography, and other design elements.

Generation of global styles provides effective separation of styles and content, which allows more flexible and customizable website creation process. Global styles provide uniformity across the pages, while local overrides handle unique stylistic variations per Section or Widget.

In one or more embodiments, such style or design management may be layered. By way of non-limiting example, a website may have one or more of: a site-wide base style layer, a theme/skin layer, a page-level style layer, a Section-level style layer, a Widget- or Web Component-level style layer, or one or more override layers. Different embodiments may use fewer, more, or different style layers, and the invention is not limited to any particular naming, ordering, or combination of such layers.

In one or more embodiments, the same global styles are also applied to views that render Structured Content Entity items, thereby preserving consistency between ordinary webpages and schema-defined content domains. In one or more embodiments, the system treats design management as a whole-site layer that may be modified, stored, validated, previewed, approved, propagated, rolled back, or reconciled independently from one or more content layers of the website. Accordingly, a redesign or rebranding operation may modify the design state of the website as a whole without necessarily requiring regeneration of the content, while a content-modification operation may update content while preserving the current design state.

A copilot system may generate sample pieces of preview, corresponding to a small part of a webpage, in order for user to preview the sample with global styles applied. For example, a sample portion of preview may include a Section with form, buttons and images upon which some styles are applied, such as colors and styles of buttons, styles of form input fields or typography styles.

### Website Quick Preview

Between generation of Sitemap and generation of website content, the copilot system may generate a preview of the website, which may be used for users to provide intermediate feedback and make changes if needed. The user sees a “mid-fidelity” snapshot rather than a fully rendered final website, reducing time spent on rework later. The styles of preview may be different from the final website but may be close to the final website. Preview may include final content of the website, but with some placeholders for content that may be generated later, for example a list of products or blog posts or other Sections with complex functionality. Preview may have some styles partially applied, such as colors and fonts, but with some simplification for styles that may be applied later. Preview allows quick changing and editing of Sections, such as adding/removing/modifying/reordering/replacing Sections, as well as changing styles of the Sections.

The preview may not include media and other content that require more time and cost to generate, such as advanced interactive elements, functional elements, complex animations, etc. Users are able to navigate from preview back to Sitemap, global styles and refresh the preview with the changes users made. Generating preview provides benefits for user-experience, such as quick feedback and intermediate changes on the website structure and content before final generation, quick editing and approval of the website styles. Additionally, generating preview provides ability to see the website as a whole before deep diving into editing and customizing generated webpages or exploring the website in detail. Generating preview simplifies the complexity of the website for users by replacing the full website with a simpler web view with less parameters. Additionally, generating preview provides a platform-agnostic view of the website, which may be used to generate content for different platforms such as WordPress, Wix, Squarespace, plain HTML, etc.

In one or more embodiments, the preview acts as an intermediate review stage in which the system may defer selected expensive or support-sensitive operations, such as final media generation, validation and repair, synchronization with live website state, or final package building, until one or more intermediate representations are approved. In one or more embodiments, generation of the preview may itself include execution of one or more stages of the Webpage Composition Pipeline, including rendering, conversion, build, or page-builder-driven composition of one or more Sections, pages, or views. However, the same rendering, conversion, build, or page-builder actions may also be performed in embodiments that do not present a preview stage, including direct generation, import, deployment, synchronization, validation, or editing flows. The preview may provide simple editor experience for editing textual content of Sections.

### Generating Ground Data

During generation and editing of Website Sitemap, preview, final website and any other step in the process, the system may generate the Ground Data, save and retrieve Ground Data from the Database. Ground Data is used to generate content for the website or any content during the next steps of the process. Ground Data is stored in a structured or semi-structured format in the Database. The purpose of Ground Data is to provide a consistent and coherent source of information for the system, which may be used to generate content for the website or any content during the next steps of the process. Ground Data is used when the system is generating content for different parts of the website (such as pages or Sections) and ensures the content to be consistent and coherent between different parts of the website.

In one or more embodiments, Ground Data additionally acts as an intermediate control layer that relates website structure, reusable templates, design parameters, content dependencies, Structured Content Entity schemas, and later generation or modification tasks. Accordingly, Ground Data provides the core state of the website.

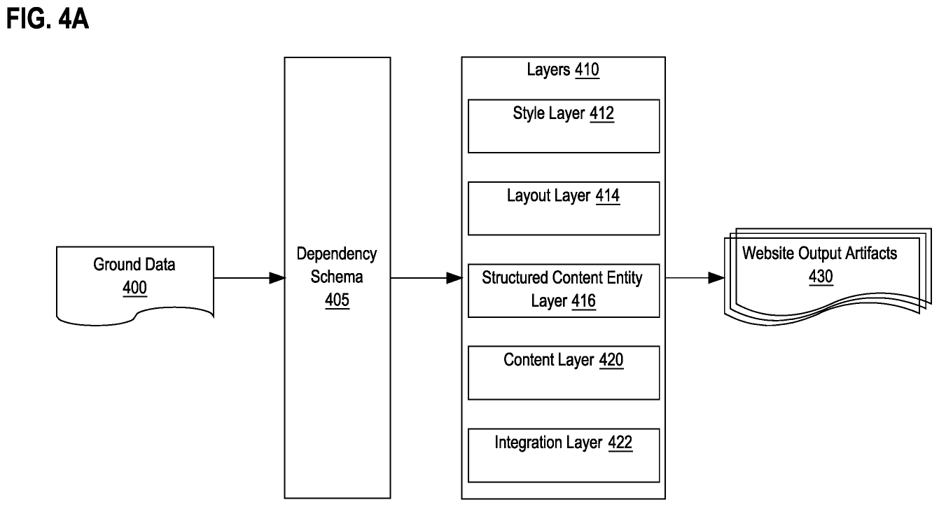

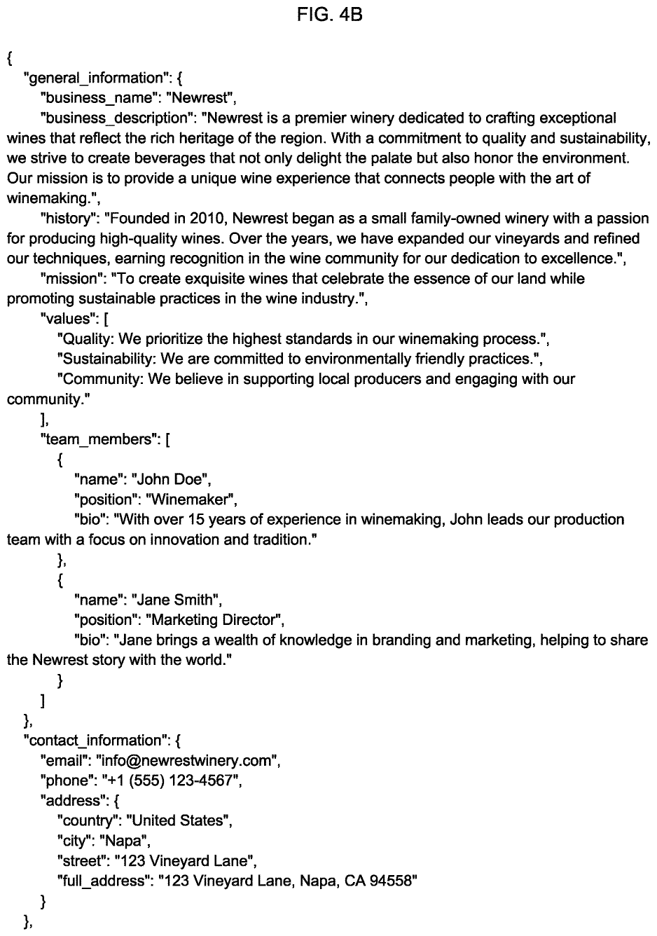

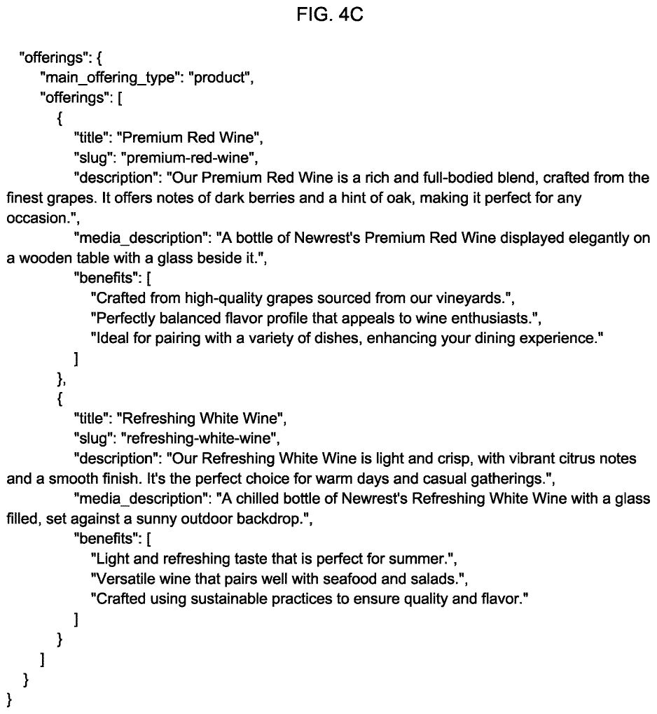

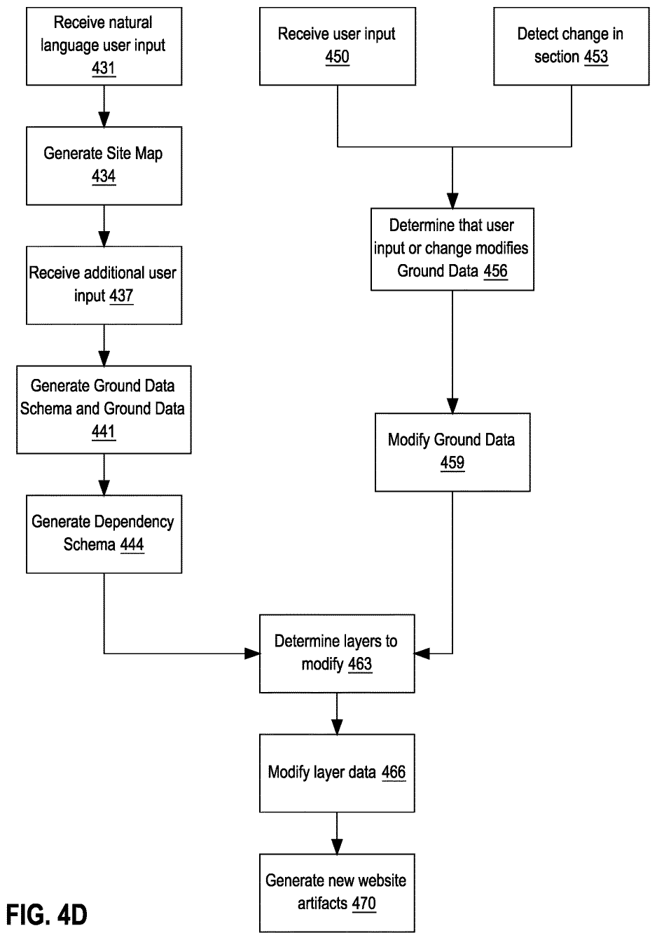

FIG. 4A is a block diagram that depicts the data flow interaction between the various layers of the website and the resulting website artifacts, in one or more embodiments. Data in Ground Data 400 affects the schema and parameter values of Layers 410 of the website.

The exact structure of Ground Data is defined by the system and is a combination of data portions and relations between them. In an embodiment, the structure of Ground Data may be represented as an associative array that may be shallow with keys and their values corresponding to the portions of Ground Data or deep with keys, subkeys and their values, depending on the complexity of the website and the level of detail that the user requests to provide or achieve. In another embodiment, the structure of Ground Data is represented as a tree with nodes and edges, where nodes are portions of Ground Data and edges are relations between portions of Ground Data, including references to other portions of Ground Data. FIG. 4B and FIG. 4C are an example of Ground Data structure (in JSON format), in an implementation.

Each portion of Ground Data has a title, description, and other metadata, including relations to other portions of Ground Data, content portions, etc. Each portion of Ground Data serves a specific purpose and is used to generate specific content or serve as a basis for the content.

Additionally, the system defines relations between portions of Ground Data and website content that may be generated based on the Ground Data. The schema defining the structure of Ground Data is called “Ground Data schema” and may be fully pre-defined, fully AI-defined or a combination of both (partially pre-defined) with any level of complexity. In the case of AI-defined or partially pre-defined schema, AI Models are responsible for defining portions of Ground Data partially or fully. Ground Data is being read or written (operations of addition, modification or deletion) through an AI Agent or an AI Model (for the parts) or rule-based algorithms (for parts that have pre-defined schema). A pre-defined schema or set of schemas or combination of pre-defined and AI-defined schemas determine relations between portions of Ground Data and content generated by the system. This set of relations is called a “dependency schema”. The “dependency schema” defines bi-directional relations between the portions of Ground Data and the content generated by the system, that is how the website structure or content may affect the Ground Data structure and vice versa.

In one or more embodiments, the Ground Data schema and dependency schema also define relationships to Structured Content Entity types, item sets, metadata, taxonomies, and the views through which such entities are rendered. In one or more embodiments, the Ground Data, Ground Data schema, and Ground Data dependency schema additionally provide constraints, expected content relationships, or dependency rules that are used during validation of generated, modified, rendered, synchronized, imported, or deployed website output.

Continuing with FIG. 4A, when a change occurs in Ground Data 400, the system propagates the change based on Dependency Schema 405 to the schema(s) and parameter value(s) of Layers 410. Dependency Schema 405 may indicate that a particular parameter value change in Ground Data 400 Style Layer 412, Layout Layer 414, Structured Entity Layer 416, Content Layer 420, and/or Integration Layer 422. Based on the change(s) in Layers 410, the system generates one or more website output artifacts, which, when rendered, display the change on the website.

The list of Ground Data portions and their values that are actually generated may be based on the user input, the pages and Sections that may be generated and other preferences.

In an embodiment, the trigger for generating a specific portion of the Ground Data may be the existence of certain Sections or pages in the Sitemap. A non-limiting example may be the system configured in a way that if the homepage of a website has a Section about the company and there exists a page called “About us” containing several Sections of content, it may trigger generation of a Ground Data portion called “about_company” that may provide information about the company and may be used to generate both “aboutsection in the homepage and “About us” page. In this case, the Ground Data dependency schema is a simple mapping between “aboutsection type in the homepage, “about” page type and “about_company” Ground Data portion. The exact structure of data in “about_company” Ground Data portion is defined by the “Ground Data schema” and may include structured or semi-structured data, such as information about founding the company, its mission, values, history, etc. Using one Ground Data portion for multiple Sections may keep the information consistent between the “about ussection in the homepage and the “About us” page.

AI Agents or AI Models may be used to generate/modify Ground Data portions, such as “about_company” or “blog” portions upon the need. AI Agents or AI Models may be used to retrieve Ground Data portions and to provide the raw or processed results to other parts of the system. Such processing may turn Ground Data portions into the requested format or schema according to the request requirements.

Another non-limiting example is blog sites for which the list of blog posts with their titles, outline or full content and media, categories, tags and other metadata may be generated in the Ground Data under the key “blog” and be used to generate blog posts on the website and other blog related content. In that case, the website type or title may be a trigger for generating the “blog” Ground Data portion.

Other embodiments of Ground Data portions may correspond to “products”, “team members”, “contact information”, “reviews”, etc. The system may provide a functionality to ask users to provide missing Ground Data portions, such as “about_company” or “blog” portions upon the need.

In one or more embodiments, a Ground Data portion may define or constrain one or more Structured Content Entity types, their item fields, metadata, taxonomies, validation rules, or rendering dependencies.

Portions of Ground Data may include descriptions and parameters of images or image content, such as images of products, team members, blog posts, that are generated for the website.

Ground Data portions may be independent or mutually dependent. In case of independent portions, the system may generate such portions in parallel. In case of mutually dependent portions the system may generate such portions sequentially, by defining and resolving dependencies between one or more portions. At each step of Ground Data generation, the system may recheck against the Ground Data schema and Ground Data dependency schema to resolve the dependencies between portions of Ground Data and to update the next portions of the Ground Data.

Accordingly, Ground Data generation may itself be a staged process with dependency resolution, intermediate updates, and rechecking against governing schemas before later steps are performed.

The Ground Data may include information about the user and content explicitly provided by the user or inferred and augmented from the user input through AI Models. As a source of the Ground Data, the system may use data from integrations with third-party services, such as CRM, e-commerce, marketing, analytics, social media, and other services.

In one embodiment, the system uses CRM data to analyze customer groups and preferences and define customer segments as a portion of Ground Data. The system uses the portion of Ground Data describing customer segments to generate different landing pages and Sections for each segment. In an embodiment, Ground Data is user preferences, such as tone of text inferred from the user input or provided by the user through direct input or examples of text.

The system may provide a tool to visualize Ground Data portion or for users to edit them directly or indirectly through the chat or other user interface. In one embodiment, the user may request the copilot to provide information about the founding of the company. The copilot may generate a reply based on the “about_company” Ground Data portion. Additionally, the user may request to edit the “about_company” Ground Data portion or add more details to the Ground Data portion. Furthermore, the user may request the copilot to generate one or more new Ground Data portions based on the user input, such as a new product or service.

The Ground Data is being generated during the initial stage of website creation before actual generation of the website content. However, the Ground Data may be modified directly or indirectly at any later stages of website editing or managing processes.

FIG. 4D is a flow diagram that depicts a process for generating and/or modifying Ground Data and propagating the changes to the final website artifacts, in one or more embodiments. At step 431, the system receives a natural language user input describing the desired website, such as its purpose, industry, content preferences, or style directives. This serves as the foundational prompt that drives the subsequent AI-based generation. The system then proceeds to step 434.

At step 434, the system generates a Site Map based on the natural language input received at step 431. Using an AI model, the system infers the appropriate page structure and hierarchy for the website—for example, determining that a business site may include a Home page, About page, Services page, and Contact page. The system then proceeds to step 437.

At step 437, the system receives additional user input to refine or expand upon the initial natural language input provided at step 431. This may include user clarifications, corrections, content preferences, or supplemental details about the website's audience, branding, or functionality. The system then proceeds to step 441.

Based on step 434 and step 437, at step 441, the system generates a Ground Data Schema and the corresponding Ground Data. The AI model may generate a structured schema that defines the core semantic content of the website—such as the business name, tagline, contact details, service offerings, and team members—and then populates that schema with actual content values derived from the user inputs. In an embodiment, this Ground Data serves as the single source of truth for the downstream website content generation and the core state of the website. The system then proceeds to step 444.

At step 444, the system generates a Dependency Schema based on the Ground Data Schema and Ground Data produced at step 441. The AI model maps out the relationships and dependencies between different data fields and the website layers that consume them—establishing which pages, sections, and widgets rely on which Ground Data fields, so that any future change may be precisely and efficiently propagated throughout the site. The system then proceeds to step 463.

Additionally, Ground Data may be modified. At step 450, the system receives a user input representing an edit or update request directed at the existing website content, structure, or design. This may occur at any point after initial website generation. The system then proceeds to step 456.

Alternatively or additionally, at step 453, the system may detect a change in a section of the website, which may have been triggered programmatically, by a CMS event, or by a direct edit to a page section or widget. The system then proceeds to step 456. At step 456, the system determines that the received user input or detected section change may require a modification to the Ground Data. The system analyzes the nature of the incoming change and maps the change to the appropriate Ground Data fields that is to be updated to reflect the intended modification accurately. The system then proceeds to step 459.

At step 459, the system modifies the Ground Data based on the determination made at step 456. In an embodiment, the AI model updates the relevant fields within the Ground Data Schema—for example, revising a entity description, updating a phone number, or changing a offering—ensuring that the central data record remains consistent and current, as non-limitting examples. The system then proceeds to step 463.

Regardless whether the system is performing steps for generation or modification of Ground Data, the system uses the Dependency Schema, to determine which layer(s) of the website need to be modified as a result of either the initial Ground Data generation or the Ground Data modification. Using the Dependency Schema established at step 444, the system identifies the affected layers—such as specific pages, sections, widgets, or design parameters—that are dependent on the changed Ground Data fields. The system then proceeds to step 466.

At step 466, the system modifies the layer data for the layers identified at step 463. In an embodiment, the AI model regenerates or updates the content, structure, or styling of each affected layer to reflect the new or updated Ground Data, ensuring full consistency across the parts of the website. The system then proceeds to step 470.

At step 470, the system generates new website artifacts based on the modified layer data produced at step 466. In an embodiment, this includes producing updated page files, section components, widget outputs, and any other deployable website assets that incorporate the propagated Ground Data changes, resulting in a fully regenerated and coherent website ready for packaging or publishing.

During modifications of website content, Sitemap or other stages of website creation or management, modifying any data on the website that has related Ground Data portions may trigger modification of corresponding Ground Data portion through the Ground Data dependency schema. In an embodiment, the copilot system may ask the user to confirm modification of Ground Data portion, if the modification is not clear or ambiguous.

More detailed description of the modification of the Ground Data is presented in the

### “interaction With Database and Ground Data Modifications” Section.

In an embodiment, the Ground Data management system supports rollbacks and version control, allowing the system to revert to previous version of Ground Data if needed (e.g. upon user request).

### Structured Content Entities Separated From Presentation

In one or more embodiments, the system maintains certain website content as Structured Content Entities rather than as ordinary page fragments. A Structured Content Entity may belong to an entity type having a type-specific schema, item instances, metadata, taxonomies, and validation rules.

A Structured Content Entity type may be defined by a machine-readable field catalog or other schema representation that specifies fields, field types, metadata requirements, taxonomy relationships, or item-structure constraints. Such entity types may coexist with ordinary pages, Sections, Widgets, and templates within the same website.

In one or more embodiments, a Structured Content Entity type definition additionally includes one or more machine-readable identifiers, singular or plural labels, field names, field types, required-field indicators, selectable-option sets, validation attributes, or other schema elements used to create, validate, store, query, and render item instances of that entity type. By way of non-limiting example, an entity type corresponding to services, team members, events, or other structured website content may specify a unique entity-type key, one or more display labels, and a field catalog that identifies which fields are text, email, URL, date, number, image, selection, boolean, or other types, together with required flags, option lists, or validation constraints associated with such fields.

A given Structured Content Entity type may have multiple item instances. Such items may be stored independently from page layout and later rendered through one or more Sections, pages, list templates, single-item templates, archive-like structures, or other presentation views.

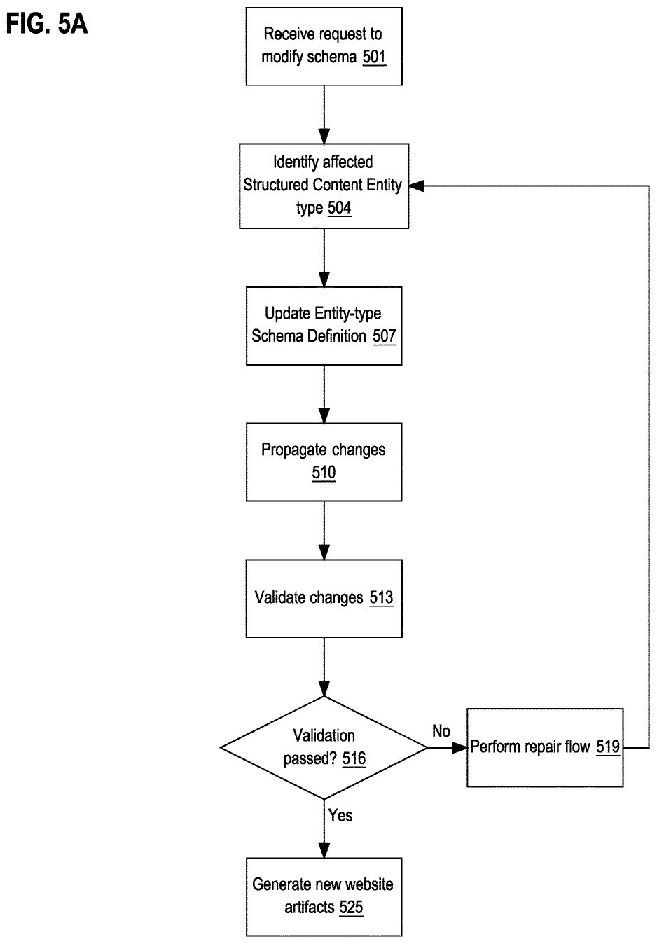

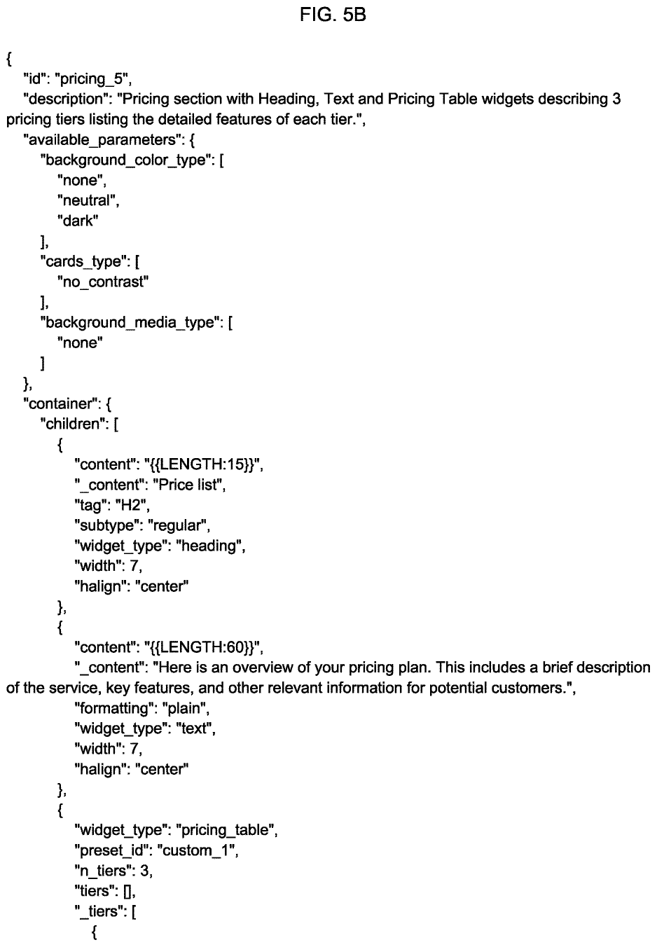

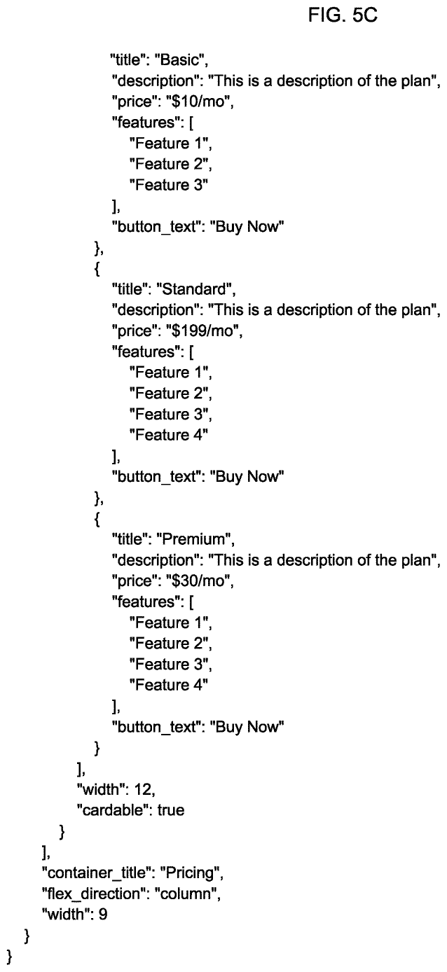

FIG. 5A is a flow diagram that depicts the process for modifying the schema of a Structured Content Entity type, in one or more embodiments. At step 501, the system receives a request to modify a schema. In the context of AI-based website generation, this request may originate from a user instruction, an automated system trigger, or a detected mismatch between the current schema definition and the intended content structure of the website. The request signals that one or more Structured Content Entity types—such as a “Product,” “Team Member,” “Blog Post,” or “Service”—may require a change to their defined fields, field types, relationships, or constraints. A schema modification may add, remove, or change fields, metadata rules, taxonomies, or other type-specific constraints, and the system may propagate such modifications into validation, storage, queries, bindings, and rendered output. The system then proceeds to step 504.

Continuing with FIG. 5A, at step 504, the system identifies the affected Structured Content Entity type associated with the schema modification request received at step 501. The AI model analyzes the request and determines which specific entity type or types are implicated—for example, recognizing that adding a “certifications” field targets the “Team Member” entity type, or that restructuring pricing tiers affects the “Product” entity type. In an embodiment, this identification ensures that subsequent schema updates are applied precisely and do not inadvertently affect unrelated entity types. In one or more embodiments, the system determines whether a user request, automated trigger, synchronization event, or other change request is to be applied to a Structured Content Entity layer rather than directly to a presentation layer. Such determination may depend on whether the requested change concerns entity data, entity-type schema, metadata, taxonomies, query behavior, bindings, or a rendered view that derives from one or more Structured Content Entities.

When the system determines that the requested change is directed to the Structured Content Entity layer, the system then proceeds to step 507.

At step 507, the system updates the Entity-type Schema Definition for the affected Structured Content Entity type identified at step 504. In an embodiment, the system modifies the formal schema definition to reflect the requested change—for example, adding, removing, renaming, or retyping fields; adjusting validation rules; or updating relational references to other entity types. In an embodiment, this updated schema definition becomes the new authoritative blueprint governing how instances of that entity type are structured across the website. The system then proceeds to step 510.

At step 510, the system propagates the changes made to the Entity-type Schema Definition at step 507 throughout the affected layers of the website. In an embodiment, the system traverses the Dependency Schema to identify every page, section, widget, content instance, and data record that references or is populated by the modified entity type, and applies the schema changes accordingly—for example, updating the existing “Team Member” content instances to include the newly added “certifications” field, or remapping widget bindings that referenced a renamed field.

Accordingly, the system may first update one or more entity definitions, schemas, item instances, metadata, taxonomies, bindings, or query rules, and may thereafter update, re-render, regenerate, synchronize, or validate one or more presentation structures that consume or display the affected Structured Content Entities.

At step 513, the system validates the propagated changes performed at step 510. In an embodiment, the system checks that the content instances, widget bindings, page structures, and data references that were affected by the schema modification are consistent with the updated Entity-type Schema Definition—verifying, for example, that the required fields are populated, that field values conform to their updated types, and that no broken references or data mismatches exist across the website layers. The system then proceeds to step 516.

At step 516, the system evaluates whether the validation performed at step 513 has passed. If at step 516, the system determines that the validation has passed (Yes), meaning the propagated changes are consistent and error-free, then the system proceeds to step 525. If at step 516, the system determines that the validation has failed (No), meaning one or more inconsistencies, broken references, or data integrity errors were detected, then the system proceeds to step 519.

At step 519, the system performs a repair flow to address the validation failures identified at step 516. In an embodiment, the system diagnoses the specific errors—such as missing required field values, type mismatches, or orphaned widget bindings—and applies targeted corrections to bring the affected content instances and website layers back into conformance with the updated Entity-type Schema Definition. In an embodiment, upon completing the repair flow, the system returns to step 504 to re-identify any remaining affected entity types and re-execute the schema update and propagation cycle until validation succeeds.

Based on step 516, at step 525, the system generates new website artifacts reflecting the fully validated and propagated schema changes. In an embodiment, the system model produces updated page files, section components, widget outputs, and the other deployable website assets that incorporate the revised Structured Content Entity type schema, resulting in a coherent and fully consistent website ready for packaging or publishing.

Accordingly, the techniques described herein address not only webpage generation, but also structured content domains that are stored separately from the presentation structures that render them.

### Generating Website Content

During the website creation process, the copilot system generates a complete website from scratch. The complete website contains multiple pages, which may be based on the instructions received from the user or on the suggestions of the system which are based on the user input and preferences. The final website includes page-level and Section-level templates and their content, such as header, footer, popups, templates for lists of products, blog posts, etc. Depending on the Subject Matter type, description, Sitemap and Ground Data and other inputs, the system may generate specific content portions for the website besides creating pages and templates. Such content portions include blog posts, products, team members, reviews, contact information, etc.

In one or more embodiments, website content generation is a staged process in which page-oriented structures and Structured Content Entity items are generated, transformed, validated, and rendered through templates, Sections, pages, or other presentation structures.

The output of the copilot system may be in different formats. The exact format of block-based artifacts depends on the platform-specific Page Builder. In one embodiment, the format of the output of the copilot system is in a JSON format that is used to generate the website with the Page Builder. In another embodiment, the format is an HTML code of the website or web components or block-based code that may be used to generate the website with any platform-specific Page Builder.

In one or more embodiments, the output may additionally include Web Component-based code or artifacts generated through the Webpage Composition Pipeline.

In one or more embodiments, the system distinguishes between authored artifacts that are still subject to validation, repair, packaging, or synchronization, and deployed artifacts that have already been imported or published to a live website environment.

Below the process of generating the website content is described in more details.

### Generating Media Content and Custom Code

Besides textual content, the system may generate media content for the website, such as images, videos, audio, etc. The media content may be generated based on the Ground Data, such as images of products, team members, blog posts, or may be generated based on the user input, such as a logo or a brand kit. The system allows users to add media during the website creation process.

In an embodiment, the system generates a description for media content for each media used in each Section. Additionally, the system may determine proper size for the media or may use the size for each media as provided. Then the system generates prompts and preferred styles for each media based on the description, size, context (the Section, the page including next and previous Sections, entire website), Ground Data and global styles. The Ground Data may include information about preferred styles of media or further instructions for generating descriptions or prompts for the media. The system may use base AI Model, fine-tuned AI Model or rule-based algorithm to generate the description, prompts and preferred styles for each media.

In one embodiment, the system considers the global styles of the website and uses them to generate images with corresponding colors or compatible colors.

In another embodiment, the system may generate Ground Data portions for media that specify the preferred styles of images (such as specifying if the media may be an anime) based on the user input. Such a Ground Data portion may be used to generate media for different pages and Sections in consistent style.

Given the prompts for media, the system may choose third-party text-to-image models for generating the media. The system may use a base model or fine-tuned model for generating the media. The system may use other rule-based algorithms for generating custom types of media, such as 3D models, logos, icons, etc.

In another embodiment, the system may choose between using an AI Model for generating media or using a service of stock media that provides matching media based on the prompts, preferred styles or initial media descriptions. The service of stock media acts as a cache and allows to “generate” media faster and cheaper. The decision to use an AI Model or stock media is based on image content description, preferred styles, and other parameters. The selection process may be configured or driven by AI Agent(s).

Generated media may be post-processed to enhance the quality of the media. The processing may include resizing, compressing, removing background, adding effects, changing colors, etc.

Generated and post-processed media may be stored externally, such as in a cloud storage or a database. Copies of generated media files may be included in the final package of the website or may be stored separately and linked from within the package. Upon importing the website, the system may download the media from the cloud storage or the final package and include the media in the generated website by uploading or linking the media files.

In one or more embodiments, media generation, storage, binding to content, and inclusion in the final package of webpage artifacts are coordinated as part of a unified asset lifecycle.

In one or more embodiments, media generation is context-conditioned and priority-aware so that model choice, stock-media retrieval, post-processing, validation, and synchronization behavior depend on the intended website scope, rendering context, and deployment needs.

The copilot system may also generate custom code for the website, such as frontend or backend code for integration with third-party services, custom scripts, and other code that is not typically displayed as blocks in webpages. The custom code may be generated based on the user input, such as a list of services or products, or may be generated based on the Ground Data, such as CRM data. The system allows users to add custom code during the website creation process.

In one or more embodiments, such custom code is subject to the same validation, packaging, synchronization, and deployment controls as other website artifacts. Custom code generation may be a controlled artifact-production step rather than an isolated code-generation step, including compatibility review, dependency-aware inclusion, and later reconciliation with the deployed website state.

### Section Types Classification

Layout of the webpage is based on one or more Sections. At the Webpage Outline stage each Section has a title, type, description and few other parameters, mostly related to style and layout. At the preview stage, each Section may also have a Section template chosen from the list of available Prebuilt Section Templates. When a user chooses a Section template from the list of available Prebuilt Sections, the system may display a preview of the Section with the template applied.

The system may include available pre-defined Section types. Section classification into Section types is achieved through AI Models or rule-based algorithms, which analyze parameters such as Section title, description, page type, website type, Subject Matter description of the website's objectives, and user preferences. Classification of Sections into Section types allows to leverage the prebuilt templates for Sections, thus reducing the complexity of the generation process and providing more consistent and predictable output. Each Section type may trigger generation of Ground Data portions for that Section type. Additionally, the system provides custom Section types that do not have prebuilt templates and are generated using freestyle generation.

In one or more embodiments, Section classification additionally determines whether a Section is associated with a Structured Content Entity source, whether to render item instances of a given entity type, and which later template or query behavior is to be applied.

Section classification may further determine a later generation techniques, parameterization mode, placeholder structure, validation path, or whether the Section is to be filled from ordinary page content, generated content, or schema-governed structured-content data.

The list of available Section types may be different for each page or website type. When a user customizes a Sitemap and Webpage Outlines of pages or upon initial Sitemap generation, the system may classify Sections into available Section types. Section types may also include “customsection types, which are not predefined. A non-limiting example of Section types may be “team”, “footer” or “call-to-action”. Each Section type has a set of parameters, which defines the style and layout of the Section. Each Section type has a title and description allowing to understand purpose and usage of the Section, thus becoming available for the user, AI-model or any other algorithm to choose for each Section.

In an embodiment, the system may generate Section types together with the Section titles and descriptions in the Sitemap, thus avoiding the classification step.

### Choosing Template For a Section

Upon choosing Section type for a Section, the system may choose a template for the Section from the list of available templates. The list of available templates is different for each Section type. The list of available prebuilt templates may depend on other parameters besides Section type, such as page type, website type, Ground Data, user preferences, etc. The algorithm for choosing a prebuilt template is called “template choosing algorithm” and may be rule-based or AI-based or a combination of both with different levels of complexity. The template choosing algorithm may take into account Section description, Section layout description, user preferences for template, etc. The data may be received in different formats, such as textual, audio, visual through screenshot, drawing or other media, or given as a reference URL or HTML snippet or their combination. Template choosing algorithm considers the provided information and chooses the best template match, given descriptions, structure and parameters of each template.

In one or more embodiments, template choice also depends on whether a Section is intended to render ordinary page content, a list of Structured Content Entity items, or a view bound to one or more entity-type schemas or taxonomies.

Each template has a set of parameters and features the template supports. The parameters of each template and the features supported of the template is stored in the metadata of the template. In one embodiment, parameters such as “supports background video,” “supports advanced grid,” etc. are stored in the template metadata.

In an embodiment, the user requests are classified and templates that cannot accommodate advanced user requests are filtered out.

In an embodiment, the system receives a request to apply a template during the quick preview stage. In response the system applies the chosen template and displays to the user. Further, the user may send another request to replace the chosen template. In response the system immediately updates the Section template.

In another embodiment, user may describe a Section for “features” of their offer that includes three columns and texts and images to showcase three features. The description of the Section may also include a preference for a template with dark background or three features looking like cards. The system may choose a template from the list of available templates for “featuressection type, which includes dark background and cards layout.

Prebuilt page or Section templates may include predefined structures with Widgets of different types placed hierarchically in container blocks like Sections, columns, rows, grids etc. Some parameters of Widgets and containers in the template may be defined as available for AI to modify, others may be fixed, yet others not available and not visible to AI. In an embodiment, this allows to have simple structures for templates with simplicity less than final HTML or block-based code, but more than just a list of Widgets.

In an embodiment a Section template may be a JSON structure with parameters for each Widget and container block, which may be used to generate the Section with the template applied. The parameters of a container may include its type (column, row etc.), the width (in arbitrary unit system, e.g. 12-col grid layout). As a non-limiting example, parameters of a Widget called “call-to-action” may include its heading text, description text, buttons text (for one or two buttons) and the layout parameters (e.g. title and description are on the left, buttons are on the right).

FIG. 5B and FIG. 5C are an example of a Prebuilt Section Template (in JSON format), in an implementation. Prebuilt page and Section templates may include custom parameters for each Widget thus allowing to have more flexibility in final output. Additionally, templates may have template-level parameters for the whole template which may be modified and applied to all or some Widgets in the template. In an embodiment, a template may have a global parameter called “cards layout”, which may be modified and applied to the Widgets to look like cards in the template, such as cards for each member of the team in the “teamsection. Additionally, card templates define the features of the cards, such as background color, shape, etc.

Choice of the template for the current Section may depend also on other Sections in the same page, such as neighboring Sections. In an embodiment, this does not allow certain combinations of neighboring Sections that do not look good together. Such constraints may be defined using either a rule-based approach or an AI-based approach. In the AI-based approach, a fine-tuned model determines whether two adjacent Sections may be placed together based on the prompt or field data. Additionally, choosing a Section may depend on the Ground Data and parameters in the Ground Data that are applied globally to the website. In one embodiment, a Ground Data may include a (sub)portions of data called “blog layout”, which may be a “grid” or “list”, and the system may choose a template for the current Section based on the blog layout, thus generating a similar layout for the pages that contain Sections of blog posts.

In one or more embodiments, template selection is therefore a constrained matching step that aligns local presentation with global design intent, nearby structures, and structured-content behavior.

### Freestyle Generation

Freestyle generation of a Section or a page refers herein to the generation of a Section or a page by an AI Model without using a prebuilt Section or Page Template. Freestyle generation is a process of generating a Section or a page without using any prebuilt templates. The system may use a base AI Model or fine-tuned AI Model or rule-based algorithm to generate the Section or page. Freestyle generation is used for the Sections having “customsection type. Sections having one of the pre-defined Section types are being generated using prebuilt templates. However, when the best match is not found in the prebuilt templates, the system may use freestyle generation. During the freestyle generation process, the AI Model uses its knowledge of the Section type, title, description, user preferences, related Ground Data, and context (including other Sections or pages) to generate a simple layout structure and content for the Section. The generation process includes choosing Widgets, defining the parameters of the Widgets, and placing the Widgets hierarchically within a layout structure.

The AI Model may be given the rules for building layout, or the AI Model may be a fine-tuned model trained on a dataset with valid or acceptable Section layouts. Such rules may include data about relations between Widgets, such as which Widget may be placed next to another Widget, or which Widget may be placed inside another Widget, or which Widget may be placed in the same row or column. In one or more embodiments, freestyle generation leads to complex or invalid structures if AI constraints are not strict enough. To prevent complex or invalid structures guardrails are implemented.

Depending on input parameters, the AI Model may shortlist the list of Widgets that may be used in the Section to reduce complexity, and the list of available Widgets for better quality of the output.

In an embodiment, a systematic approach for context (other Sections, pages, etc.) injection is used to minimize the use of essential data for each generation by the AI Model used in freestyle generation, instead of providing the context at once.

Such selective context reduction may preserve materially relevant state for a given subtask, thereby reducing noise, token usage, and propagation of irrelevant context into later decisions.

Freestyle generation may handle both structural layout tasks (such as Widget placement) and tasks relating to textual or media content. Blending these in a single call may reduce the quality of either output. In an embodiment, a two-phase approach is used: (1) generate layout structure, (2) fill textual content or images.

In one or more embodiments, output of freestyle generation is passed through one or more validation and repair stages before being accepted into authored artifacts for the website state.

### Choosing Widgets and Their Parameters

The list of Widgets and their parameters is configurable and may depend on context or available third-party integrations. Each Widget has type (title), description and parameters. Some parameters may be general for the Widgets (such as width), others may be specific for certain Widget types (such as list of menu items for navigation menu Widget). Each parameter has its type (e.g. integer, string, list of string, JSON, HTML) and possible values. Each Widget may have a different number of parameters, including custom parameters that may not be modified by the AI Model.

In one or more embodiments, the system additionally processes Web Components and their properties, configuration values, exposed interfaces, or implementation-linked metadata in a manner analogous to processing Widgets and their parameters.

Widgets may have a set of pre-defined parameters that are combined as one parameter, called preset. Preset is a set of parameters and their values that are used together and may be modified together. For example, a preset for “form” Widget may be called “purpose” and have possible values “contact”, “order”, “subscribe”, “signup”, “login”, “search”, “feedback”, “survey”, “other”. The system may use a preset to generate a form Widget with purpose “contact” which may automatically include fields for name, email, phone, message without need to reveal each field as a parameter to the AI Model. Thus, presets provide for abstraction and simplification of Widgets for the AI Model.

Similarly, Web Components may have predefined modes, variants, or parameter presets that combine multiple properties or implementation options into selectable configurations.

Parameters of Widgets in general case may not correspond to the final HTML or parameters of Widgets in exported block-based code. Each Widget has its own logic for converting AI-generated parameters into parameters for HTML or block-based code.

In one or more embodiments, analogous logic is applied to Web Components by converting AI-generated properties, presets, or configuration values into Web Component-based code, declarative markup, or other platform-specific representations.

Moreover, the Widgets as provided to the AI Model to generate prebuilt or freestyle templates may not correspond to the final Widgets in the exported Section or page. In an embodiment, a Widget in a simplified template is converted into several Widgets (a subtree of Widgets) in the final output (webpage or its part). For example, a “persons list” Widget in the simplified template may be converted into containers with Widgets for each person in the list. The exact algorithm of conversion of simplified template into final template is defined by the system and may be rule-based or AI-based or a combination of both with different levels of complexity. For example, the system may export a “heading” Widget with a “subtype” parameter set to “regular” as a “heading” Widget in the exported block-based code. Meanwhile, if the “subtype” parameter is set to “animated,” the system may convert the same “heading” Widget into an “animated” Widget.

In an embodiment, the system may implement guardrails for AI-generated freestyle templates and other templates to prevent generation of invalid or unacceptable layouts, Widget types or parameters and their values.

In one embodiment of freestyle generation process, the values of Widget parameters are generated by the AI Model. In an embodiment, the system may use rule-based algorithms or default values when generating values of some parameters, thus reducing the complexity of the generation process.

### Generating Section Content Using Prebuilt Template

Depending on the Section type, the system may choose a prebuilt template for the Section from the list of available templates. For such prebuilt templates, an AI Model is used to fill the template with content. The template contains some parameters as placeholders for AI Models to fill the placeholders with content. The placeholders may be empty or provide some snippets of prompt or hint for the AI Model suggesting what type of content may be generated and filled into the placeholder. For example, a placeholder for the “content” parameter of some “heading” may be {“three words about the company”}.

In one or more embodiments, a template may include Widgets, Web Components, markup fragments, code fragments, or combinations thereof. In one or more embodiments, the same template may additionally define how one or more Structured Content Entity items or item collections may be rendered in presentation form. In one or more embodiments, the system distinguishes between filling existing placeholders, rendering structured-content records into a presentation template, and regenerating a broader Section structure, and selects among such modes based on desired scope, efficiency, and control requirements.

In an embodiment, the system requests an AI Model to return values of placeholders, without generating the whole template (the template is provided to the AI Model), a “fill” approach. In another embodiment, the system requests an AI Model to return the whole template with placeholders filled with content, a “retype” approach. Depending on the template complexity, the system may choose between different models for different templates, by using more expensive and powerful AI Models for more complex templates.

As an optimization, in an embodiment, each Section content may be generated in parallel with other Sections, thus allowing the website to be generated faster. Dependencies between Sections and their content are managed through algorithms that define the relationships between Sections and Ground Data portions.

In one or more embodiments, the system distinguishes between parallelizable stages and dependency-sensitive stages so that later transformations, validation, synchronization, and/or packaging steps occur after prerequisite state is available.

### Converting and Building Final Block-Based Code Package

Given the Sitemap with a list of pages and templates, Sections with their content, Ground Data and global styles, the system converts the Sitemap into block-based code or HTML code (the “converter” module).

In one or more embodiments, the converter module is part of a broader Webpage Composition Pipeline that converts higher-level website representations into block-based code, Web Component-based code, HTML code, or other platform-specific artifacts.

The block-based code may be in a JSON format that may be used to generate the website with any platform-specific Page Builder. The final package contains not only block-based, Web Component-based, or HTML code, but also Web Component definitions, source-like representations, declarative markup, executable bundles, media content, custom code, and other instructions or markup that defines additional settings of the final website.

In one or more embodiments, the converter module operates after one or more stages of classification, template selection, placeholder filling, layout calculation, style application, validation, and repair, such that exported artifacts may differ from earlier authored representations while preserving the intended website state.

In one or more embodiments, the converter module additionally transforms Structured Content Entity types, item instances, metadata, taxonomies, or bindings into rendered views, list structures, single-item templates, or other presentation artifacts while preserving separation between storage form and presentation form.

In one or more embodiments, the system distinguishes among the website state with authored artifacts, validation-corrected state, packaged output state, and deployed website state.

### Applying Global Styles

The global styles including the Design Paradigm, global colors, fonts, themes/skins, etc., may be applied to each Section and page and the final website. The resulting values of corresponding parameters may be applied to each Widget, Section, page or the whole website.

Each Widget has a set of parameters. One or more parameters are directly generated by AI Model(s) or Agent(s). Other parameters are set in the Section template. Yet other parameters are custom parameters that are exported without additional processing, other parameters are retrieved from the set of global styles. The variety of settings of each Widget and their values are converted into exportable format of that Widget.

Application of global styles to each Widget is unique and may take into account the context of the Widget, such as the Section, the page (along with next and previous Sections), the entire website, or other Widgets in the same Section or page. A series of AI Models or rule-based algorithms are used to ensure that the global styles are applied correctly to each Widget. In an embodiment, before applying typography styles to a heading Widget, the system may check if the Widget is the main heading of the page, or a subheading or a minor heading in one of the Sections and choose the appropriate typography style from the global styles. Additionally or alternatively, an algorithm may run and find the best font-sizes of each textual element of each Widget from the global styles. In an embodiment, before applying colors to a button Widget, the system may check if the Widget is the main button of the page, or a secondary button in one of the Sections and choose the appropriate color from the global styles. Additionally, the system may take into account the global color scheme of the website, colors and backgrounds of underlying elements and choose a color that is readable and harmonious with the underlying elements.

In another embodiment, the system checks if there are two adjacent buttons in the same Section and ensures the consistency between the colors and styles of the adjacent buttons.

A different series of algorithms are used for consistency of styles of different elements across the website.

Similarly, views may render Structured Content Entity records so that schema-defined content domains remain visually consistent with ordinary pages and Sections.

### Layout Building and Other Algorithms

The system may use different algorithms for building layout of the website, such as rule-based algorithm, AI-based algorithm or a combination of both with different levels of complexity. Building a webpage layout is a complex process that involves multiple steps, such as arranging Widgets in the correct hierarchy and order, organizing alignments, managing spacing (including margins, paddings, and gaps), setting Widget sizes, and ensuring the layout is responsive and visually appealing across various devices and screen sizes.

In an embodiment, there might be different types of Sections and containers with different layout parameters, such as width, height, direction, inner layout, etc. Some Sections may be full-width, others may be boxed or have a different width. Some containers may be rows, while others may be columns, grids, or other types of containers. While some of these parameters are defined by the template or generated by AI Model(s), others may be computed based on the global styles, Ground Data, user preferences, and mutual relations between Widgets and containers.

In an embodiment, the system may adjust the chosen template for the Section or replace the Section with a different Section template if the chosen one does not fit the layout preferences or context. In an embodiment, if a series of templates have two-columns with textual content in the left column and image in the right one, the layout adjusting algorithm may replace such templates with symmetric templates having alternating columns with image and content.

In an embodiment, there are a series of algorithms, either AI-based or rule-based that are used to compute padding, spacings and margins of Widgets and containers in a way that makes Widgets located in different Sections of the page or same Section aligned, evenly spaced or grouped together. As rule-based algorithms may have different levels of complexity and there might be many edge cases and distinct layout substructures, a fine-tuned AI Model may be used to generate the detailed layout parameters of each Section as whole and then apply the parameters to each Widget in the Section.

Besides layout, a series of algorithms may be used to add animations and effects to the website and its Widgets. These algorithms consider global styles, Ground Data, user preferences, and the relationships between Widgets and containers, ensuring that animations and effects remain harmonious and consistent throughout the website.

Each website has a set of site-wide data, parameters and templates. In an embodiment, the system uses a series of algorithms to compute the values of site-wide parameters, such as list of menu elements, internal links, social media links, list of necessary modules (plugins, extensions, etc.) to install on the website, and other parameters.

In one or more embodiments, such site-wide parameters additionally include an inventory of installed or available modules, plugins, or extensions, dependency relationships among them, enablement state, configuration state, version state, and compatibility signals used to decide ordering of subsequent deployment or management actions.

In an embodiment, the system uses algorithms or AI Models to compare Sections across different pages and for the repeating Sections to be extracted as templates and be reused rather than duplicated.

In an embodiment, the system generates or chooses (through AI Model or rule-based algorithm) which pages and templates may be included in the header and footer menus and which ones may be excluded and be available through search or internal links from within the main content of the website and not navigation menus.

### Building and Importing Final Package

Building the final package includes generating media content, custom codes and converting pages and Sections into block-based code, Web Component-based code, HTML code, or other platform-specific artifacts.

Once the final package is imported into the platform-specific website, the site is fully ready for use.

In one or more embodiments, importing the final package includes activation of the generated structures, content, styles, media bindings, code, and settings needed for the selected deployment scope. In one or more embodiments, the final package is deployment-ready but remains distinct from intermediate authored artifact representations preserved by the system for later editing, validation, synchronization, rollback, or restoration.

In one or more embodiments, importing the final package into a website platform or CMS includes discovering current live website state, determining which modules, plugins, extensions, templates, data bindings, or settings are already present, and identifying missing, outdated, disabled, or incompatible elements before mutation occurs. In one or more embodiments, the system generates or selects a staged import sequence that may include installing one or more required modules, enabling previously installed modules, applying configuration values, importing content or templates, activating bindings, publishing selected artifacts, and verifying resulting website behavior.

The staged import sequence may be dependency-aware so that prerequisite modules, settings, schema changes, data migrations, or related platform capabilities are applied before dependent views, Sections, pages, or Structured Content Entity-backed outputs. After one or more import stages, the system may perform verification by checking availability of required modules, validity of configuration values, rendering success of affected pages or views, integrity of bindings, and consistency between internal state and live website state.

If a deployment stage fails or produces unacceptable results, the system may halt later stages, roll back selected imported elements, restore an earlier version or configuration state, or reconcile the live website with preserved authored artifacts or restore points. A package may have some Web Components set as optional and not included in the final package, such as SEO optimization, analytics, social media integration, etc. The system allows to add these Web Components later or to remove them from the final package.

Optional Web Components may correspond to optional modules or extensions that are installed or enabled when selected scope, compatibility constraints, user approval, or platform capabilities justify them. In case of a single page generation/modification, the package includes the page and the Sections in the page. In case of a full website generation/modification, the package includes the pages and Sections of the website. In case of single Section generation, the package includes the Section and its Widgets.

In one or more embodiments, the package may additionally include Structured Content Entity-backed views, related bindings, or other artifact Web Components needed for the chosen scope.

### Validation and Repair Pipeline

In one or more embodiments, generated or modified website output is processed through a validation and repair pipeline before acceptance, packaging, import, or publication. The pipeline may include structural validation, semantic validation, integration validation, style validation, accessibility validation, or combinations thereof. If a validation stage detects an issue, the system may reject output, invoke one or more repair operations, regenerate a portion of the output, retry earlier stages, or request user clarification. Repaired output may be re-validated before acceptance.

### Versioned Artifact Lifecycle

In one or more embodiments, the system preserves intermediate authored artifacts, validation-corrected artifacts, packaged outputs, published versions, restore points, and deployed website state as distinct lifecycle stages. Such separation enables comparison, rollback, restoration, scoped publishing, and controlled re-generation.

### Website Editing Through Editor Interface—Overview

Website Content Management Systems usually provide user interfaces for editing the website. In recent years drag-and-drop interfaces have become the most popular solutions for website editing. In such editors, users may perform certain actions on Widgets, such as adding, editing, removing, rearranging, aligning, resizing, styling them etc. The copilot system may be integrated into various visual website editor interfaces, such as WordPress (default block editor, Element or builder, Oxygen builder, etc.), Wix, Squarespace, Weebly, Shopify, etc.

In one or more embodiments, editable target elements include not only Widgets but also Web Components, source-represented webpage units, markup/code fragments, or other implementation-level structures corresponding to visible webpage content.

The copilot system enhances the editor user experience by providing a chat and voice interface for editing the website, as well as by adding extra UI elements to the editor interface to interact with the copilot system, such as extra buttons, inputs, dropdown menus etc.

Integration of the copilot system into the website editor interface significantly improves the user experience. The main problem of editor interfaces is their complexity and the large sets of styling parameters. Users often struggle with the learning curve, different user experiences for different platforms, and large sets of styling parameters that may require substantial time to learn, find and apply.

The copilot system may achieve the final goal of editor interfaces, that is getting the desired webpages, by doing it much faster and better. Unlike existing site builders that may use simple AI integrations to merely generate individual pages or Sections in isolation, the present techniques orchestrates multiple AI Agents to propagate the stylistic and structural changes consistently across the entire website.

The copilot system in editor interface may call frontend APIs of platform editor functionality and backend APIs of the platform to get information about the website, website's content, structure, parameters, styles, etc., and to apply changes to the website by implementing actions such as inserting, modifying, removing, suggesting. The steps may be applied to a single Widget, Web Component, whole Section, whole page, whole website or a combination thereof. As there is a large variety of user-performed steps through the editor interface, the system uses AI Agents to perform these steps. The system determines intent (the main action(s)), the desired output and recursively splits the main action task into subtasks for different AI Agents (task planning). The copilot system in the editor interface may be configured to request the user to provide missing data (for the main action(s) or for some subtask) or to clarify the user input.

In one or more embodiments, the system classifies the request into a modification scope before executing the request, including Widget-level, Section-level, page-level, site-wide, or Structured Content Entity-level scope, and selects a corresponding execution path.

In an embodiment, the copilot system is implemented not only for editor interface, but also for the post-rendered (in the frontend of) website (as is seen by website visitors), with ability to select Widgets right in the website frontend without the need to load heavy editor interfaces with numerous UI elements.

If not provided explicitly, the system, through a special AI Agent identifies Widgets relevant to the user's request (target Widgets) by analyzing on-page Widget structures. In an embodiment, in order to improve intent recognition, the copilot system's AI Agent uses a specially trained or fine-tuned model that was trained on user prompts.

Accordingly, the target element identification process may identify a Widget, a Web Component, a parent or child structure thereof, or an underlying source-represented element responsible for the requested visible behavior or appearance.

The result of the action of the copilot system in the editor interface is not limited to producing the desired Widgets/Sections/pages but also includes modification of website parameters or Ground Data, such as styles, or modifying and adding extra settings or content into the website, which is not necessarily the direct output of the action in the editor interface. In an embodiment, in response to a request to modify a Section, the system modifies the Section, replaces the content of the Section on the webpage, and saves one or more new settings into website global settings.

The techniques described herein are not limited to Widget/block-only representations and may be applied to mixed Widget-Web Component architectures or Web Component-oriented website generation systems. In one or more embodiments, the result of an editing action also includes modification of Structured Content Entity items, entity-type schemas, bindings between entities and rendered views, or synchronization instructions for reconciling internal and live website state.

The copilot system may be used as a chat tool for getting help, asking questions about the editor interface, website, platform, etc. The copilot system may provide the user with the feedback on what to improve on the website or on the current page. In an embodiment, the system uses AI Models to predict the user's most probable next action and proactively suggest the change to the user. In another embodiment, the system uses AI Models that estimate how well the content of the Section or page fits the user's preferences, overall website design and context (including Ground Data) and suggest what to improve.

In an embodiment, selection of target elements (such as Widgets, Sections, pages, websites) may be done by clicking on the Widget/Section in the editor interface.

Additionally or alternatively, the selection of the target element(s) is done by selecting the Widget or the Section in the editor interface and then clicking on the “edit” button.

In another embodiment the user may provide as an input the unique identifier of the Widget or Section in the chat or voice interface.

The selection may be possible by indirectly telling about the target element in the chat or voice interface in conversational manner. Moreover, the user may not specify the target element. In case the target element is not selected explicitly, the system may use AI Agents to find the target element by analyzing the user's input and context. In that case the list of possible target elements or the whole page or Section content (list of Widgets and their some parameters) is being sent to the AI Agent. The agent then chooses the target element and returns its unique identifier.

In an embodiment, the copilot system receives a user request to “Change the hero banner's background to a video showing real estate imagery and move the ”Contact Us“ button to the center.” Receiving the user request triggers a series of steps by one or more AI Agents.

AI Agent 0 (the supervisor), responsible for intent recognition and task planning, splits the task into two subtasks: changing the hero banner's background and aligning the button. Then AI Agent 1, responsible for target Widget identification, identifies the “hero bannersection, finds out the unique ID of the Widget that has a relevant background. During the next step, AI Agent 2, responsible for finding relevant parameters of a Widget, retrieves relevant parameters (background type, file URL, alignment).

After receiving the relevant parameters of the Widget, AI Agent 3, responsible for video generation, generates a relevant video. AI Agent 4, responsible for background modification, replaces the background with a generated video (in an embodiment, through a tool call).

For the second action, the same AI Agent 1, responsible for target Widget identification, identifies the “Contact Us” button and finds out the unique ID of the Widget. Then AI Agent 2, responsible for finding relevant parameters of a Widget, tries to retrieve a relevant parameter but does not find the alignment of the button as whole among the list of button's own parameters. In an embodiment, this triggers AI Agent 1 to suggest the parent container of the button as the correct target element. Subsequently, AI Agent 2 retrieves relevant parameters of the parent element (content alignment of the button's parent container). Then AI Agent 5, responsible for basic parameters modification, changes the content alignment parameter of the parent container (in an embodiment, through a tool call), thus moving the button to the center.

AI Agent 6, responsible for reviewing, determines if the changes are correct and correspond to the user request. If the changes correspond to the user request, the changes are applied to the website. Otherwise, the system requests the user to provide clarification(s).

The final output of the copilot system is the modified Section with the changes applied, replacing the original Section in the editor interface and presented to the user for approval. If the user approves the changes, the system applies them to the website, otherwise, the original Section is restored.

In one or more embodiments, approval is received before committing broader-scope side effects, including propagation to related pages, Structured Content Entity-backed views, or live published website state.

The system and each AI Agent may be improved through use of fine-tuned or trained specialized AI Models. The training and fine-tuning of AI Models are done through one or more datasets.

In an embodiment, user feedback may be used in the process of training and fine-tuning one or more AI Model. The system suggests certain changes to the webpage and outputs the result, however users are allowed to approve or reject the changes. The data about user's approval or rejection is stored in a dedicated database for different initial action prompts, different target elements etc.

In another embodiment, user inputs for correcting the output are used. In particular, when the system sends the result to the user, the user may correct the result. The system stores the data about user's correction in the dataset to train the AI Models responsible for different tasks and subtasks.

Additionally, the user may suggest further actions. The data about the user's further actions is stored in a database and is used to train the system to better tailor the system to serving the users' needs.

In another embodiment, full conversation with further messages from the user and responses by the system are used as a proxy for the user's approval or rejection. An AI Model, based on the full conversation between a user and the system, estimates a set of pre-defined metrics for the success of the action. The metrics are stored in a database and are used to train the system to better tailor the system to serving the users' needs.

In an embodiment, the field data of different AI Agents (inputs, outputs) is filtered according to quality criteria (user satisfaction, relevancy, and other metrics based on user feedback/data or AI-feedback). Then this filtered data is used as an example dataset to generate synthetic dataset (e.g. through one-shot or other techniques) of user inputs, agent inputs and outputs, and to train/fine-tune the AI Models upon them.

### Single Widget Modifications

Modification, addition or removal of a single Widget is the basic scenario of website editing. In an embodiment, a user may want to tweak a button style or change text content quickly without overhauling an entire page. To do this the target Widget is being selected either by the user or an AI Agent (target Widget identification agent). Further, the system receives a description of the desired modification to the Widget through the chat or voice interface which may also include one or more visual references or examples. The editor interface sends Widget and context parameters to the copilot system. The system applies the modification to the Widget and replaces the Widget with the modified one in the editor interface.

The third step is done by the copilot system, which uses AI Agents to apply the modification to the Widget. Based on the prompt, the copilot system first decides intent, decides if the task is simple or complex or if the task is a single task or may include several subtasks to be executed in sequence. Based on that, the supervisor AI Agent responsible for task planning decides which AI Agent to use and how to split the task into subtasks.

In one or more embodiments, single-Widget requests are routed through a bounded action flow that limits allowed parameters, allowed mutation targets, and allowed tool calls before the modification is performed.

The AI Agent responsible for intent recognition may be the same supervisor Agent that acts as task planner and classifier. In an embodiment, a list of possible actions and their descriptions are provided to the AI Agent to choose from. In another embodiment, the AI Agent is a fine-tuned or trained model that was trained on user prompts to recognize the intent of the user. A special AI Agent may be used to adapt a user message to the copilot system's language (translation, spellcheck, paraphrasing etc.) before the user message is sent to the supervisor AI Agent. The supervisor AI Agent triggers a series of AI Agents to execute the subtasks, which are modifications of settings, creation or removal of a single Widget or a series of such tasks. The supervisor Agent generates parameters of request to each sub-Agent.

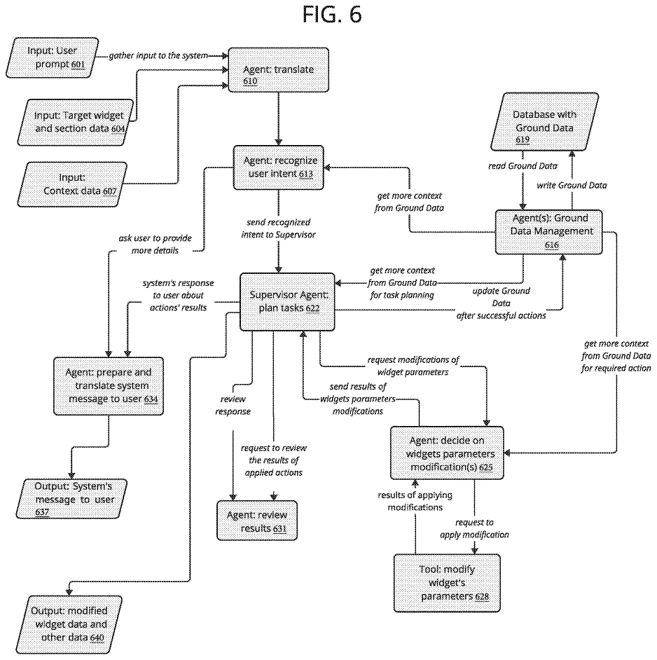

FIG. 6 is a block diagram that depicts website editing process by modifying a specific Widget through AI Agents, with an AI Agent responsible for Widget settings modification being triggered, in one or more embodiments. The process may include separate AI Agents for translation, user intent recognition and task planning (supervisor), calling an AI Agent responsible for Widget settings modification in a loop to modify several settings and using another AI Agent for reviewing the results of action to check if the results fulfilled the user's intent or not.

At block 601, the system receives the user prompt as input. In an embodiment, In an embodiment, this is a natural language instruction provided by the user through a chat or voice interface describing the desired modification to a Widget—for example, “change the button color to blue” or “make the headline text larger.”

At block 604, the system gathers the target Widget and section data as input. In an embodiment, this includes the structured parameters, properties, and configuration data of the specific Widget selected for modification—either by the user directly in the editor interface or by a target Widget identification AI Agent—as well as the data of the enclosing section in which the Widget resides.

At block 607, the system gathers context data as input. In an embodiment, this includes any additional contextual information relevant to the modification request, such as the page layout, design parameters, global style settings, or visual references provided by the user that may inform how the Widget modification may be executed.

At block 610, the Translation Agent gathers inputs to the system and preprocesses the user prompt before the prompt is passed to downstream AI Agents. In an embodiment, this Agent may apply translation, spellchecking, and paraphrasing as necessary to normalize the user's natural language instruction into a clean, well-formed expression that the copilot system's AI Agents may reliably interpret—ensuring that linguistic variation, typos, or ambiguities in the original user input do not impede accurate intent recognition.

At block 613, the Intent Recognition Agent receives the translated user prompt from block 610 and determines the precise intent of the user's modification request. In an embodiment, the Agent classifies the request—for example, identifying that the user intends to modify a style property such as button color, or to update a text content field—and assesses whether the task is simple or complex and whether the task constitutes a single action or a sequence of subtasks. In one or more embodiments, the Agent selects from a predefined list of possible actions and their descriptions, or alternatively is a fine-tuned model trained on user prompts to recognize intent. The Agent may also consult block 616 to retrieve additional context from the Ground Data to support accurate intent classification. The system then sends the recognized intent to block 622.

At block 616, the Ground Data Management Agent(s) serve as the interface between the AI Agents and the Database with Ground Data at block 619. Throughout the process, this Agent reads Ground Data from block 619 to supply relevant context to the Intent Recognition Agent at block 613, the Supervisor Agent at block 622, and optionally the Widget Parameters Modification Agent at block 625. The Agent may also write updated Ground Data back to block 619 after successful modification actions have been completed. In an embodiment, this block may be invoked multiple times throughout the overall flow at the request of different Agents.

At block 619, the Database with Ground Data serves as the persistent data store containing the website's authoritative semantic content—including business information, content field values, entity instances, and structured content records. In an embodiment, Ground Data is read from and written to by the Ground Data Management Agent at block 616 throughout the modification flow, ensuring that the AI Agent decisions are grounded in the current state of the website's content.

At block 622, the Supervisor Agent receives the recognized intent and acts as the central task planner and orchestrator for the entire Widget modification flow. The Supervisor Agent decomposes the request into one or more subtasks, determines which AI Agents to invoke, generates the parameters of the request to each sub-Agent, and maintains the sequencing of execution. The Supervisor Agent also retrieves additional context from the Ground Data Management Agent at block 616 for task planning, and updates Ground Data via block 616 after successful actions. The Supervisor Agent operates in a loop—dispatching subtask requests to block 625 and receiving results back—until the planned modifications have been executed and reviewed. If insufficient information is available to plan tasks, the Supervisor Agent may request the user to provide more details, routing a clarification prompt back to the user via block 634.

At block 625, the Widget Parameters Modification Agent receives a request from the Supervisor Agent to decide on and execute specific Widget parameter modifications. Operating in an inner loop, this Agent may determine the precise parameter changes to apply to the target Widget—such as adjusting a CSS style value, updating a content field, or toggling a configuration option—within the bounded action flow that limits allowed parameters, mutation targets, and tool calls. The Agent may retrieve additional context from the Ground Data Management Agent at block 616 to conform to its specific action. The Agent may then issue a request to apply the modification via block 628, receives the results of applying the modification back from block 628, and may iterate through multiple parameter modifications in sequence. Upon completing its modifications, the Agent sends the results of the Widget parameter modifications back to the Supervisor Agent at block 622. The loop runs until the parameter modifications assigned by the Supervisor Agent have been applied.

At block 628, the Widget Parameter Modification Tool receives a request to apply a specific modification to the target Widget's parameters. In an embodiment, this is a deterministic tool—not an AI Agent—that executes the precise, bounded parameter change instructed by the Agent at block 625, directly mutating the Widget's configuration within the editor interface. The tool returns the results of applying the modification back to block 625.

At block 631, the Review Agent receives a request from the Supervisor Agent to review the results of the applied Widget parameter modification actions. The Agent may evaluate whether the modifications achieved the intended outcome as specified by the user's original request—for example, confirming that the button color was correctly changed or that the content field was accurately updated—and returns its review response to the Supervisor Agent at block 622, which may then decide to approve the results or trigger further corrective actions.

At block 634, the Message Preparation and Translation Agent receives the system's response about the actions' results from the Supervisor Agent and prepares a clear, user-facing message describing the outcome of the Widget modification. The Agent may format and translate the response to match the user's language and interface context.

At block 637, the system outputs the System's message to the user—a natural language confirmation or status report presented through the chat or voice interface, informing the user of the outcome of their requested Widget modification, such as confirming success or describing any issues encountered.

At block 640, the system outputs the modified Widget data and other data—the updated Widget configuration and any associated data changes that are returned to the editor interface, replacing the original Widget with the modified version so that the user may immediately see the result of the applied modification in the website editor.

For each agent and subtask there is a set of guardrails that is implemented through the “tools” these Agents use by calling them and getting their returned values. Tools for single-Widget actions are a set of functions that modify the Widget or Widget's parameters. If there is no such a parameter, or one or more values of the parameter are incorrect, the tool returns an error. In such a case the last called AI Agent is re-called with the same parameters and the error response of the tool. In case of repeated errors, the previous Agent in the chain is re-called with the same parameters and the error responses of the tool.

In one or more embodiments, these guardrails implement protocol-validated action invocation by requiring supported action types, target identifiers, parameter names, parameter values, or dependency conditions to be satisfied before the website is mutated.

To produce desired output the copilot system may be provided with information about Widgets and context. Information about Widgets includes their descriptions, parameters (name, description, type, value, possible values, etc.), styles, presets, mutual relations. Information about context includes page-wide data, such as structure of the page and its content, site-wide data, such as structure of the website, list of pages etc. And Ground Data, such as business data, market data, user preferences, Website Sitemap or summary etc. A special type of context are the global styles and the Design Paradigm of the website, which either are fed to the system from the website or provided with the Ground Data in raw or processed form.

A special type of context is the history of messages. In an embodiment, the history includes user messages to the system and system responses to the user within a certain context. Such context may be defined as time-based, topic-based, number-of-steps-based, page-based or other, or a combination of such. In another embodiment, the context may also include the messages sent between AI Agents or inputs/outputs of tools during previous requests to the system. Each AI Agent may store the relevant messaging history context into its memory and retrieve such context from there. The system is configurable and depending on the AI Agent, some subsets of the messages are considered as relevant to the given AI Agent. In an embodiment, for a certain AI Agent, messages from the user, the supervisor AI Agent, messages between the current AI Agent and the supervisor AI Agent, and inputs/outputs of the tools employed by the current Agent are deemed as relevant.

Beyond purely visual edits, the system may update functional parameters. For instance, the system may change an on-click behavior to redirect to a new page or toggle advanced analytics triggers. These changes go through the same multi-agent pipeline, ensuring consistency with global site settings.

The list of Widgets and their parameters provided to the copilot system are configurable and may be different for each page or website type. In an embodiment, the system implements a series of optimizations. In an embodiment, the optimization includes providing some parameters of Widgets to AI Agents, such as parameters that are relevant to the task, those not set in the template, those not set in the Ground Data or global styles. In another embodiment, the system combines a series of parameters into one parameter, called preset, which is a set of parameters that are used together and may be modified together. In another embodiment, the optimization includes renaming and modifying parameters of Widgets or converting them to a different representation in general to make them more understandable for AI Agents and easier to modify.

In an embodiment, the system may use fine-tuned or trained AI Models that were trained on a dataset of Widgets and their parameters.

If an AI Agent's proposed change is incompatible with the Widget's parameters, the system prompts the user to revise or reselect the Widget, ensuring no disruptive changes go live.

The system is extensible and additional Widget types or parameters may be “plugged in” to the system as new Widgets become available. The availability of new Widget types or parameters is determined by website builder or platform software, webpage type, Ground Data etc.

### Section-Wide Modifications

Section-wide modifications simultaneously update multiple Widgets (e.g., header images, text blocks, buttons) while preserving visual consistency, in an embodiment. Section-wide modifications include adding, removing, rearranging, replacing or modifying parameters of single or multiple Widgets in the Section, including the entire Section itself. The input to the copilot system includes the Section and its content, the output is the modified Section and its content.

For instance, suppose a user wants to convert a three-column features Section into a two-column layout, update a background image, and adjust the text content of each feature simultaneously. The copilot system would parse these requests, identify relevant Widgets (e.g., text blocks, images, CTA buttons), and coordinate multiple AI Agents to handle layout changes, textual updates, and style reapplication in sequence or parallel, depending on the complexity.

The context provided to the copilot system is similar to the one provided for single Widget modifications.

Similar to single Widget modifications, based on the prompt, the copilot system decides intent, and decides if the task is simple or complex, or if the task is a simple single task, or a complex but single task, or if the task may require several tasks to be executed in sequence. Based on that the supervisor AI Agent responsible for task planning determines which AI Agent to use and how to split the task into subtasks. Changing an entire Section may involve numerous Widgets, layouts, and style parameters. The AI Agents coordinate more complex tasks, such as rearranging multiple elements or updating an entire color scheme for the Section. For that purpose, a series of AI Agents may be used to evaluate how each subtask may be executed within the scope of the primary task, as well as to generate reusable parameters and their values to pass to these subtasks. Additionally, the copilot may use AI Agents to review the output of the subtasks, how well the subtasks fit into the primary task and to make final adjustments if necessary.

A multi-Agent chain is used for Section-wide modifications. The chain may have arbitrary length and depth (with limits set by the system configuration for performance and quality) and may be executed in parallel and/or in sequence. In an embodiment, when the user requests a new background image for the entire Section, the first AI Agent identifies the best-fitting global style and relevant local overrides. A second AI Agent sources or generates the image, ensuring brand consistency. Additionally, if the user requests to rearrange text blocks, a third AI Agent reflows the layout parameters while respecting the newly inserted media. The supervisor AI Agent then validates each AI Agent's output for conflicts before finalizing the changes.

During the task execution, the copilot system may ask the user to provide missing information or to clarify the user input. The system and its AI Agents are configurable through prompts to have a required balance between execution of tasks and requesting more clarifications from users. The copilot system also has optimizations per different AI Agents and subtasks. In an embodiment, the copilot system limits the list of Widgets and their parameters to be provided to AI Agents to reduce the complexity of the task or subtask and improve the quality of the output. For each subtask, the copilot system may request a portion of contextual or related information from Ground Data or global styles. The system may use references to site-wide or page-wide data when making Section-level changes (e.g., ensuring brand colors remain consistent, verifying that a new layout does not conflict with adjacent Sections). To achieve this, guardrails may be used to ensure that the changes are consistent with the overall design and structure of the website. Additionally, if certain text or images within the Section derive from Ground Data entries (e.g., product details), the system cross-references these entries to keep them updated and consistent with any global changes in the Database.

Section-level changes may therefore operate as a controlled subgraph of a broader website state, where local changes are checked against page-wide, site-wide, or structured-content dependencies before acceptance.

Because each Section-wide modification is tracked, the same transformation (such as converting a standard hero layout into a two-column structure with new styles) may be rapidly applied to similar Sections on other pages, preserving design continuity and reducing repetitive tasks. In order to perform such global changes, the copilot system may request permission from the user to apply the same changes to other Sections. More details about how such changes may be performed are described in “WEBSITE DESIGN MODIFICATIONS, REDESIGN AND REBRANDING AND BULK CONTENT MODIFICATIONSsections.

In an embodiment, the copilot system uses a series of fine-tuned or trained AI Models to perform different subtasks.

In an embodiment, the copilot system may implement Retrieval-augmented generation (RAG) or similar techniques with external data sources to enhance the accuracy and reliability of AI Agents. Such data sources may include information about Widgets (e.g. their documentation) and website builder or platform software, tutorials or similar about how to use the platform-specific editor interface, or other information that may cause AI Agents to understand the user prompt and to produce the desired output.

In an embodiment, the Section-wide modifications are broken down into per-Widget modifications and are recursively applied to each Widget in the Section.

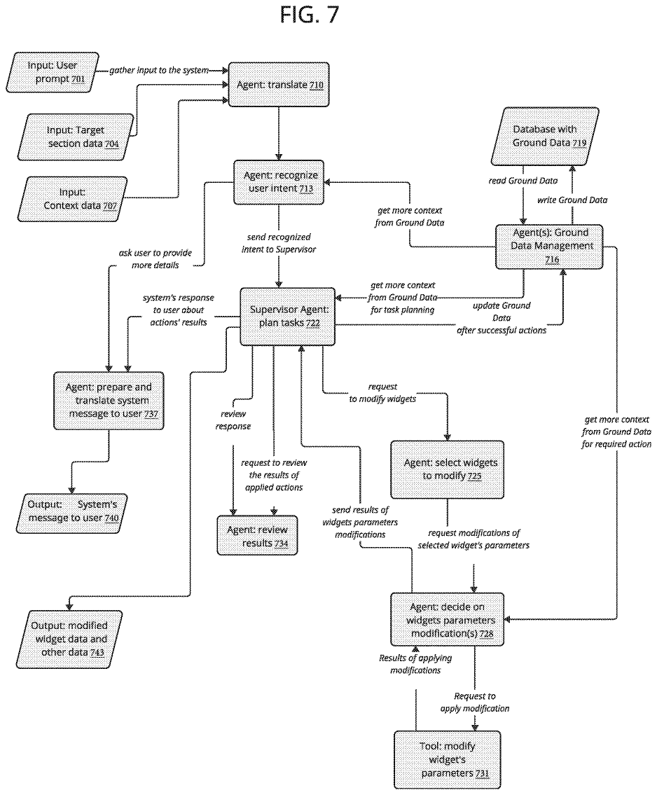

FIG. 7 is a block diagram that depicts website editing process by modifying a specific Section through AI Agents, in an implementation. Such an example flow has a separate AI Agents for translation, user intent recognition and task planning (supervisor), calling an AI Agent responsible for target Widgets selection, and their settings modification in a loop to create and modify Widgets in a Section and using another AI Agent for reviewing the results of action to check if results fulfilled the user's intent or not in one or more embodiments.

At block 701, the system receives a user prompt as input. In an embodiment, this is a natural language instruction provided by the user through a chat or voice interface describing the desired modification to a Section of the website—for example, “redesign this section to feel more modern” or “add a pricing table to this section.”

At block 704, the system gathers the target Section data as input. Unlike the single-Widget flow of FIG. 6, this input comprises the full structured data of the entire target Section, including its layout configuration, its constituent Widgets and their current parameters, and the Section's positional and stylistic properties within the page. In an embodiment, this Section-level data is what enables the Supervisor Agent to decompose the request into per-Widget subtasks.

At block 707, the system gathers context data as input. In an embodiment, this includes supplemental contextual information relevant to the Section modification request—such as global design parameters, page-level layout constraints, visual references provided by the user, Ground Data content fields that populate the Section, and any platform-specific documentation retrieved via Retrieval-Augmented Generation (RAG) about the Widgets or website builder in use—all of which inform accurate intent recognition and task planning downstream.

At block 710, the Translation Agent gathers the inputs to the system and preprocesses the user prompt before passing the input to downstream AI Agents. The Agent applies translation, spellchecking, and paraphrasing as necessary to normalize the user's natural language instruction into a clean, unambiguous expression that the copilot system's AI Agents may reliably interpret. In one or more embodiments, this Agent may leverage RAG with external sources such as Widget documentation or platform tutorials to better adapt the user's message to the system's operational vocabulary.

At block 713, the Intent Recognition Agent receives the translated user prompt from block 710 and determines the precise intent of the user's Section modification request. The Agent classifies the request, assessing whether the request implies adding new Widgets, removing existing ones, modifying styles or content across multiple Widgets, or a combination of such operations, and whether the task is simple or may require a complex multi-Widget sequence. The Agent may consult block 716 to retrieve additional context from the Ground Data to support accurate intent classification. In one or more embodiments, this Agent is a fine-tuned or trained model specifically optimized for recognizing Section-level editing intent. The system then sends the recognized intent to block 722.

At block 716, the Ground Data Management Agent(s) serve as the interface between the AI Agents and the Database with Ground Data at block 719. Throughout the process, this Agent reads Ground Data from block 719 to supply relevant content context to the Intent Recognition Agent at block 713, the Supervisor Agent at block 722, and the Widget Parameters Modification at block 728 as each may request for its specific action. The Agent also writes updated Ground Data back to block 719 after successful modification actions have been completed, maintaining consistency between the website's content store and the modified Section. In an embodiment, this block may be invoked multiple times throughout the overall flow.

At block 719, the Database with Ground Data serves as the persistent, authoritative data store containing the website's structured semantic content—including entity instances, content field values, business information, and the records that populate the website's Widgets and Sections. Ground Data is read from and written to by the Ground Data Management Agent at block 716 throughout the Section modification flow, ensuring that the AI Agent decisions are grounded in the current core state of the website.

At block 722, the Supervisor Agent receives the recognized intent and acts as the central task planner and orchestrator for the entire Section modification flow. The Supervisor Agent decomposes the Section-level modification request into a set of per-Widget subtasks, determines the sequencing and parameters of each subtask, and dispatches requests to the Widget Parameters Modification Agent at block 728 in a loop—iterating over the Widgets that constitute the Section until the planned modifications have been applied.

At block 725, the Widget Selection Agent receives a request to modify Widgets from the Supervisor Agent and is responsible for identifying which specific Widget or Widgets within the target Section are to be modified for the current subtask iteration. In one or more embodiments, this Agent leverages RAG with Widget documentation to make informed selections—understanding what each Widget is capable of and which ones are appropriate targets for the requested change.

At block 728, the Widget Parameters Modification Agent receives a request to decide on and execute specific parameter modifications for the Widget selected at block 725. In an embodiment, this Agent determines the precise parameter changes to apply—such as altering layout properties, updating content bindings, adjusting style values, or toggling configuration options—within the bounded action flow appropriate for the Widget type. The Agent may retrieve additional Ground Data context from block 716 based on its specific modification. The Agent then issues a request to apply the modification to block 731, receives the results of applying the modification back from block 731, and may iterate through multiple parameter changes for the same Widget in an inner loop until the modifications for that Widget are complete. Upon finishing, the Agent sends the results of the Widget parameter modifications back to the Supervisor Agent at block 722. The inner loop runs until the parameter modifications for the currently selected Widget have been applied.

At block 731, the Widget Parameter Modification Tool receives a request to apply a specific, bounded modification to the selected Widget's parameters. In an embodiment, this is a deterministic tool that executes the precise parameter change instructed by the Agent at block 728, directly mutating the Widget's configuration within the editor interface. The tool returns the results of applying the modification back to block 728.

At block 734, the Review Agent receives a request from the Supervisor Agent to review the cumulative results of the Widget parameter modification actions applied across the Section. The Agent evaluates whether the complete set of per-Widget modifications collectively achieved the user's original Section-level intent—for example, confirming that a Section redesign is visually coherent and functionally correct across the modified Widgets—and returns its review response to the Supervisor Agent at block 722, which may then approve the results or trigger further corrective iterations.

At block 737, the Message Preparation and Translation Agent receives the system's response about the actions' results from the Supervisor Agent and prepares a clear, user-facing message summarizing the outcome of the Section modification. The Agent formats and translates the response to match the user's language and interface context, conveying which Widgets were modified, what changes were applied, and whether the overall Section modification was completed successfully.

At block 740, the system outputs the System's message to the user—a natural language confirmation or status report delivered through the chat or voice interface, informing the user of the outcome of their requested Section modification.

At block 743, the system outputs the modified Widget data and other data—the complete set of updated Widget configurations and associated data changes for the Widgets modified within the target Section, which are returned to the editor interface to replace the original Section content with the fully modified version, allowing the user to immediately review the result of the AI-driven Section modification.

In an embodiment, there are a series of substructures of Widgets that are not passed to AI Agents, such as Widgets that are not editable, Widgets that are not visible in the editor interface or other special cases. Such substructures are unmodifiable for AI Agents but may have rule-based or other algorithms to modify them.

In an embodiment, there are actions/subtasks that are combinations of other actions/subtasks and are defined as groups of tasks/actions. The copilot system may apply such groups of actions/subtasks in parallel or in sequence.

Section-wide modifications under the hood may include the same algorithms as those used during generation of the website, as described in “GENERATING WEBSITE” section, but limited to the scope of one Section. In an embodiment, for certain requests, the system may first generate the Section according to the above-mentioned flow, then apply modifications over the Section.

### Page-Wide Modifications

Whereas Section-wide changes focus on updating a single grouping of Widgets, page-wide modifications include adding, removing, rearranging, replacing or modifying parameters of single or multiple Widgets in the page, including the entire page itself. Such modifications may include global text changes, mass Widget updates, or layout reshuffles spanning multiple Sections on a page. The input to the copilot system is the page and its content, the output is the modified page and its content. Page-wide modifications may affect every Section on the page.

In an embodiment, if a user requests to rebrand a landing page by updating the headings to a new font, adjusting the background across multiple Sections, and merging two testimonial blocks into one, the copilot system first inventories the relevant Sections on the page, spawns layout and style AI Agents, and applies these modifications in a controlled sequence. Once each change is validated, the user is presented with a cohesive, updated version of the entire page.

The context provided to the copilot system is similar to the one provided for single Widget and Section-wide modifications.

For page-wide modifications, the copilot system breaks down the tasks into subtasks per Section of that page.

In one or more embodiments, page-wide modifications additionally coordinate shared page state such as navigation, internal links, style hierarchy, page-level metadata, and rendered views of Structured Content Entity collections appearing on that page.

Page-wide modifications under the hood may include the same algorithms as those used during generation of the website, as described in “GENERATING WEBSITE” section, but limited to the scope of one page.

### Site-Wide Modifications

Site-wide modifications of website global parameters and settings (including global styles, Design Paradigm) may be done by adding, removing or configuring modules (plugins, extensions, etc.) and other settings.

In one or more embodiments, before performing a site-wide modification, the system discovers current website-platform or CMS state, including installed modules, plugins, extensions, their versions, enablement state, configuration state, dependency signals, and platform capabilities exposed by the live website.

Site-wide modification requests may therefore include installing, configuring, enabling, disabling, removing, updating, replacing, or reordering one or more modules or other site-wide capabilities in addition to modifying visible presentation.

As for page-wide modifications, the copilot system breaks down the tasks into subtasks per Section of that page. The input of the system is similar to the one provided for page-wide, or Section-wide or single Widget modifications. The input also includes site-wide parameters and settings, such as global styles, Design Paradigm, installed modules, plugins, extensions, etc.

The system may validate whether requested module-level changes are compatible with the current website state by evaluating dependency conditions, version constraints, resource conflicts, affected templates or bindings, security or policy checks, or platform-specific support conditions.

In one or more embodiments, the system produces an ordered execution plan in which prerequisite backups, exports, disablement steps, schema migrations, configuration saves, module updates, enablement steps, cache refreshes, and verification stages are sequenced before the visible result is treated as accepted.

In contrast to Section-wide or page-wide modifications, site-wide modifications produce actions, which may not immediately change the visible content in the editor interface (i.e. what the user is editing at that moment) but rather change website's global parameters and settings. An example of such a modification may be the user's request to make the popups appear with certain animation, or request to turn the blue buttons to red ones. Therefore, the system's initial response to the user may be an acknowledgment of receiving such a request or notification upon its completion.

In one or more embodiments, site-wide modifications may also trigger controlled propagation into multiple pages, reusable templates, Structured Content Entity-backed views, and other dependent artifacts, with review, rollback, and reconciliation controls. A site-wide modification may be executed in stages such that one stage observes the live environment, another stage performs a bounded mutation to module inventory or configuration state, and a later stage validates rendering, functionality, performance, security, or synchronization outcomes.

If a stage reveals incompatibility or failure, the system may stop further site-wide mutation, revert a selected module update, restore a prior configuration, re-enable a previously active module set, or request approval before proceeding with an alternative sequence.

In one or more embodiments, site-wide modifications also update corresponding Ground Data, internal site representations, module inventories, and restore-point metadata so that future automation reflects the actual live website state rather than stale assumptions.

Fine-grained vendor-specific compatibility matrices, module taxonomies, or platform-specific update policies may be used in some embodiments, but are optional refinements; the broader process covers evaluating compatibility signals, dependency ordering, and rollback feasibility before performing module-level mutation on a live website platform or CMS.

### AI Agents

The copilot system uses a series of specialized AI Agents to perform specific different tasks. Such tasks include intent recognition, target element selection, layout generation, subtask planning, or final content validation, etc. The first agent is intent recognition, which usually spawns task planner and classifier, which further spawns a series of other AI Agents. Each AI Agent is a separate AI Model or a combination of several models or rule-based algorithms. Each AI Agent has prompt and parameters and description of the task the agent performs. Each AI Agent is provided with necessary data for its execution or may receive the necessary data from user input or additional parameters sent to backend from the website, from the database and the Ground Data, third party integrations and external APIs, such as HubSpot integration or trigger requesting user to provide clarifications. When spawning other AI Agents, the agent may pass necessary data to them, defined in the specification of the spawned agent.

In one or more embodiments, specialized AI Agents additionally include routing, review, repair, synchronization, restoration, schema-management, or progress-communication roles. Different AI Agents may therefore have different bounded responsibilities, such as planning, generation, data-retrieval, validation, synchronization, review, or mutation execution, and may exchange work products in validated forms rather than through unconstrained free-form output.

### Agent Architecture and Orchestration

The supervisor AI Agent receives the user's request (e.g., “Move the ”Contact Us“ button to the center”) and determines which agents are needed to fulfill that request and which data to send to each of sub-agents. Additional AI Agents for pre-processing user input may be placed before the supervisor AI Agent for tasks such as translation, additional intent recognition etc.

In one or more embodiments, the supervisor AI Agent or another orchestration agent classifies the request into an execution regime before invoking downstream agents, thereby distinguishing direct bounded execution from multi-stage planning, repair, clarification, or synchronization flows.

When defining subtasks, the supervisor AI Agent may also determine parameters of these requests to sub-Agents. The supervisor AI Agent may also redefine the user prompt for a sub-Agent, keeping prompts/commands relevant to the sub-Agent. Each sub-Agent may have its data input schema, which determines how the supervisor AI Agent may prepare and present the data being passed for each sub-Agent. The schema of sub-Agent may also include its description, description of its capabilities, best usage cases etc., which is used in the supervisor AI Agent's system prompt. The system may have two or more supervisor AI Agents in use, where each supervisor orchestrates a certain subset of sub-Agents. Such an architecture allows keeping each supervisor's scope limited and the number of sub-Agents known to each supervisor AI Agent and information used in the supervisor's prompt limited.

In one or more embodiments, planning and execution supervision are performed by different agents. For example, a planner or planning supervisor may generate a task plan, execution graph, ordered sequence of subtasks, or dependency structure, while a separate orchestration or execution-supervision agent may coordinate execution of those subtasks, monitor progress, determine whether prerequisite stages are complete, invoke retries or repair flows, and decide whether the workflow continues, pauses, proceeds to clarify, rolls back, or terminates.

In one or more embodiments, each sub-Agent is associated with a supported input schema, supported action vocabulary, or allowed mutation scope so that downstream execution is constrained before side-effectful actions occur.

Simple tasks, such as retrieving data or classifying user intent, may occur in parallel. More complex tasks, such as layout modifications that rely on completed subtasks (e.g., a newly generated video asset), are executed in sequence for a proper data flow.

In case of failure of one of the AI Agents, the system may try to recover from the failure by retrying the task, falling back to a rule-based algorithm or asking the user for clarification. As each AI Agent may have a side effect (not direct response to the caller AI Agent or user), the side effects of intermediate agents are stored in temporary storage and are passed to the next agent. In case of failure of the last agent, the side effects are discarded.

In one or more embodiments, failure handling includes preserving execution state, partial results, temporary side effects, and recovery checkpoints so that the system may resume, repair, replay, or abandon a subset of an interrupted operation.

The modular design of the copilot system permits additional AI Agents to be “plugged in” as new features are introduced. For example, a SEO Optimization AI Agent may parse page content to suggest meta tags, or a Design Consistency AI Agent may identify Sections mismatched with a newly applied global style.

### Interaction With the Database and Ground Data Modifications

The copilot system generates the initial Ground Data during the site creation process. Additionally, the copilot system may fill in the Ground Data during the website modifications process in case the original Ground Data was not provided (e.g. the website was created manually and not through the copilot system).

Then during the site modification process (e.g. through the copilot system in editor interface), the copilot system is receiving information from the database and Ground Data, depending on specific AI Agent. The system may add, remove, modify or update information in the database and Ground Data as the direct result of the execution of AI Agents. However, more commonly modifications of the Ground Data are not the direct result of the execution of AI Agents, but rather the side effects of the execution of AI Agents. In an embodiment, an AI Agent adds a Section to a webpage. Adding the Section triggers an update of the corresponding Ground Data portion that summarizes the content of the webpage in its page-by-page Webpage Outline or Sitemap. As a result, a title and a description of the newly added Section are added to the Ground Data. Additionally, the system may synchronize the information from the database and Ground Data to the website and vice versa.

In one or more embodiments, the information retrieved from the database and ground data additionally includes module inventory, enablement state, configuration state, version state, dependency metadata, publication state, and prior verification or rollback information associated with the live website environment.

Ground Data modifications may be triggered not only by actions through the copilot system, but also direct modifications of the website, for example when a new page is added to the website, the system may add new Ground Data portions to the database. Depending on the modification in the website, the system may trigger the corresponding AI Agent to modify or add new Ground Data portions to the database. The copilot has a subset of AI Agents that are exclusively used to modify and read Ground Data. In different embodiments, there are different mechanisms to trigger such AI Agents.

Direct user changes (e.g., manual changes) in the website may also include installation, removal, update, enablement, disablement, or reconfiguration of modules through native website-platform or CMS management interfaces. The system may detect such changes and update internal representations so later automation is based on current live website state.

Each AI Agent that performs a specific task decides whether to call the corresponding AI Agent that modifies Ground Data. After the task is executed (by multiple AI Agents), the system checks if there are necessary modifications of the Ground Data and triggers the corresponding AI Agent to modify the Ground Data.

In one or more embodiments, one or more AI Agents or rule-based processes maintain a normalized representation of website-platform or CMS operational state, including module inventory and configuration state, which is synchronized with Ground Data and used during later planning, validation, import, rollback, or reconciliation stages.

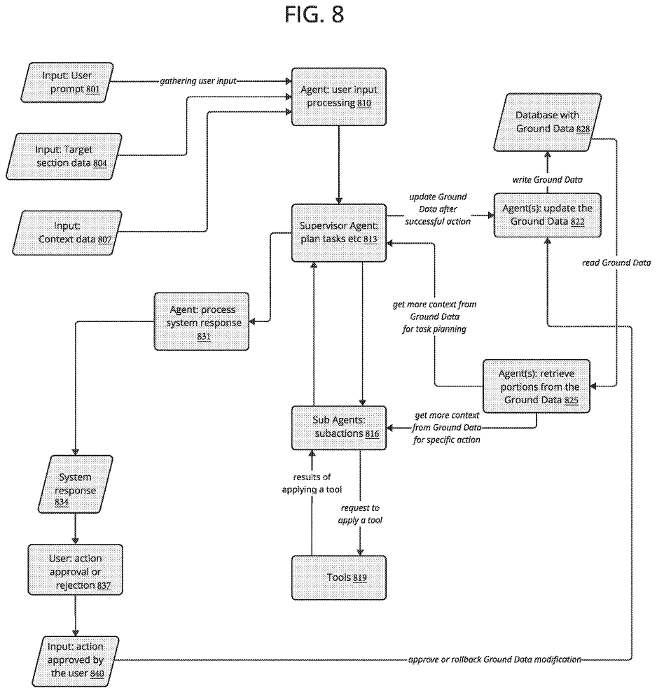

FIG. 8 is a flow diagram that depicts the process of interaction between the copilot system and the database and Ground Data during website editing process, in an implementation. The techniques describe the interaction between the copilot system and the database and Ground Data during the website editing process.

At block 801, the system receives the user prompt as input. In an embodiment, this is the natural language instruction provided by the user through the copilot interface describing an intended website edit—for example, adding a new Section, installing a module, or modifying content across the page.

At block 804, the system gathers the target section data as input. In an embodiment, this includes the full structured configuration of the Section or page area targeted by the user's request, encompassing its current Widget inventory, layout properties, and any platform-specific CMS state information such as module enablement state, configuration state, version state, and publication state relevant to the target area.

At block 807, the system gathers context data as input. In an embodiment, this includes the supplemental contextual information relevant to the editing request—such as global design parameters, the current state of the live website environment, prior verification or rollback records, dependency metadata, and any other operational state information maintained by the system's normalized representation of the website platform or CMS. Where the website was created directly rather than through the copilot system, this context may also include data gathered to fill in Ground Data that was not originally generated by the copilot.

At block 810, the User Input Processing Agent gathers the inputs to the system and performs the initial preprocessing of the user prompt and associated input data. In one or more embodiments, this Agent handles translation, normalization, intent pre-classification, and any other preparation necessary to transform the raw user inputs into a structured representation suitable for consumption by the Supervisor Agent. In an embodiment, this step may also be the re-entry point of a loop—the system returns here to gather updated user input when the Supervisor Agent may require further clarification or when a new round of instruction is received following user action approval.

At block 813, the Supervisor Agent receives the processed user input and acts as the central task planner and orchestrator for the entire website editing flow. The Supervisor Agent plans the full task execution plan—decomposing the user's request into ordered subtasks, determining which Sub Agents to invoke, generating the parameters for each sub-Agent call, and managing the sequencing of the downstream actions. To support accurate planning, the Supervisor Agent may request additional Ground Data context from block 825, receiving retrieved portions of the Ground Data—including module inventory, configuration state, dependency metadata, publication state, and prior rollback information—that inform which AI Agents and tools are appropriate for the current live website state. After successful execution of subtasks, the Supervisor Agent instructs block 822 to update the Ground Data to reflect the changes made. If the overall task may require multiple rounds of Sub Agent execution, the Supervisor Agent loop runs until the planned subtasks have been completed.

At block 816, the Sub Agents execute the specific subactions assigned by the Supervisor Agent for each subtask in the editing flow. These are the operational AI Agents responsible for the actual website modifications—such as adding a Section, modifying Widget parameters, updating page structure, or triggering CMS-level operations such as module installation, removal, update, enablement, disablement, or reconfiguration. Each Sub Agent may retrieve additional Ground Data context from block 825 as determined for its specific action, ensuring that its execution is grounded in the current live website state. Sub Agents issue requests to apply tools to block 819, receive the results of applying those tools back from block 819, and may iterate in an inner loop until the parameters of their assigned subaction have been applied. Importantly, the execution of Sub Agents may produce both direct and side-effect modifications to the Ground Data—for example, adding a Section to a page directly triggers an update of the corresponding Ground Data portion that summarizes the page content, such as adding the new Section's title and description to the Webpage Outline or Sitemap. The Sub Agent loop runs until the subactions planned by the Supervisor Agent have been executed.

At block 819, the Tools layer receives a request to apply a specific, deterministic operation from the Sub Agents at block 816. These tools execute bounded, well-defined actions against the editor interface or website platform—such as mutating a Widget's parameters, applying a layout change, or triggering a CMS management operation—and return the results of applying the tool back to block 816. Each individual tool call is scoped to a single atomic operation, with the higher-level orchestration handled by the Sub Agents and Supervisor Agent above.

At block 822, the Ground Data Update Agent(s) are a dedicated subset of AI Agents exclusively used to modify Ground Data in response to instructions from the Supervisor Agent at block 813 and from the user action approval input at block 840. These Agents receive update instructions triggered either directly—as the intentional result of a user-requested change—or indirectly, as a side effect of Sub Agent execution, such as when a new page is added to the website and new Ground Data portions may be created to represent the page. In one or more embodiments, these Agents also maintain a normalized representation of the website platform's or CMS's operational state—including module inventory and configuration state—keeping the state synchronized with the Ground Data so that later planning, validation, import, rollback, and reconciliation stages are based on the current live website state. The Ground Data Update Agent writes the changes to block 828, the Database with Ground Data.

At block 828, the Database with Ground Data serves as the persistent, authoritative data store for the website's structured semantic content and operational state. Ground Data is written to by the Ground Data Update Agent at block 822 and read from by the Ground Data Retrieval Agent at block 825 throughout the editing flow. In addition to content generated by the copilot system during site creation, the database may also hold Ground Data filled in by the copilot system for websites created manually, ensuring that even non-copilot-created sites benefit from a structured content foundation. Direct website changes—including direct CMS modifications, module installations, or page additions made outside the copilot interface—may also trigger Ground Data updates, with the system detecting such changes and updating the database so that the subsequent automation is based on current live website state.

At block 825, the Ground Data Retrieval Agent(s) are a dedicated subset of AI Agents exclusively used to read Ground Data from block 828 on behalf of other Agents in the system. These Agents receive retrieval requests from the Supervisor Agent at block 813—to supply context for task planning—and from the Sub Agents at block 816—to supply context for specific subactions. Retrieved information may include content field values, entity instances, module inventory, enablement and configuration state, version and publication state, dependency metadata, and prior verification or rollback records. In an embodiment, this Agent also reads Ground Data to supply information needed to evaluate whether Ground Data modifications triggered by the user's approved action at block 840 may be committed or rolled back.

At block 831, the System Response Processing Agent receives the system's response about the results of the executed actions from the Supervisor Agent and prepares a structured response for presentation to the user. In an embodiment, this Agent formats the outcome of the completed subtasks—including confirmation of changes made, any warnings or errors encountered, and a summary of Ground Data modifications applied—into a coherent system response delivered to the user for review.

At block 834, the system delivers the System Response to the user through the copilot interface. In an embodiment, this response presents the results of the AI Agents' actions, including the specific modifications made to the website, any Ground Data updates applied, and any relevant status information about the live website state, allowing the user to evaluate whether the outcome meets their intent before approving or rejecting the changes.

At block 837, the system receives the User's action approval or rejection. The user reviews the system response delivered at block 834 and makes a decision—either approving the actions and associated Ground Data modifications as correct and complete, or rejecting them to trigger a rollback.

At block 840, the system receives the action approved by the user as a formal input. In an embodiment, this approval or rejection signal is then sent to the Ground Data Update Agent at block 822 with an instruction to either commit the pending Ground Data modifications as permanent—finalizing the updated normalized representation of the website's operational state—or to roll back the Ground Data modifications to their prior state, restoring consistency between the Ground Data and the live website environment. If the action is approved, the loop at block 810 may also be re-entered for the next user editing instruction.

### Bidirectional Synchronization With Live Website State

In one or more embodiments, the system synchronizes changes from internal representations, Ground Data, Structured Content Entities, templates, or packaged artifacts to the live website state, and also observes changes made directly in the live website environment so that corresponding internal representations may be updated.

Such bidirectional synchronization may be triggered by editor-interface actions, external integrations, direct website edits, imports, publications, or other state-changing events.

### Restore and Reconciliation Between Historical and Current State

In one or more embodiments, when internal state and live website state diverge, the system performs reconciliation by identifying differences, determining whether one side has authority for a given scope, and then applying repair, synchronization, or user-approval steps before finalizing the result. In one or more embodiments, restore points, historical versions, or versioned artifacts may be used to recover from unacceptable changes, compare alternative states, or reconstruct an earlier state for a selected scope.

Bidirectional synchronization may additionally compare expected module inventory, version state, enablement state, configuration state, content bindings, or publication status against the corresponding live website state and detect drift for a selected scope. When difference(s) are detected, the system may determine whether internal state, live website state, or a restore point may be authoritative for each affected scope and may then selectively import, export, disable, reconfigure, update, remove, or preserve modules or settings accordingly.

Reconciliation may further preserve user-made live-site changes that remain compatible with system goals while still updating preserved internal representations, thereby reducing destructive overwrite of valid external website management actions.

### Website Management

The copilot system may perform website management. Website management includes a spectrum of tasks performed after a website is launched, ranging from routine checks to broader restructuring or operational recovery tasks. In an embodiment, this includes website maintenance, analytics, error handling, speed optimization, security checks, publication control, module or extension lifecycle management, synchronization monitoring, and other tasks that are part of the website lifecycle after deployment. The copilot system may be used to perform these tasks by discovering current live state, selecting a bounded or staged execution path, invoking the needed actions, and verifying resulting website behavior.

In one or more embodiments, website management includes ongoing management of website-platform or CMS operational state, including installed modules, plugins, extensions, configuration surfaces, scheduled updates, health state, and restore points associated with the deployed website.

Some management tasks are direct and bounded, such as checking whether an update is available, enabling or disabling a module, applying a stored configuration preset, or restoring a selected prior state for a limited scope. Other management tasks are staged and dependency-aware, such as updating multiple modules together, replacing one module with another, migrating configuration between versions, or applying a website-wide capability that may require installation, configuration, validation, and synchronization across multiple website surfaces.

In one or more embodiments, website management is performed with awareness that a live website platform or CMS may continue to change outside the copilot system through native admin interfaces, scheduled jobs, external services, or direct API calls.

In some embodiments, the tasks for website management are much more complex and include a series of steps and have site-wide impact. The copilot system may be used to perform such complex tasks which include:
1. website design modifications, redesign and rebranding;
2. bulk content modifications;
3. website editing through editing Webpage Outlines of webpages or Website Sitemap;
4. programmatic webpage creation and modification;
5. automatic and continuous modifications of website content, design etc.

In one or more embodiments, website management additionally includes management of Structured Content Entity schemas, item collections, synchronization state, restore points, and published artifact versions. Complex website management may include staged module or extension lifecycle management in which the system discovers the current environment, prepares backups or restore points, evaluates compatibility and dependencies, performs one or more install, update, enablement, disablement, configuration, or removal operations, and verifies the resulting live website state.

Verification after such management actions may include checking rendered pages or views, Structured Content Entity-backed views, API availability, navigation integrity, configuration consistency, performance indicators, security indicators, or synchronization outcomes. If a management operation produces incompatibility, failure, or unacceptable degradation, the system may roll back to a previous module set, restore earlier configuration values, revert selected published artifacts, or replay a reduced sequence that excludes a problematic module or dependency path.

Detailed vendor-specific update policies, compatibility matrices, or module marketplace semantics may be present in some embodiments but are optional refinements; the broader management process covers staged evaluation, bounded mutation, verification, rollback, and reconciliation for live website-platform or CMS operations.

### Website Design Modifications, Redesign and Rebranding

Website design modifications may range from minor style tweaks to comprehensive rebranding that affects every page. Modifying the design of the website may require one or more steps. First, Design Paradigm or design system, theme/skin parameters and other global parameters including layout-related parameters are modified. Then, the system checks the consistency of the design across the website, identifies Sections, Widgets and other elements that are inconsistent with the new design. Afterwards, the system applies design to each Widget and Section that did not get global design applied.

In one or more embodiments, redesign and rebranding are performed by first constructing or modifying a site-wide design state that is separate from the website's content state. Such design state may include design-system parameters, typography rules, spacing rules, color logic, theme/skin selections, Web Component or Widget Presets, reusable style patterns, and other rules that govern how content may be visually rendered across the website.

In one or more embodiments, the system determines whether a requested redesign is satisfied by changing design state alone, by changing design state together with local layout parameters, or by regenerating one or more Sections, templates, or pages. In an embodiment, this determination may depend on the requested visual outcome, current page structures, reusable templates, user constraints, and consistency goals.

Such design changes may include not only trivial changes, such as changing heading typography parameters, but also complex changes that may require reconsidering each Section, and even replacing some Sections with different Sections, or Section-level templates or recalculating paddings, margins, sizes or spacings for each Widget in the Section. Global design changes may be part of the website redesign and rebranding, that is matching the design of the website to the new brand identity in general and brand kit in particular. As a non-limiting example, a scenario where a user changes the global “theme/skin” from “minimalist” to “bold” triggers a ripple effect across the headings, buttons and other Widgets adjusting not only some typography parameters but also margins and paddings.

In one or more embodiments, the redesign flow preserves a distinction between design-layer mutations and content-layer mutations. A design-layer mutation may change visual rules, presets, spacing, typography, color, interaction style, or template choice while preserving the underlying textual, media, or structured content to the extent possible. A content-layer mutation may then be applied separately or subsequently if the new brand identity also may require changes in messaging, tone, or data presentation.

The copilot system may be used to perform these tasks. Under the hood the system uses a series of AI Agents and may trigger re-generation of the website (Section per Section) for the design consistency across the website and/or to modify a limited set of parameters for each Widget in each Section.

In one or more embodiments, the system applies design propagation as a controlled site-wide process in which reusable templates, repeating Sections, page-level structures, Widget presets, and rendered views of Structured Content Entities are evaluated against the modified design state and updated according to their role and scope.

In one or more embodiments, some structures inherit the modified design state directly, while other structures are selectively overridden, regenerated, replaced, or left unchanged based on compatibility with the requested redesign and user-imposed constraints.

As an input the system receives description of the design changes, which may include visual reference or example, as well as new brand kit and other information, particularly from the Ground Data. The description may be visual or descriptive (e.g. the new mission statement of the company or updated market positioning of the business). Such changes may also trigger bulk content modifications (see section below). As an example, in case of rebranding, if the description of the company and brand kit is changed, the system may update the “about_company” data portion accordingly and update the corresponding “About Us” page and recalculates styling to ensure brand consistency.

In the case of website redesign, the system regenerates Global Design Parameters, and applies them for each Section and Widget on the website, by processing each Section as input and output, ensuring the new theme or color palette is uniformly applied to every Section. In an embodiment, one or more AI Agents flag inconsistencies, like an outdated logo or mismatched Widget styling, and suggest a quick fix. In another embodiment, a more extensive re-generation of affected pages is done.

In one or more embodiments, the system validates redesign success not only by visual consistency, but also by checking whether content remains correctly bound, whether semantic roles of Sections are preserved, whether interactive elements remain functional, and whether the result satisfies brand-consistency or readability constraints.

In one or more embodiments, the system may generate previews or intermediate redesign states for approval before propagating the redesigned state across the full website.

In an embodiment, the system reviews and considers whether the structure of each Section may be preserved or changed, and if the structure may be changed, whether the structure may be replaced with a different template or modified in some other way, based on the new design and parameters of that Section.

In one or more embodiments, the system therefore performs redesign as a decision process among preserving existing structure, changing rendering parameters, changing local layout, replacing a template, or regenerating a broader page- or site-level structure while keeping content continuity where appropriate.

In another embodiment, the system implements a module that does the opposite of what the “converter” module does (see “CONVERTING AND BUILDING FINAL BLOCK-BASED CODE PACKAGE” section), that is, the module converts the website artifacts, such as the block-based code, component-based code, HTML code, or other markup-based representation back, into the simple template representation (the “inverter” module). Then the process applies the new design parameters to each section and runs the “converter” module again to produce the final website artifacts, such as final block-based code, component-based code, HTML code, or other platform-specific artifacts.

Section and runs the “converter” module again to produce the final block-based code, Web Component-based code, HTML code, or other platform-specific artifacts. In an embodiment, this inverter-and-converter flow allows the system to redesign a live website or authored artifact of the website at the level of intermediate site representations rather than being limited to direct low-level code edits. Accordingly, the system may manage the website as a coherent designed artifact with reusable structures and whole-site design rules.

As bulk changes are applied to multiple pages and settings and may impact how the website looks and works significantly, the system may be able to roll back or revert if the user decides a new design is not acceptable. Whenever the AI Agents determine that the scale of changes is big enough, the system automatically backs up the current state of the website and the Ground Data before implementing the changes, to create a restore point. The user may restore the website to the previous state if the new design is not acceptable.

In one or more embodiments, such restore points additionally preserve affected Structured Content Entity state, package state, and synchronization state for the modification scope. In one or more embodiments, the restore point additionally preserves prior design state so that a rejected redesign may be reversed without necessarily discarding unrelated content updates that are outside the redesign scope.

In an embodiment, this flexible, AI-driven approach enables seamless rebranding without requiring users to individually edit every Widget, page, or Section. Instead, the copilot system orchestrates the necessary design adjustments site-wide, ensuring a cohesive and updated look that aligns with the user's evolving brand identity.

In one or more embodiments, the technical value of the redesign flow lies in managing design as a whole-website computational layer and coordinating its propagation, validation, approval, synchronization, and rollback across the live website.

### Bulk Content Modifications

Bulk content modifications include modification of the content of the website across multiple pages or Sections. In an embodiment, this action may be triggered by website rebranding or change in global description of the Subject Matter, market positioning, mission statement, etc. Such changes, if done manually, include a lot of work and require a lot of time as human may check the webpages and Sections and modify them accordingly, such as changing the tone of the content, changing the list of products, services, publishing new pages, updating multiple pages with new information etc. The copilot system may be used to perform these tasks.

In practice bulk content modifications are often caused by website redesign and rebranding. In such cases the system implements both changes in content and design together or in sequence, where the design of the website are modified and layouts of some Sections is changed, if necessary, then the content of the website are modified.

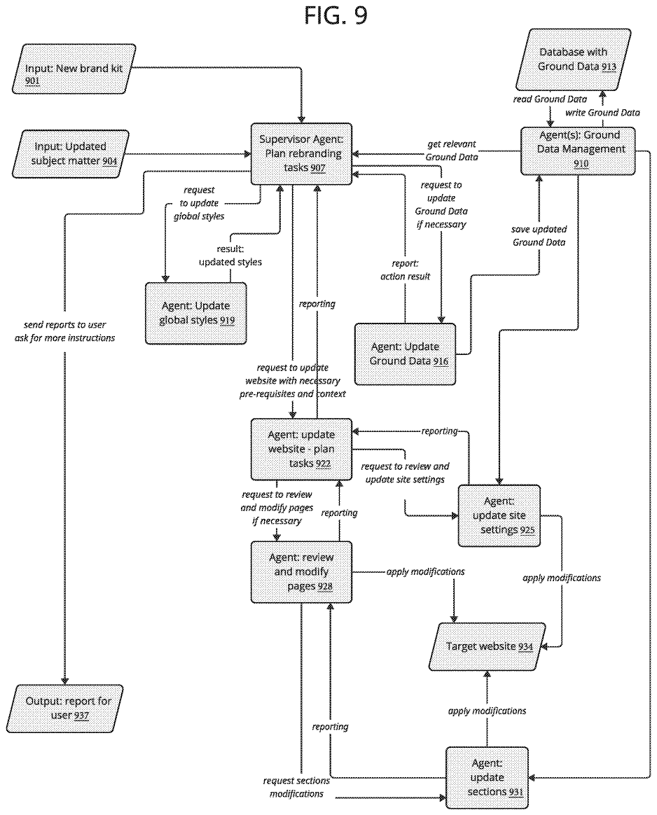

FIG. 9 is a flow diagram that depicts the process of website rebranding with both content and design modifications, in an implementation. Such an example of a flow of website rebranding may include both content and design modifications. In the flow, the supervisor AI Agent orchestrates three AI Agents, responsible for Ground Data modification, global styles update and website content update planning. The latter AI Agent, in turn, orchestrates its subagents responsible for modification of each page and each Section, as well as for modification of website settings.

At block 901, the system receives a new brand kit as input. This may include updated logos, color palettes, typography selections, brand voice guidelines, imagery assets, and any other visual or stylistic materials that define the website's new brand identity. In an embodiment, this input signals the beginning of a bulk rebranding operation that may affect both the design and content of the website across the pages and sections.

At block 904, the system receives updated subject matter as input. In an embodiment, this represents changes to the website's core semantic content foundation—such as a revised mission statement, updated market positioning, a new list of products or services, a changed tone of voice, or a restructured description of the business's purpose. In an embodiment, this input drives the content-side of the rebranding, determining what may be updated across the pages and sections to reflect the organization's new identity and direction.

At block 907, the Supervisor Agent receives both inputs and acts as the central orchestrator of the entire rebranding flow. In an embodiment, the Supervisor Agent plans the full sequence of rebranding tasks—determining whether design changes, content changes, or both may be applied; deciding the order in which the changes are executed (e.g., global style updates first, then page-by-page content modifications); and dispatching requests to each subordinate Agent accordingly. To support accurate planning, the Supervisor Agent requests relevant Ground Data from Ground Data Management Agent(s) at block 910, retrieving the current state of the website's content—including its Sitemap, page-by-page Webpage Outline, entity instances, and structured content records—so that the scope of changes across the pages and sections is ascertained. After successful actions are completed by subordinate Agents, such as at block 916, the Ground Data is updated to reflect the changes. The Supervisor Agent also sends reports to the user and may request additional instructions throughout the process, routing the final consolidated report to block 937.

At block 910, the Ground Data Management Agent(s) serve as the interface between the AI Agents and the Database with Ground Data at block 913. In an embodiment, these Agents read Ground Data from block 913 to supply the Supervisor Agent at block 907 with relevant context for rebranding task planning—for example, providing the current Sitemap, Section summaries, and entity content records needed to understand the full scope of the website. The Ground Data Management Agent(s) also receive instructions from the Ground Data Update Agent at block 916 to save updated Ground Data back to block 913 after successful modifications, maintaining the database as a current and accurate reflection of the website's post-rebranding state.

At block 913, the Database with Ground Data serves as the persistent, authoritative data store for the website's structured semantic content. Throughout the rebranding flow, Ground Data is read from and written to by the Ground Data Management Agent at block 910, ensuring that the AI Agent decisions are based on the most current content state, and that the Ground Data modifications resulting from the rebranding—such as updated mission statements, revised product descriptions, and new Section summaries—are durably persisted.

At block 916, the Ground Data Update Agent receives a request from the Supervisor Agent to update the Ground Data if necessary following the execution of rebranding actions. In an embodiment, this Agent identifies which Ground Data fields and records are affected by the new brand kit and updated subject matter—for example, updating the business description, revising service listings, modifying the Webpage Outline entries for changed pages, or adding new Ground Data portions for newly created pages—and instructs the Ground Data Management Agent at block 910 to save the updated Ground Data to the database. The Agent reports the action result back to the Supervisor Agent at block 907 upon completion.

At block 919, the Global Styles Update Agent receives a request from the Supervisor Agent to update the website's global design parameters in accordance with the new brand kit received at block 901. In an embodiment, this Agent applies the new brand's visual identity system across the website—updating the global color palette, typography settings, spacing parameters, button styles, and any other design tokens that govern the consistent visual appearance of the pages and sections. The Agent applies these style modifications directly to the Target website at block 934 and returns the result of the updated styles to the Supervisor Agent at block 907, confirming that the design foundation of the rebranded website has been established before per-page content modifications proceed.

At block 922, the Website Update Planning Agent receives a request from the Supervisor Agent to update the website with the necessary prerequisites and context established by prior steps—including the updated global styles from block 919 and the revised Ground Data from block 916. In an embodiment, this Agent acts as a second-level task planner, decomposing the website-wide content and layout modification work into two parallel tracks: updating site-level settings via block 925 and reviewing and modifying individual pages via block 928. The Agent receives reporting back from both block 925 and block 928 as each completes its assigned work, and reports overall progress back to the Supervisor Agent at block 907.

At block 925, the Site Settings Update Agent receives a request from the Website Update Planning Agent to review and update site-level settings in accordance with the rebranding. In an embodiment, this includes updating global site metadata such as the site name, tagline, SEO settings, favicon, logo placement, and any other platform-level or CMS-level configuration parameters that reflect the new brand identity. The Agent applies these modifications directly to the Target website at block 934 and reports the results back to the Website Update Planning Agent at block 922.

At block 928, the Page Review and Modification Agent receives a request from the Website Update Planning Agent to review and modify individual pages of the website as necessary to reflect the rebranding. Operating in an outer loop—iterating over each page in the website's Sitemap—this Agent evaluates the current content of each page against the updated subject matter and brand guidelines, determines which sections may require modification, and dispatches section modification requests to block 931 for each page that may require updates. The Agent receives reporting back from block 931 upon completion of each section's modifications, and may request multiple rounds of section updates per page until the content and layout changes for that page are complete. The loop runs until the pages in the website have been reviewed and modified as necessary. The Agent reports results back to the Website Update Planning Agent at block 922.

At block 931, the Section Update Agent receives requests to modify specific sections from the Page Review and Modification Agent at block 928, iterating in an inner loop over each section within the current page being processed. For each section, the Agent applies the necessary content and layout modifications—such as updating text to reflect the new mission statement or tone of voice, revising product or service descriptions, restructuring section layouts to accommodate new brand content, or replacing imagery with assets from the new brand kit. The Agent applies the modifications directly to the Target website at block 934 and reports the results of each section modification back to block 928. The loop runs until the sections on the current page have been updated.

At block 934, the Target website is the live website platform or CMS environment that receives the applied modifications throughout the rebranding flow. It is the direct recipient of global style updates from block 919, site settings changes from block 925, and per-section content and layout modifications from block 931—collectively representing the full output of the AI-driven rebranding process as rendered in the actual website environment.

At block 937, the system outputs a consolidated report to the user summarizing the full outcome of the rebranding operation. In an embodiment, this report describes the changes made—including global style updates applied, site settings modified, pages reviewed, sections updated, and Ground Data records revised—and may also ask the user for additional instructions if further refinements may be required, allowing the rebranding loop to be re-entered with new guidance from the user.

In one or more embodiments, the system distinguishes between a design-first flow, a content-first flow, and a coordinated dual-track flow for rebranding. In the design-first flow, the system modifies site-wide design state before or while preserving most content state. In the content-first flow, the system modifies business or messaging content while preserving design state. In the coordinated dual-track flow, the system performs design propagation and content propagation together while maintaining consistency between them.

In one or more embodiments, the system preserves semantic content continuity during rebranding by maintain the informational role of content while changing the manner in which that content is visually expressed, unless the requested rebranding may also require substantive content changes.

For bulk content modifications, the system uses the “Ground Data schema” and the “Ground Data dependency schema” to quickly update the Ground Data and then propagate the changes in the Ground Data to the website content. In an embodiment, if the company name changes, the system may quickly propagate that update across every mention in the Ground Data, then the system may regenerate the website content based on the new Ground Data. Review AI Agents validate and finalize changes by reviewing changes in website content and checking whether the changes are accomplishing user request(s), and how relevant the changes are to user request(s). If the changes are not satisfactory, the supervisor or sub-Agents may retry their tasks taking into account the results of the review by the reviewing AI Agents (feedback).

In one or more embodiments, the same propagation logic may be applied to Structured Content Entity item sets, taxonomies, or schema-governed content fields whose rendered views appear across multiple website locations.

If changes in Ground Data conflict with user overrides (e.g., local page edits that differ from the global setting), the system prompts the user for clarification before proceeding to modify such pages. Similarly to other modifications, a rollback mechanism is implemented to revert changes if the user decides the new content is not acceptable.

Bulk modifications may include updating meta descriptions or headings for SEO. Large content changes could affect links and navigation. The system runs a series of checks from broken or irrelevant links (leveraging a combination of AI Agents and rule-based algorithms) to determine that the links are valid and relevant after the bulk modifications.

### Outline and Sitemap-Level Editing

The Webpage Outline and Sitemap are a high-level representation of the website structure and content. By modifying the Webpage Outline and Sitemap, users may edit websites through high-level changes over website pages instead of granular modifications of Widgets, their parameters and content.

In one or more embodiments, such high-level changes are propagated to Web Components, markup/code fragments, or mixed internal representations corresponding to the affected webpage content.

Copilot system allows modifications of webpages content without specifying the exact Widgets and parameters to be modified. Such modifications are done by a high-level description of the desired changes, and the system may apply them to the website. The system accepts as input modified Sections and pages from the user interface containing the Sitemap and Webpage Outlines of webpages. Then the system modifies the corresponding Sections and pages of the website. Such changes may include changing title, descriptions and preferences of the Sections and pages, adding/removing new Sections and pages, rearranging them etc. An example of such modifications is merging two pages into one, moving a “Testimonialssection to the homepage, or converting a “Services Overview” page into multiple sub-pages—requiring complex changes and AI-driven orchestration.

In one or more embodiments, the system determines the corresponding Widgets, Web Components, or source-represented webpage units to be modified without requiring the user to identify them explicitly.

Such a system runs the same algorithms as those used during generation of the website (see “Generating Website” section) but limited to the scope of one or several Sections or pages. In an embodiment, this includes updating the Ground Data, regenerating the affected Sections (either fully or partially by keeping the same layout and template), then running the converter module to produce the final block-based code, Web Component-based code, HTML code, or other platform-specific artifacts.

One feature of the copilot system is that the database and Ground Data continuously maintain the up-to-date information about the website and its content (descriptions of Sections and pages). In an embodiment, the feature makes it possible to modify the website in editor or other interfaces and switch back to the Webpage Outline/Sitemap interface to see the changes. In such an embodiment, the Webpage Outline/Sitemap interface is up to date with the actual website content and may be used not only during website generation but later as well, even when the website is modified through other interfaces.

In one or more embodiments, the same approach maintains up-to-date information about Structured Content Entity definitions, item collections, and their relationship to the presentation structures that consume them.

In an embodiment, the system triggers AI Agents that update the descriptions of Sections in the Webpage Outline whenever the descriptions are modified in the actual website through the editor interface or in any other way.

In another embodiment, the system uses the “inverter” module (see the previous Section) to convert the website artifacts, such as block-based code, Web Component-based code, HTML code, or other markup-based representation, back into the simple template representation and then applies the new design parameters to each Section and runs the “converter” module again to produce the final website artifacts, such as block-based code, Web Component-based code, HTML code, or other platform-specific artifacts. In one or more embodiments, the converter and inverter modules operate over block-based, Web Component-based, markup-based, or mixed internal representations of webpages and Sections. In an embodiment, based on this conversion, the system modifies the Section descriptions in the Webpage Outline and Sitemap interface without changing the template or layout of the Section.

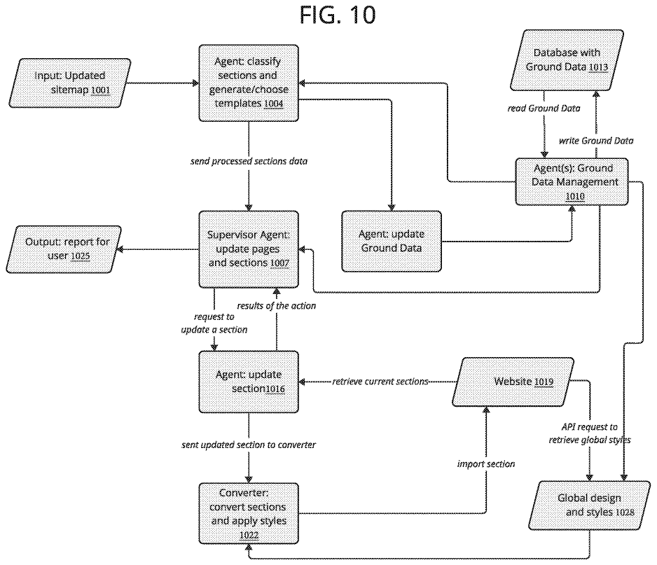

FIG. 10 is a flow diagram that depicts the process of Sitemap-level website editing scheme, in an implementation. At block 1001, the system receives an updated Sitemap as input. This represents a high-level structural modification to the website submitted by the user through the Sitemap or Webpage Outline interface—for example, adding or removing pages, reordering Sections, merging two pages into one, moving a “Testimonials” section to the homepage, or converting a “Services Overview” page into multiple sub-pages. Critically, this input operates at the Webpage Outline and Sitemap level of abstraction, meaning the user does not need to specify which underlying Widgets, Web Components, or markup-based units are to be modified—the system determines these automatically.

At block 1004, the Section Classification Agent receives the updated Sitemap and classifies each Section affected by the structural changes, then generates or selects the appropriate templates for those Sections. Running the same algorithms used during initial website generation—but scoped to the affected Sections and pages—this Agent analyzes the type and purpose of each Section in the updated Sitemap and determines whether the Section may be fully regenerated with a new template, partially regenerated while preserving its existing layout, or simply updated with revised content within its current template. In one or more embodiments, this Agent also retrieves relevant Ground Data context from the Ground Data Management Agent at block 1010 to inform its classification and template selection decisions—for example, consulting existing Section descriptions in the Webpage Outline to understand the current content of Sections that are being moved or merged. The Agent sends the processed sections data to the Supervisor Agent at block 1007.

At block 1007, the Supervisor Agent receives the processed sections data and acts as the central orchestrator for the page and section update operations. The Supervisor Agent plans the full sequence of updates for propagating the Sitemap-level changes down to the actual website—determining the order in which pages and Sections may be updated, dispatching per-Section update requests to block 1016 in a loop, and receiving results of each action back from block 1016 to track progress. The Supervisor Agent also triggers block 1013 to update the Ground Data whenever necessary following successful Section modifications, ensuring that the Webpage Outline and Sitemap interface remains fully synchronized with the actual state of the website at all times. Upon completing the updates, the Supervisor Agent sends a consolidated output report to the user at block 1025.

At block 1010, the Ground Data Management Agent(s) serve as the interface between the AI Agents and the Database with Ground Data at block 1013. These Agents read Ground Data from block 1013 to supply the Section Classification Agent at block 1004 and the Ground Data Update Agent at block 1013 with current Section descriptions, Webpage Outline entries, Sitemap structure, Structured Content Entity definitions, item collections, and their relationships to the presentation structures that consume them. The agents may also retrieve global designs and styles at block 1028. The agents may also receive instructions to write updated Ground Data back to block 1013 following successful Section modifications—for example, updating the description of a moved Section in the Webpage Outline, adding new Ground Data entries for newly created pages, or removing entries for deleted Sections—so that the database continuously reflects the current live state of the website.

At block 1013, the Database with Ground Data serves as the persistent, authoritative data store for the structured content and high-level website metadata—including the Webpage Outline, Sitemap structure, Section descriptions, Structured Content Entity definitions, and item collections. Ground Data is read from and written to by the Ground Data Management Agent at block 1010 throughout the flow. In one or more embodiments, the database's current state makes it possible for users to switch between the editor interface and the Webpage Outline/Sitemap interface at any time and see a consistent, up-to-date representation of the website—regardless of which interface was used to make the most recent modifications.

At block 1016, the Section Update Agent receives a request from the Supervisor Agent to update a specific Section of the website in accordance with the Sitemap changes. Operating in a loop—iterating over each affected Section assigned by the Supervisor Agent—this Agent retrieves the current Section artifacts from the Website at block 1019 via a retrieve current sections call, obtaining the existing block-based code, Web Component-based code, HTML code, or other platform-specific representation of the Section as the Section currently exists on the live website. In one or more embodiments involving the inverter module, the Agent converts these existing website artifacts back into a simple template representation, then applies the new content or design parameters—such as updated Section titles, revised descriptions, new layout preferences, or restructured content derived from the Sitemap changes—before sending the updated Section to the Converter at block 1022. The Agent reports the results of each action back to the Supervisor Agent at block 1007. The loop runs until the affected Sections have been processed.

At block 1019, the Website represents the live website platform or CMS environment from which the Section Update Agent at block 1016 retrieves the current Section artifacts. The website is also the destination to which the Converter at block 1022 imports the final converted Section output, applying the updated Section back to the live website. Additionally, the Website exposes an API that the Global Design and Styles component at block 1028 uses to retrieve the current global style parameters, ensuring that the converted Sections are styled consistently with the website's active design system.

At block 1022, the Converter receives the updated Section data from the Section Update Agent at block 1016 and performs the conversion of the updated Section into the final platform-specific website artifacts—such as block-based code, Web Component-based code, HTML code, or other markup-based representation—with the website's current global design parameters and styles applied. To accomplish this, the Converter retrieves the global design and styles from block 1022 via an API request to the Website, ensuring that the Section's visual presentation is consistent with the live website's design system. Once conversion is complete, the Converter imports the final converted Section back into the Website at block 1019, replacing the prior version with the fully updated and properly styled output. In one or more embodiments, this Converter module operates over block-based, Web Component-based, markup-based, or mixed internal representations of webpages and Sections, and may also update the Section's description in the Webpage Outline and Sitemap interface based on the conversion result—without changing the template or layout of the Section.

At block 1025, the system outputs a consolidated report to the user summarizing the results of the page and Section updates performed in response to the Sitemap-level changes. This report describes which pages and Sections were modified, what structural changes were applied, and the overall outcome of the Sitemap-driven editing operation, giving the user a complete picture of how the high-level Sitemap modifications were propagated through to the live website.

A conflict resolution, rollback and link validation mechanisms similar to those implemented for website design modifications and bulk content modifications are implemented for high-level content modifications as well.

### Programmatic Webpage Creation and Modification

Webpage creation and modifications often may be done in bulk programmatically (for SEO purposes, ads, etc.). Programmatic webpage creation and modification enables website administrators (or external tools) to automate webpage generation without manually interacting with the editor UI. The copilot system may be used to perform these tasks. The copilot system may be used to generate or modify a series of webpages, such as a series of blog posts, a series of product pages, a series of service pages, a series of landing pages, etc. A special AI Agent recognizes the intent and the desired output and generates a series of prompts for each webpage. The prompts are sent to the copilot system, which generates the webpages and saves them into the website, and triggers corresponding updates in the database and Ground Data. The copilot system allows for scheduling of such tasks. External triggers and modifications of data sources trigger the copilot system to perform these programmatic tasks.

In an embodiment, the system uses a third-party service integration to obtain the list of relevant keywords and topics (SEO) and generates a series of prompts for each webpage. Additionally, the system analyzes the existing content of the website and finds the pages/blog posts or other content that match the keywords and topics and modifies them.

In another embodiment, the system uses a list of products, either through spreadsheet or third-party service integration and generates a series of prompts for each product page or product categories then generates the webpages and saves them into the website. The system also analyzes the existing content of the website and finds the product pages/products categories or other content that match the dataset and modifies them. Upon changing the list of products in the source, the system may automatically modify the existing product pages and add new ones if needed.

In yet another embodiment, the system uses a list of advertisements copies and generates a series of prompts for each webpage (landing page) then generates the webpages and saves them into the website. The system also analyzes the existing content of the website and finds the advertisements pages/advertisements copies or other content that match the dataset and modifies them.

In yet another embodiment, the system uses a list of entities or interaction prospects and their information (such as name, email, phone, address, etc.), categorizes them into entity segments, personas etc. and generates a series of prompts for each webpage (landing page) that caters to each entity segment. Then the system generates the webpages and saves them into the website. The system also analyzes the existing content of the website and finds the entities pages/entities information or other content that match the dataset and modifies the existing webpages when requested.

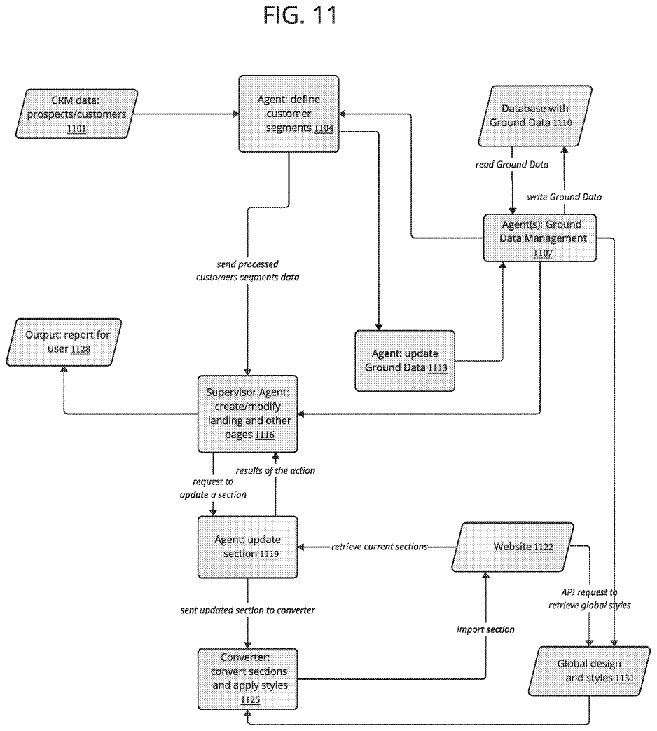

FIG. 11 is a flow diagram that depicts the process of programmatic landing page creation, in an implementation. At block 1101, the system receives CRM data comprising prospects and/or entities as input. This data is sourced from a third-party CRM integration or an external data source such as a spreadsheet, and contains customer or prospect records including attributes such as name, email, phone, address, industry, purchase history, and other profile information. This input triggers the programmatic landing page creation flow—either on demand, on a schedule, or automatically in response to a change in the external data source such as the addition of new prospects or updates to existing customer records.

At block 1104, the Customer Segmentation Agent receives the CRM data and analyzes the full set of prospect and customer records to categorize them into meaningful customer segments, personas, or audience groups. Using AI-driven classification, the Agent identifies clusters of entities that share common characteristics—such as industry vertical, company size, geographic region, buying behavior, or stage in the interactions funnel—and defines a distinct segment profile for each group. In one or more embodiments, the Agent also retrieves existing Ground Data of block 1110 via the Ground Data Management Agent to cross-reference the current website content, identifying any existing landing pages, customer-facing pages, or other content that already corresponds to a given segment so that the system may decide whether to create a new page or modify an existing one. The Agent sends the processed customer segments data to the Supervisor Agent at block 1116, providing a structured description of each segment and the corresponding page generation or modification prompts needed to produce landing pages tailored to each group. The Customer Segmentation Agent also instructs the Ground Data Update Agent at block 1113 to update the Ground Data after successful page operations.

At block 1107, the Ground Data Management Agent(s) serve as the interface between the AI Agents and the Database with Ground Data at block 1110. These Agents read Ground Data from block 1110 to supply the Customer Segmentation Agent at block 1104 with existing website content context for the system to identify which customer-facing pages already exist and which segments still may require new pages. The Ground Data Management Agent(s) also receive instructions from the Ground Data Update Agent at block 1113 to write updated Ground Data back to block 1110 after new landing pages have been created or existing pages have been modified, keeping the database synchronized with the current live state of the website.

At block 1110, the Database with Ground Data serves as the persistent, authoritative data store for the structured content and website metadata, including the Sitemap, Webpage Outline, Section descriptions, and entity records. Ground Data is read from and written to by the Ground Data Management Agent at block 1107 throughout the programmatic page creation flow. In one or more embodiments, the database's always-current state ensures that the Webpage Outline and Sitemap interface remains synchronized with the live website—so that when new landing pages are programmatically added for customer segments, these additions are immediately reflected in the website's high-level structural representation and available for subsequent editing through any interface.

At block 1113, the Ground Data Update Agent receives instructions triggered by the Customer Segmentation Agent at block 1104 to update the Ground Data following the successful creation or modification of landing pages. This Agent determines which Ground Data records may be created, modified, or extended—for example, adding new Webpage Outline entries and Sitemap entries for newly created segment-specific landing pages, updating Section descriptions to reflect modified content, or adding new Structured Content Entity instances corresponding to the customer segment data embedded in the generated pages. The Agent instructs the Ground Data Management Agent at block 1107 to write the updated records to the database at block 1110, ensuring that the website's content foundation remains consistent with the programmatically generated output.

Based on block 1104's processed customer segments data and/or block 1107's Ground Data, at block 1116, the Supervisor Agent acts as the central orchestrator for the landing page creation and modification operations. For each customer segment, the Supervisor Agent generates a tailored prompt describing the desired landing page content—structured to address the specific needs, pain points, and interests of that segment—and dispatches per-Section update requests to block 1119 in a loop, iterating over each Section of each landing page that are to be created or modified. The Supervisor Agent may also analyze the existing website content to determine whether a matching page already exists for a given segment, in which case the Supervisor Agent directs a modification of the existing page rather than creation of a new one. Upon completing the page operations across the customer segments, the Supervisor Agent sends a consolidated output report to the user at block 1128.

At block 1119, the Section Update Agent receives a request from the Supervisor Agent to create or update a specific Section of a landing page for a given customer segment. Operating in a loop—iterating over each Section assigned by the Supervisor Agent across the segment-specific pages—this Agent retrieves the current Section artifacts from the Website at block 1122 via a retrieve current sections call when modifying an existing page, obtaining the existing block-based, Web Component-based, or HTML representation of the Section. The Agent then applies the segment-specific content changes—such as tailoring headlines, value propositions, calls-to-action, testimonials, or product recommendations to the specific customer persona—and sends the updated Section data to the Converter at block 1125. The Agent reports the results of each action back to the Supervisor Agent at block 1116. The loop runs until the Sections of the landing pages across the customer segments have been processed.

At block 1122, the Website represents the live website platform or CMS environment from which the Section Update Agent at block 1119 retrieves current Section artifacts when modifying existing pages, and to which the Converter at block 1125 imports the final converted Section outputs, publishing the programmatically generated landing pages into the live website. The Website also exposes an API used by the Global Design and Styles component at block 1131 to retrieve the current global style parameters, ensuring that the programmatically generated landing pages are visually consistent with the rest of the website's design system.

At block 1125, the Converter receives the updated Section data from the Section Update Agent at block 1119 and converts the Section into the final platform-specific website artifacts—such as block-based code, Web Component-based code, or HTML—with the website's current global design parameters applied. To accomplish this, the Converter retrieves the global design and styles from the Global Design and Styles component via an API request to the Website at block 1131, ensuring that the programmatically generated landing pages inherit the website's active visual identity. Once conversion is complete, the Converter imports the final rendered Section back into the Website at block 1122, publishing the new or updated landing page content to the live site. In one or more embodiments, the Converter and its associated inverter module operate over block-based, Web Component-based, markup-based, or mixed internal representations of Sections, supporting a wide range of website platform and CMS targets.

At block 1128, the system outputs a consolidated report to the user summarizing the results of the programmatic landing page creation and modification operations. This report describes how many customer segments were identified, which new landing pages were created, which existing pages were modified, and the overall outcome of the programmatic page generation task—providing the website administrator with a complete audit trail of the automated operations performed on their behalf.

By combining automated triggers with intelligent AI Agents, the copilot system allows website administrators to manage and grow their websites efficiently, especially when dealing with frequently changing content or large data sets.

In one or more embodiments, such programmatic modification may operate over ordinary webpages, Structured Content Entity items, or both in a coordinated workflow.

### Automations and Continuous Run

Very often in practice webpage creation and modification are part of a project with specific goal that are to be achieved in a certain time frame. The copilot system may be used to perform these tasks. The copilot system recognizes the intent and the desired output, generates/suggests (or is provided with) a series of metrics and checks for these metrics to measure the progress and quality of the output (webpages and their content). The system breaks down the goal into a series of achievable tasks (webpage creation/modification), performs them and checks the metrics. For each checked metric, the system estimates whether the performance according to the metric is good or bad and suggests what to improve. The system may be configured to run in a loop, performing the tasks and checking the metrics until the goal is achieved. The the tasks mentioned above are summarized in the human-readable action plan that is being displayed to the user. The metrics are of several types:
Metrics that measure the progress of the project, such as number of webpages created/modified, number of Sections created/modified
Metrics that measure the quality and relevance of the output, such as the relevance of webpage content to the list of keywords and topics.
Statistical metrics that are obtained from third party services, such as Google Analytics. For example, the number of visitors, bounce rate, conversion rate, conversion rate for each button in the webpage etc.

The list of allowed tasks includes creation/modification of webpages, Sections, Global Design Parameters etc. In an embodiment, this way the copilot system triggers bulk webpage creation/modification actions based on the action plan and the corresponding metrics and checks (see the sections above). A series of AI Agents are responsible for generating the prompts for each task (e.g. how the texts in the webpage are to be modified to have higher conversion rate), performing the tasks and checking the metrics.

An example of such a project is creation of a series of blog posts to increase the number of visitors to the website. The system is provided with a goal: dominate in the organic search results for the given list of target keywords and topics. User provides constraints-number of new blog posts to generate or modify (including removing bad performing ones) per day, instructions which layout templates for blog posts to use or not to use, etc., how frequently to check for metrics and what metrics to check (position in search engine results page, number of visitors, average time spent on the blog post, bounce rate, conversion rate, etc.). The system checks for the metrics according to the schedule and generated (and approved plan) and suggests what to improve and iteratively performs the tasks until the goal is achieved. The system also provides a report according to the schedule to the user.

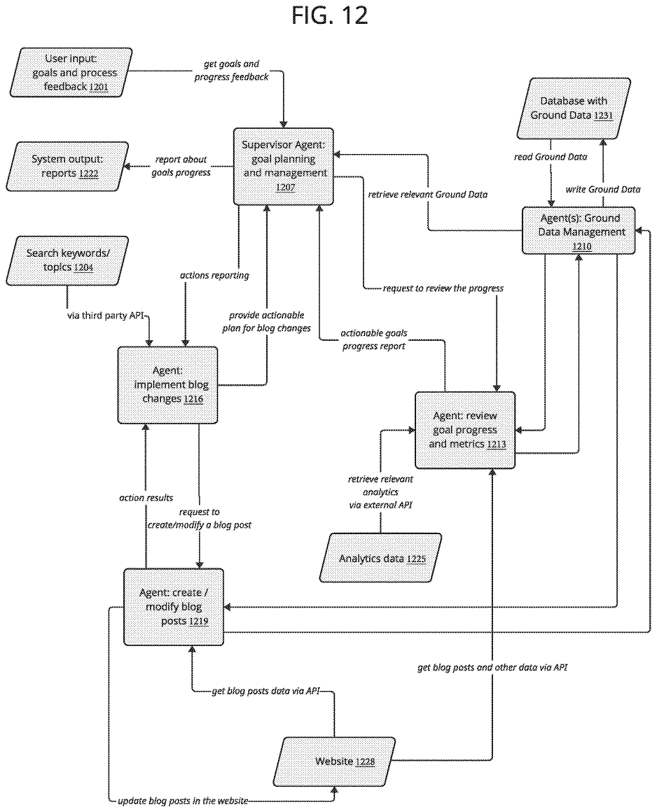

FIG. 12 is a flow diagram that depicts the process of automated programmatic blog posts creation with goals, in an implementation. In such embodiments, the supervisor AI Agent in the flow orchestrates several sub-Agents, including those responsible for goal progress review/analysis of metrics and blog content management, which in turn, calls sub-Agents for generating/rewriting blog posts.

At block 1201, the system receives user input that includes goals and process feedback. For example, such input may establish the parameters of the blog creation project—including the overarching Search Engine Optimization (SEO) goal (e.g., dominating organic search results for a target set of keywords and topics), user-defined constraints such as the number of blog posts to generate or modify per day, which layout templates to use or exclude, how frequently to check metrics, and which metrics to monitor (e.g., search engine result page position, number of visitors, average time on page, bounce rate, conversion rate). This input also captures ongoing feedback from the user as the project progresses—approvals, corrections, or revised instructions that refine the system's action plan across scheduled iterations.

At block 1204, the system receives a list of search keywords and topics as input. This list, which may be provided directly by the user or retrieved from a third-party SEO service via API, defines the content targets that the blog posts may address to achieve the project's organic search goal. The keywords and topics serve as the primary relevance criteria against which both newly generated blog posts and existing website content are evaluated—informing which posts are to be created, which existing posts are to be modified to better target high-priority terms, and which underperforming posts may need to be removed. This input is consumed by the Blog Changes Implementation Agent at block 1216 via a third-party API.

At block 1207, the Supervisor Agent serves as the central orchestrator for the entire goal-driven blog creation and management process. The Supervisor Agent receives the user's goals and process feedback from block 1201, retrieves relevant Ground Data from block 1210 to understand the current state of the website's blog content, and manages the overall project across scheduled loop iterations—each triggered automatically on the configured schedule. In each iteration, the Supervisor Agent sends a request to the Goal Progress and Metrics Review Agent at block 1213 to assess current performance, receives an actionable goals progress report back from block 1213, and based on that report provides an actionable plan for blog changes to the Blog Changes Implementation Agent at block 1216. The Supervisor Agent also receives actions reporting back from block 1216 upon completion of each implementation cycle, and produces a human-readable report about goals progress sent to block 1222 for delivery to the user. The scheduled loop runs continuously—planning, implementing, measuring, and refining—until the defined goal is achieved.

At block 1210, the Ground Data Management Agent(s) serve as the interface between the AI Agents and the Database with Ground Data at block 1228. Ground Data Management Agent(s) read Ground Data from block 1228 to supply the Supervisor Agent at block 1207 with relevant context about the current state of the website's blog content—including existing blog post metadata, Section descriptions, Webpage Outline entries, and Sitemap structure—providing accurate gap analysis against the target keywords and topics. Ground Data Management Agent(s) also write updated Ground Data back to block 1228 following successful blog post creation or modification operations, maintaining the database as a current reflection of the live website's blog content. Additionally, the Ground Data Management Agents supply relevant Ground Data to the Blog Post Creation and Modification Agent at block 1219 to support per-post content generation.

At block 1213, the Goal Progress and Metrics Review Agent receives a request to review the progress from the Supervisor Agent at block 1207 and performs a comprehensive evaluation of the project's current performance against the defined metrics. The Agent retrieves relevant analytics data from block 1225 via an external API call—obtaining statistical metrics such as search engine ranking positions, visitor counts, average time on page, bounce rates, and conversion rates for each blog post—and combines this data with project progress metrics (such as the number of blog posts created or modified to date) and content quality metrics (such as keyword relevance scores for existing posts). Based on this multi-dimensional assessment, the Agent estimates whether performance on each metric is on track or underperforming, identifies which specific blog posts or content areas may require attention, and generates an actionable goals progress report that is returned to the Supervisor Agent at block 1207 to inform the next cycle's action plan.

At block 1216, the Blog Changes Implementation Agent receives an actionable plan for blog changes from the Supervisor Agent at block 1207. This Agent translates the high-level action plan into a concrete set of per-post implementation tasks—generating specific prompts for each blog post that may be created or modified, detailing how text content is to be updated to improve keyword relevance or conversion rate, which layout templates to apply, and which underperforming posts to be removed. The Agent also retrieves current keyword and topic data from block 1204 via a third-party SEO API to determine that each prompt is grounded in the most current search intelligence. For each blog post task, the Agent dispatches a request to create or modify a blog post to block 1219, receives action results back from block 1219, and reports the overall actions outcome back to the Supervisor Agent at block 1207 upon completion of the implementation cycle.

At block 1219, the Blog Post Creation and Modification Agent receives individual requests to create or modify specific blog posts from the Blog Changes Implementation Agent at block 1216. Operating in an inner loop—iterating over each blog post task in the current implementation cycle—this Agent retrieves existing blog post data from the Website at block 1228 via API when modifying an existing post, and retrieves relevant Ground Data from the Ground Data Management Agent at block 1210 for content consistency with the website's broader content structure. The Agent then generates or modifies the blog post content in accordance with the prompt received from block 1216—tailoring headlines, body text, calls-to-action, internal links, and metadata to optimally address the target keywords and improve the relevant metrics—and updates the blog post in the Website at block 1228 via API. The loop runs until the blog post tasks in the current cycle have been processed, after which results are returned to block 1216.

At block 1222, the system produces a system output comprising reports and other user-facing communications. This output, triggered by the Supervisor Agent at block 1207 on the configured reporting schedule, delivers a human-readable summary of goal progress to the user—describing the current state of the tracked metrics, the actions taken in the most recent implementation cycle, an assessment of what is working and what may require further improvement, and the proposed action plan for the next scheduled cycle. This report serves as the primary transparency mechanism through which the user monitors the autonomous blog creation project and provides refined goals or process feedback back into block 1201.

At block 1225, the Analytics data component represents the external analytics and measurement services—such as Google Analytics or third-party SEO ranking tools—accessed by the Goal Progress and Metrics Review Agent at block 1213 via external API calls. This component supplies the statistical performance metrics used to evaluate blog post quality and project progress, including search engine result page position, visitor counts, session duration, bounce rates, and conversion rates at both the page and element level.

At block 1228, the Website represents the live website platform or CMS environment that serves as both a data source and a modification target throughout the flow. The Blog Post Creation and Modification Agent at block 1219 retrieves existing blog post content from the Website via API to inform modification tasks, and writes created or updated blog posts back to the Website via API upon completion. The Goal Progress and Metrics Review Agent at block 1213 also retrieves blog post and other relevant website data from the Website via API to support its performance assessment. The Database with Ground Data at block 1228 is read from and written to by the Ground Data Management Agent at block 1210 to maintain a synchronized, always-current structured representation of the blog content that supports planning, validation, and future automation cycles.

In an embodiment, the system allows users to see the action plan and the corresponding metrics and checks and configure the source of the metrics (how to get them from the third-party analytics services and prompts analyzing the content of the webpages). The user is allowed to modify the action plan, frequency of the checks and other parameters.

In an embodiment, the system accepts positive or negative constraints provided by the user as guidance, such as “do not modify design of the pages”, “do not remove any Section”, “modify only texts of call-to-action buttons”, etc. The system may take these constraints into account when performing the tasks and include checking against such constraints for each action modifying any content or settings on the website.

The system triggers bulk webpage creation/modification actions based on the action plan and the corresponding metrics and checks (see the sections above).

### User-Facing Progress Communication For Long Operations

In one or more embodiments, the system converts internal execution state of long-running operations into user-facing progress communications that summarize current stage, completed steps, pending steps, detected issues, or requested clarifications in human-readable form. Such progress communication may be updated during iterative orchestration so that a user may observe advancement of a multi-step task without waiting for a final result. The progress communication may distinguish planning, generation, validation, synchronization, repair, packaging, publication, or restoration stages.

In one or more embodiments, user-facing progress communication improves operability of long-running website automation by preserving transparency, enabling interruption or approval at selected stages, and reducing uncertainty during multi-step execution.

### Further Details On Training Machine Learning/Artificial Intelligence Model

Machine learning techniques include applying a machine learning algorithm on a training data set, for which outcome(s) are known, with initialized parameters whose values are modified in each training iteration to more accurately yield the known outcome(s) (referred herein as “label(s)”). Based on such application(s), the techniques generate a machine-learning model with known parameters. Thus, a machine learning model includes a model data representation or model artifact. A model artifact comprises parameter values, which are applied by a machine learning algorithm to the input to generate a predicted output. Training a machine learning model entails determining the parameter values of the model artifact. The structure and organization of the parameter values depend on the machine learning algorithm.

Accordingly, the term “machine learning algorithm” (or simply “algorithm”) refers herein to a process or set of rules to be followed in calculations in which a model artifact, comprising one or more parameters for the calculations, is unknown. The term “machine learning model” (or simply “model”) refers herein to the process or set of rules to be followed in the calculations in which the model artifact, comprising one or more parameters, is known and has been derived based on the training of the respective machine learning algorithm using one or more training data sets. Once trained, the input is applied to the machine learning model to make a prediction, which may also be referred to herein as a predicted outcome or output.

In supervised training, training data is used by a supervised training algorithm to train a machine learning model. The training data includes input and “known” output, label. In an implementation, the supervised training algorithm is an iterative procedure. In each iteration, the machine learning algorithm applies the model artifact and the input to generate a predicted output. An error or variance between the predicted output and the known output is calculated using an objective function, loss function. In effect, the output of the loss function indicates the accuracy of the machine learning model based on the particular state of the model artifact in the iteration. By applying an optimization algorithm based on the loss function, the parameter values of the model artifact are adjusted. The iterations may be repeated until the desired accuracy is achieved, or some other criteria are met.

In an implementation, to iteratively train an algorithm to generate a trained model, a training data set may be arranged such that each row of the data set is input to a machine learning algorithm and further stores the corresponding actual outcome, label value, for the row. For example, each row of the adult income data set represents a particular adult for whom the outcome is known, such as whether the adult has a gross income over $500,000. Each column of the adult training dataset contains numerical representations of a particular adult characteristic (e.g., whether an adult has a college degree or the age of an adult) based on which the algorithm, when trained, may accurately predict whether any adult (even one who has not been described by the training data set) has a gross income over $500,000.

The row values of a training data set may be provided as inputs to a machine learning algorithm and may be modified based on one or more parameters of the algorithm to yield a predicted outcome. The predicted outcome for a row is compared with the label value, and based on the difference, an error value is calculated. One or more error values for the batch of rows are used in a statistical aggregate function to calculate an error value for the batch. The “loss” term refers to an error value for a batch of rows.

At each training iteration, based on one or more predicted values, the corresponding loss values for the iteration are calculated. For the next training iteration, one or more parameters are modified to reduce the loss based on the current loss. Any number of iterations on a training data set may be performed to reduce the loss. The training iterations using a training data set may be stopped when the change in the losses between the iterations is within a threshold. In other words, the iterations are stopped when the loss for different iterations is substantially the same.

After the training iterations, the generated machine learning model includes the machine learning algorithm with the model artifact that yielded the smallest loss.

For example, the above-mentioned adult income data set may be iterated using the Support Vector Machines (SVM) algorithm to train an SVM-based model for the adult income data set. Each row of the adult data set is provided as an input to the SVM algorithm, and the result, the predicted outcome, of the SVM algorithm is compared to the actual outcome for the row to determine the loss. Based on the loss, the parameters of the SMV are modified. The next row is provided to the SVM algorithm with the modified parameters to yield the next row's predicted outcome. The process may be repeated until the difference in loss values of the previous iteration and the current iteration is below a pre-defined threshold or, in some implementations, until the difference between the smallest loss value achieved and the current iteration's loss is below a pre-defined threshold.

Once the machine learning model for the machine learning algorithm is determined, a new data set for which an outcome is unknown may be used as input to the model to calculate the predicted outcome(s) for the new data set.

In a software implementation, when a machine learning model is referred to as receiving an input, executing, and/or generating output or prediction, a computer system process executing a machine learning algorithm applies the model artifact against the input to generate predicted output. A computer system process executes a machine learning algorithm by executing software configured to cause the execution of the algorithm.

### Further Details On Machine Learning Algorithms and Domains

A machine learning algorithm may be selected based on the domain of the problem and the intended type of outcome for the problem. The non-limiting examples of algorithm outcome types may be discrete values for problems in the classification domain, continuous values for problems in the regression domain, or anomaly detection problems in the clustering domain.

However, even for a particular domain, there are many algorithms to choose from for selecting the most accurate algorithm to solve a given problem. As non-limiting examples, in a classification domain, Support Vector Machines (SVM), Random Forests (RF), Decision Trees (DT), Bayesian networks (BN), stochastic algorithms such as genetic algorithms (GA), or connectionist topologies such as artificial neural networks (ANN) may be used.

Implementations of machine learning may rely on matrices, symbolic models, and hierarchical and/or associative data structures. Parameterized (i.e., configurable) implementations of best-of-breed machine learning algorithms may be found in open-source libraries such as Google's TensorFlow for Python and C++ or Georgia Institute of Technology's MLPack for C++. Shogun is an open-source C++ ML library with adapters for several programming languages, including C#, Ruby, Lua, Java, MatLab, R, and Python.

### Hyper-Parameters, Cross-Validation and Algorithm Selection

A type of machine algorithm may have unlimited variants based on one or more hyper-parameters. The term “hyper-parameter” refers to a parameter in a model artifact that is set before the training of the machine algorithm model and is not modified during the training of the model. In other words, a hyper-parameter is a constant value that affects (or controls) the generated trained model independent of the training data set. A machine learning model with a model artifact that has only hyper-parameter values set is referred to herein as a “variant of a machine learning algorithm” or simply “variant.” Accordingly, different hyperparameter values for the same type of machine learning algorithm may yield significantly different loss values on the same training data set during the training of a model.

For example, the SVM machine learning algorithm includes two hyperparameters: “C” and “gamma.” The “C” hyper-parameter may be set to any value from 10-3 to 105, while the “gamma” hyper-parameter may be set from 10-5 to 103. Accordingly, there are endless permutations of the “C” and “gamma” parameters that may yield different loss values for training the same adult income training data set.

Therefore, to select a type of algorithm or, moreover, to select the best-performing variant of an algorithm, various hyper-parameter selection techniques are used to generate distinct sets of hyper-parameter values. Non-limiting examples of hyper-parameter value selection techniques include a Bayesian optimization such as a Gaussian process for hyper-parameter value selection, a random search, a gradient-based search, a grid search, hand-tuning techniques, a tree-structured Parzen Estimators (TPE) based technique.

With distinct sets of hyper-parameters values selected based on one or more of these techniques, each machine learning algorithm variant is trained on a training data set. A test data set is used as an input to the trained model for calculating the predicted result values. The predicted result values are compared with the corresponding label values to determine the performance score. The performance score may be computed based on calculating the error rate of predicted results in relation to the corresponding labels. For example, in a categorical domain, if out of 10,000 inputs to the model, only 9,000 matched the labels for the inputs, then the performance score is computed to be 90%. In non-categorical domains, the performance score may be further based on a statistical aggregation of the difference between the label value and the predicted result value.

The term “trial” refers herein to the training of a machine learning algorithm using a distinct set of hyper-parameter values and testing the machine learning algorithm using at least one test data set. In an implementation, cross-validation techniques, such as k-fold cross-validation, are used to create many pairs of training and test datasets from an original training data set. Each pair of data sets together contains the original training data set, but the pairs partition the original data set in different ways between a training data set and a test data set. For each pair of data sets, the training data set is used to train a model based on the selected set of hyperparameters, and the corresponding test data set is used for calculating the predicted result values with the trained model. Based on inputting the test data set to the trained machine learning model, the performance score for the pair (or fold) is calculated. If there is more than one pair (i.e., fold), then the performance scores are statistically aggregated (e.g., average, mean, min, max) to yield a final performance score for the variant of the machine learning algorithm.

Each trial is computationally very expensive, as the trial includes multiple training iterations for a variant of the machine algorithm to generate the performance score for one distinct set of hyper-parameter values of the machine learning algorithm. Accordingly, reducing the number of trials may dramatically reduce the necessary computational resources (e.g., processor time and cycles) for tuning.

Furthermore, since the performance scores are generated to select the most accurate algorithm variant, the more precise the performing score itself is, the more precise the generated model's prediction relative accuracy is compared to other variants. Indeed, once the machine learning algorithm and its hyper-parameter value-based variant are selected, a machine model is trained by applying the algorithm variant to the full training data set using the techniques discussed above. In an embodiment, this generated machine-learning model is expected to predict the outcome with more accuracy than the machine-learning models of any other variant of the algorithm.

The precision of the performance score itself depends on how much computational resources are spent on tuning hyper-parameters for an algorithm. Computational resources may be wasted on testing sets of hyper-parameter values that cannot yield the desired accuracy of the eventual model.

Similarly, less (or no) computational resources may be spent on tuning those hyper-parameters for a type of algorithm that is most likely to be less accurate than another type of algorithm. Accordingly, the number of trials may be reduced or eliminated for hyper-parameters of discounted algorithms, thus substantially increasing the performance of the computer system.

### Software Overview

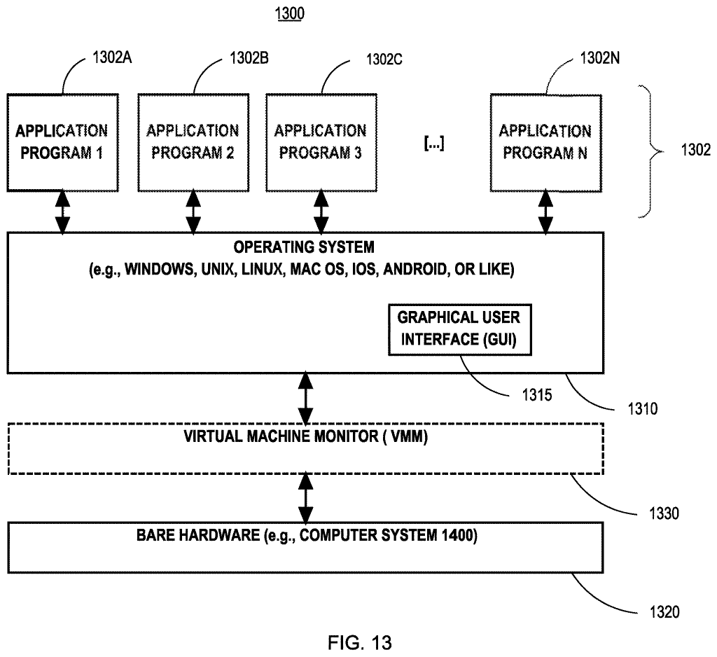

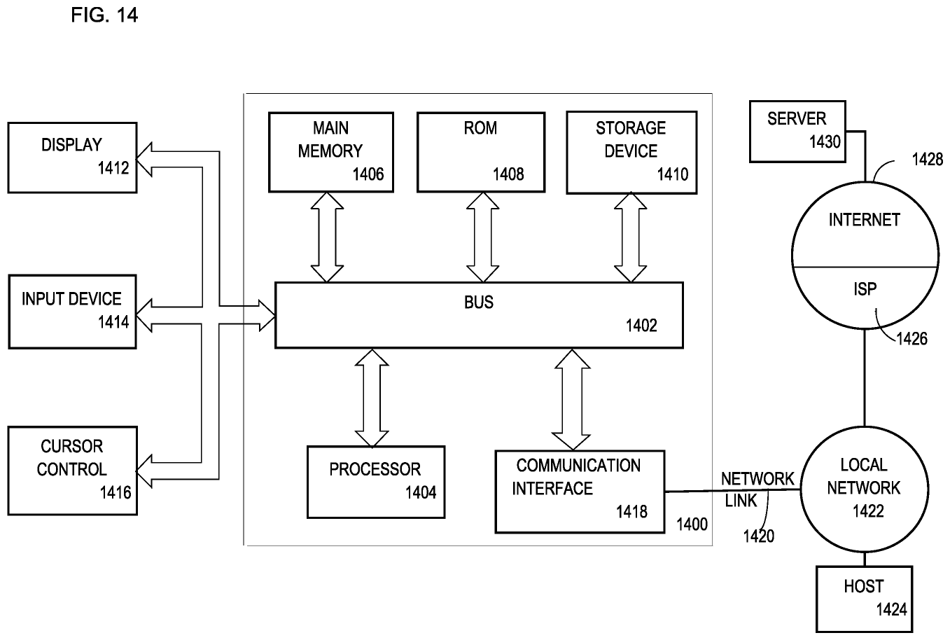

FIG. 13 is a block diagram of a basic software system 1300 that may be employed for controlling the operation of computing system 1400 of FIG. 14. Software system 1300 and its components, including their connections, relationships, and functions, are meant to be exemplary only, and not meant to limit implementations of the example embodiment(s). Other software systems suitable for implementing the example embodiment(s) may have different components, including components with different connections, relationships, and functions.

Software system 1300 is provided for directing the operation of computing system 1400. Software system 1300, which may be stored in system memory (RAM) 1406 and on fixed storage (e.g., hard disk or flash memory) 1410, includes a kernel or operating system (OS) 1310.

The OS 1310 manages low-level aspects of computer operation, including managing execution of processes, memory allocation, file input and output (I/O), and device I/O. One or more application programs represented as 1302A, 1302B, 1302C . . . 1302N, may be “loaded” (e.g., transferred from fixed storage 1410 into memory 1406) for execution by the system 1300. The applications or other software intended for use on computer system 1400 may also be stored as a set of downloadable computer-executable instructions, for example, for downloading and installation from an Internet location (e.g., a Web server, an app store, or another online service).

Software system 1300 includes a graphical user interface (GUI) 1315, for receiving user commands and data in a graphical (e.g., “point-and-click” or “touch gesture”) fashion. These inputs, in turn, may be acted upon by the system 1300 in accordance with instructions from operating system 1310 and/or application(s) 1302. The GUI 1315 also serves to display the results of operation from the OS 1310 and application(s) 1302, whereupon the user may supply additional inputs or terminate the session (e.g., log off).

OS 1310 may execute directly on the bare hardware 1320 (e.g., processor(s) 1404) of computer system 1400. Alternatively, a hypervisor or virtual machine monitor (VMM) 1330 may be interposed between the bare hardware 1320 and the OS 1310. In this configuration, VMM 1330 acts as a software “cushion” or virtualization layer between the OS 1310 and the bare hardware 1320 of the computer system 1400.

VMM 1330 instantiates and runs one or more virtual machine instances (“guest machines”). Each guest machine comprises a “guest” operating system, such as OS 1310, and one or more applications, such as application(s) 1302, designed to execute on the guest operating system. The VMM 1330 presents the guest operating systems with a virtual operating platform and manages the execution of the guest operating systems.

In some instances, the VMM 1330 may allow a guest operating system to run as if it is running on the bare hardware 1320 of computer system 1400 directly. In these instances, the same version of the guest operating system configured to execute on the bare hardware 1320 directly may also execute on VMM 1330 without modification or reconfiguration. In other words, VMM 1330 may provide full hardware and CPU virtualization to a guest operating system in some instances.

In other instances, a guest operating system may be specially designed or configured to execute on VMM 1330 for efficiency. In these instances, the guest operating system is “aware” that it executes on a virtual machine monitor. In other words, VMM 1330 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

Multiple threads may run within a process. Each thread also comprises an allotment of hardware processing time but share access to the memory allotted to the process. The memory is used to store the content of processors between the allotments when the thread is not running. The term thread may also be used to refer to a computer system process in multiple threads that are not running.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 14 is a block diagram that illustrates a computer system 1400 upon which an embodiment of the invention may be implemented. Computer system 1400 includes a bus 1402 or other communication mechanism for communicating information, and a hardware processor 1404 coupled with bus 1402 for processing information. Hardware processor 1404 may be, for example, a general-purpose microprocessor.

Computer system 1400 also includes a main memory 1406, such as a random access memory (RAM) or another dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read-only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. Such an input device may have two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise bus 1402. Transmission media may also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid-state drive of a remote computer. The remote computer may load the instructions into its dynamic memory and send the instructions over a telephone line using a modem. A modem local to computer system 1400 may receive the data on the telephone line and use an infra-red transmitter to convert the data to an infra-red signal. An infra-red detector may receive the data carried in the infra-red signal, and appropriate circuitry may place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426, in turn, provides data communication services through the worldwide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 may send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410 or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
receiving input that requests a change to at least one portion of a website;
maintaining a plurality of website parameter sets, each website parameter set of the plurality of website parameter sets corresponding to a current state of a website layer that describes a particular aspect of the website;
based, at least in part, on the input, determining one or more website layers to be modified;
based on determining the one or more website layers to be modified, modifying the corresponding one or more website parameter sets of the one or more website layers without modifying another website parameter set that corresponds to a different website layer than the one or more website layers;
based, at least in part, on the modified one or more website parameter sets, generating modified website artifacts the change to the website, which, when rendered, display the at least one portion of the website with the requested change.

2. The method of claim 1, wherein a website parameter set, of the plurality of website parameter sets, includes a widget parameter, a styling parameter, a design parameter, a layout parameter, a metadata parameter, a content parameter, a schema parameter or a context parameter.

3. The method of claim 1, wherein the one or more website layers include a style layer, a layout layer, a structure content entity layer, a content layer, or an integration layer.

4. The method of claim 1, further comprising:
based, at least in part, on the modified one or more website parameter sets, determining an execution plan for propagating the change to one or more pages of the website;
based, at least in part, on the execution plan, determining that ground data of the website is to be modified and performing modification to the ground data of the website.

5. The method of claim 4, further comprising:
based, at least in part, on the modification to the ground data, modifying the execution plan to a new execution plan;
based, at least in part, on the new execution plan, generating modified website artifacts that reflect the change to the website, which, when rendered, display the at least one portion of the website with the requested change.

6. The method of claim 1, wherein the one or more website layers include a plurality of website layers, and the method further comprises:
for each website layer of the plurality of website layers, executing a corresponding AI agent of a plurality of AI agents to invoke a respective AI model;
determining, by the corresponding AI agent, one or more website parameters to modify for said website layer;
receiving, by a supervisor AI agent, a response from the corresponding AI agent that the one or more website parameters of said layer to modify;
based, at least in part, on a plurality of responses from the plurality of AI agents, including the response from the corresponding AI agent, determining, by the supervisor AI agent, a final website parameter set to modify that includes the modified one or more website parameter sets of the one or more website layers.

7. The method of claim 1, wherein the one or more website layers include a structured entity layer, and the method further comprises:
based on the input, determining that a particular structured entity type is affected by the requested change;
based, at least in part, on the requested change, modifying a schema definition of the particular structured entity type in ground data to a modified schema definition;
based, at least in part, on a dependency schema of the ground data, identifying a plurality of web elements affected by the modified schema definition of the particular structured entity;
rendering an intermediate result view at least a portion of the plurality of web elements that results from modifying the plurality of web elements according to the modified schema definition;
based on receiving a validation input, generating the modified website artifacts the change to the website that includes plurality of web elements, which, when rendered, display the at least one portion of the website with the requested change

8. A computer-implemented method comprising:
receiving a natural language user input for generating a website;
based, at least in part, on the natural language user input, generating a ground data scheme and ground data conforming to the ground scheme, the ground data describing a core state of the website;
wherein the ground data includes a metadata portion describing a layout of the website and a content portion that includes core content for the website;
based, at least in part, on the metadata portion of the ground data, generating core website content according to the layout of the website that includes, at least in part, the content portion of the ground data.

9. The method of claim 8, further comprising:
generating a dependency schema that defines the relationship between the ground data and the core website content.

10. The method of claim 9, wherein the natural language user input is a first user input, and the method further comprising:
determining that a second user input modifies a particular portion of the ground data of the website to a changed portion of the ground data;
based on the dependency schema, determining a plurality of sections of the website that depend on the particular portion of the ground data;
modifying the plurality of sections of the website according to the changed portion of the ground data.

11. The method of claim 9, further comprising:
identifying modification to a particular section of the website;
based on the dependency schema, determining that the modification to the particular section of the website includes a modification to a particular portion of the ground data of the website ;
modifying the particular portion of the ground data of the website to a changed portion of the ground data;
based on the dependency schema, determining one or more other sections of the website that depend on the particular portion of the ground data;
modifying the one or more other sections of the website according to the changed portion of the ground data.

12. The method of claim 8, wherein the natural language user input is a first user input, and the method further comprising:
based, at least in part, on the ground data, generating an initial site map for the website ;
receiving a second user input requesting to modify the initial site map to a modified site map of the website;
determining that the modified site map modifies a particular portion of the ground data of the website to a changed portion of the ground data;
modifying the ground data of the website from the particular portion of the ground data of the website to the changed portion of the ground data.

13. The method of claim 8, wherein the ground data schema and the ground data are generated by one or more AI models based, at least in part, on the natural language user input.

14. The method of claim 8, wherein the metadata portion of the ground data includes a structured entity schema;
based, at least in part, on the structured entity schema, retrieving, from a database, a plurality of entities;
generating entity content for each entity of the plurality of structured entities for the website.

15. A system comprising one or more processors and one or more storage media storing one or more computer programs that include instructions, which, when executed by the one or more processors, cause:
receiving input that requests a change to at least one portion of a website;
maintaining a plurality of website parameter sets, each website parameter set of the plurality of website parameter sets corresponding to a current state of a website layer that describes a particular aspect of the website;
based, at least in part, on the input, determining one or more website layers to be modified;
based on determining the one or more website layers to be modified, modifying the corresponding one or more website parameter sets of the one or more website layers without modifying another website parameter set that corresponds to a different website layer than the one or more website layers;
based, at least in part, on the modified one or more website parameter sets, generating modified website artifacts the change to the website, which, when rendered, display the at least one portion of the website with the requested change.

16. The system of claim 15, wherein the one or more website layers include a style layer, a layout layer, a structure content entity layer, a content layer, or an integration layer.

17. The system of claim 15, wherein the one or more website layers include a plurality of website layers, and wherein the one or more programs include instructions, which, when executed by the one or more processors, further cause:
for each website layer of the plurality of website layers, executing a corresponding AI agent of a plurality of AI agents to invoke a respective AI model;
determining, by the corresponding AI agent, one or more website parameters to modify for said website layer;
receiving, by a supervisor AI agent, a response from the corresponding AI agent that the one or more website parameters of said layer to modify;
based, at least in part, on a plurality of responses from the plurality of AI agents, including the response from the corresponding AI agent, determining, by the supervisor AI agent, a final website parameter set to modify that includes the modified one or more website parameter sets of the one or more website layers.

18. A system comprising one or more processors and one or more storage media storing one or more computer programs that include instructions, which, when executed by the one or more processors, cause:
receiving a natural language user input for generating a website;
based, at least in part, on the natural language user input, generating a ground data scheme and ground data conforming to the ground scheme, the ground data describing a core state of the website;
wherein the ground data includes a metadata portion describing a layout of the website and a content portion that includes core content for the website;
based, at least in part, on the metadata portion of the ground data, generating core website content according to the layout of the website that includes, at least in part, the content portion of the ground data.

19. The system of claim 18, wherein the one or more programs include instructions, which, when executed by the one or more processors, further cause:
generating a dependency schema that defines the relationship between the ground data and the core website content.

20. The system of claim 18, wherein the ground data schema and the ground data are generated by one or more AI models, based, at least in part, on the natural language user input.
